(19) United States
(12) Patent Application Publication
(10) Pub. No.: US 2006/0270806 A1
(43) Pub. Date: Nov. 30, 2006

(54) Miscible high Tg polyester/polymer blend compositions and films formed therefrom

(76) Inventor: Wesley Raymond Hale, Kingsport, TN (US)

Correspondence Address: Louis N. Moreno;Eastman Chemical Company, P.O. Box 511, Kingsport, TN, 37662-5075, US

(21) Appl. No.: 11/439,340

(22) Filed: May 23, 2006

Related U.S. Application Data
(60) Provisional application No. 60/684,854, filed on May 26, 2005.

(51) Int. Cl. C08L 67/00

(52) U.S. Cl. 525/439; 525/445

(57) ABSTRACT

Disclosed is a high Tg polyester/polymer blend composition for a sheet or film. The composition comprises about 80 to about 99.8 percent by weight of a miscible blend of a polyester with a polymer. Also disclosed is a process for the preparation of a film or sheet from this composition. Compensationa and protective films and sheets prepared from this composition are useful for backlight displays.

This application claims priority benefit of provisional application Ser. No. 60/684,854 filed May 26, 2005, incorporated by reference herein.

### FIELD OF INVENTION

The field of the invention relates to miscible high Tg polyester/polymer blend compositions suitable for melt processing into films. More specifically, this invention relates to films suitable for liquid crystal displays formed from melt processable miscible high Tg polyester/polymer blend compositions. The present invention further relates to processes for producing polyester/polymer compositions and for producing films comprising these compositions and articles comprising the films.

### BACKGROUND OF THE INVENTION

Films or sheets can be produced with a variety of plastic materials by a variety of processes (extrusion molding, stretch blow molding, etc.). Polycarbonates are widely used in a variety of molding and extrusion applications. Films or sheets formed from the polycarbonates must be dried prior to thermoforming. If the films and/or sheets are not pre-dried prior to thermoforming, thermoformed articles formed from the polycarbonates can be characterized by the presence of blisters that are unacceptable from an appearance standpoint.

Poly(1,4-cyclohexylenedimethylene) terephthalate (PCT), a polyester based solely on terephthalic acid or an ester thereof and 1,4-cyclohexanedimethanol, is known in the art and is commercially available. This polyester crystallizes rapidly upon cooling from the melt, making it very difficult to form amorphous articles by methods known in the art such as extrusion, injection molding, and the like. In order to slow down the crystallization rate of PCT, copolyesters can be prepared containing additional dicarboxylic acids or glycols such as isophthalic acid or ethylene glycol. These ethylene glycol- or isophthalic acid-modified PCTs are also known in the art and are commercially available. One common copolyester used to produce films, sheeting, and molded articles is made from terephthalic acid, 1,4-cyclohexanedimethanol, and ethylene glycol. While these copolyesters are useful in many end-use applications, they exhibit deficiencies in properties such as glass transition temperature and impact strength when sufficient modifying ethylene glycol is included in the formulation to provide for long crystallization half-times. For example, copolyesters made from terephthalic acid, 1,4-cyclohexanedimethanol, and ethylene glycol with sufficiently long crystallization half-times can provide amorphous products that exhibit what is believed to be undesirably higher ductile-to-brittle transition temperatures and lower glass transition temperatures than the compositions revealed herein.

The polycarbonate of 4,4′-isopropylidenediphenol (bisphenol A polycarbonate) has been used as an alternative for polyesters known in the art and is a well known engineering molding plastic. Bisphenol A polycarbonate is a clear, high-performance plastic having good physical properties such as dimensional stability, high heat resistance, and good impact strength. Although bisphenol A polycarbonate has many good physical properties, its relatively high melt viscosity leads to poor melt processability and the polycarbonate exhibits poor chemical resistance. It is also difficult to thermoform.

Polymers containing 2,2,4,4-tetramethyl-1,3-cyclobutanediol have also been generally described in the art. Generally, however, these polymers exhibit high inherent viscosities, high melt viscosities and/or high Tgs (glass transition temperatures) such that the equipment used in industry can be insufficient to manufacture or post polymerization process these materials.

Currently a majority of films used liquid crystal displays (LCD), such as compensation and polarizer protective films, are prepared from well known cellulose ester formulations that are solvent cast into films. Films from polymers other than cellulose esters with a balance of modulus and tensile strength while maintaining sufficient melting and glass transition temperatures (Tg) to allow thermal processing for LCD films are generally unknown.

For many years, solvent-cast cellulose triacetate film has been used as a photographic film support. Additionally, these films are widely used as protective layers of polarizer elements for LCD applications. Its physical characteristics and the dimensional uniformity and surface quality imparted by solvent casting have made cellulose triacetate the first choice for many optical films.

Despite the excellent optical properties of solvent-cast cellulose ester film, environmental concerns about solvents conventionally used in the casting of the films have created a need for a new method of manufacture of display films or for a new kind of film support. For example, it has been reported that cellulose triacetate cannot be melt-cast because its melting point is above its decomposition temperature. As for solvent casting of cellulose triacetate, few solvents suitable for industrial use have been found which are more acceptable than the conventional ones.

One possible way to eliminate solvents is to melt cast a thermally stable polymer such as poly(ethylene terephthalate). Indeed, this type of polymer is used commercially for the manufacture of supports for photographic sheet films such as x-ray films and graphic arts films. It is not suitable, however, for many kinds of optical films, including roll films for amateur cameras. In this use the polyester film develops curl or “core set” when wound on the film spool. Cellulose triacetate also develops curl when wound (and a certain amount of core set is desirable), but when the cellulosic film is exposed to moisture the curl of the hydrophilic cellulosic film is relaxed and the film lies flat. Poly(ethylene terephthalate) films, on the other hand, do not relax their core set with simple humidity so they are unsatisfactory for photographic roll films. Additionally, poly(ethylene terephthalate) does not have the thermal properties required for many display applications. Other polymers lack one or more of the combination of properties and capabilities that make cellulose triacetate successful as a preferred optical film, and key properties they are lacking are the combination of heat resistance and transparency.

Esters of cellulose hydroxyl groups have been made over a wide range with both single and mixed acids for different uses. Cellulose diacetate (DSac=2.45), unlike the triacetate, has a sufficiently low melting point that, with adequate plasticizer addition, it can be melt extruded. Mixed esters, or replacement of acetyl groups of the triacetate with propionic or butyric groups can accomplish the same purpose. Films previously made from these known cellulose ester compositions with lower acetyl content than the triacetate have been deficient in properties such as stiffness and heat distortion temperature. Additionally, in recent years, there has been a drive for thinner, lighter, highly transparent optical films with improved heat resistance, moisture resistance, chemical resistance, dimensional stability, and mechanical strength. As films become thinner, a wide range of issues may be encountered. Films may become less uniform in thickness, the surface may become mottled, ultraviolet (UV) light resistance may decrease, the moisture vapor transmission rate (MVTR) may increase, and dimensional stability may suffer. Should the above discussed films be made from high Tg polyester blends, these deficiencies are potentially overcome. An embodiment of this invention is to provide a melt extruded film from transparent miscible high Tg polyester/polymer blend having sufficient properties for LCD films.

The requirements for films used in LCD applications, in particular thin film transistor (TFT) displays, are much more stringent with regard to the optical quality of said film when compared to films suitable for photographic film supports. Key aspects of LCD films are precise control over the birefringent nature of the film, extremely uniform thickness and surface flatness, and the ability to minimize contaminates which can interfere with the final display appearance and performance.

Thus, there is a need in the art for optical compensation and polarizer protective (hereafter “compensation and protective”) films or sheets for use in LCDs comprising at least one polymer having a combination of two or more properties, chosen from at least one of the following: toughness, high glass transition temperatures, high impact strength, hydrolytic stability, chemical resistance, long crystallization half-times, low ductile to brittle transition temperatures, good color, and clarity, lower density and/or thermoformability of polyesters while retaining processability on the standard equipment used in the industry.

### SUMMARY OF THE INVENTION

In a broad aspect, the present invention provides polyester/polymer blends and blend compositions for a liquid crystal display (LCD) compensation and protective film and sheet materials, methods for making the LCD compensation and protective film and sheet materials, articles including the LCD compensation and protective films or sheets, methods of making said compositions and articles, including films and sheets.

It is believed that certain LCD films or sheets comprising blends of polymers and polyesters with the polyester compositions formed from terephthalic acid, an ester thereof, or mixtures thereof, 1,4-cyclohexanedimethanol and 2,2,4,4-tetramethyl-1,3-cyclobutanediol with certain monomer compositions, inherent viscosities and/or glass transition temperatures are superior to polyesters known in the art and to polycarbonate with respect to one or more of high impact strengths, hydrolytic stability, toughness, chemical resistance, good color and clarity, long crystallization half-times, low ductile to brittle transition temperatures, lower specific gravity, and thermoformability. In a preferred embodiment according to the present invention, the polyester and the polymer form a miscible blend. These compositions are believed to be similar to polycarbonate in heat resistance and are still processable on the standard industry equipment.

In one aspect, this invention relates to a composition for LCD compensation or protective films, the composition comprising:
a polyester and polymer blend comprising
1) 1 to 99.9 percent by weight of the polymer and
2) 0.1 to 99 percent by weight of the polyester that is miscible in the polymer, with the percent by weight being based on the total weight of the polyester and the polymer; and
wherein the polyester polymer blend has a Tg greater than 85° C., and
   wherein a section of the blend having a thickness of 10 to 50 μm has less than
200 particles per 250 mm².

In one aspect, this invention relates to a composition for LCD compensation or protective films, the composition comprising
(a) a polymer and polyester blend comprising
   1) 1 to 99.9 percent by weight of the polymer, the polymer comprising a polycarbonate and
   2) 0.1 to 99 percent by weight of the polyester that is miscible with the polycarbonate; with the percent by weight being based on the total weight of the polyester and the polymer; and
   wherein the polyester polymer blend has a Tg greater than 85° C., and
wherein a section of the blend having a thickness of 10 to 50 μm has less than 200 particles per 250 mm².

In one aspect the invention relates to a method of making an article from a blend composition comprising:
(1) blending
(a) a polymer and polyester comprising
   1) 1 to 99.9 percent by weight of a polymer and
   2) 0.1 to 99 percent by weight of a polyester that is miscible with the polycarbonate, with the percent by weight being based on the total weight of the polyester and the polymer, to form a blend composition and
   3) form an article from the blend composition,
wherein the polyester polymer blend has a Tg greater than ° 85 C, and
wherein a section of the article having a thickness of 10 to 50 μm has less than 200 particles per 250 mm².

In one aspect the invention relates to an article made from a polymer polyester blend composition comprising
(a) a polycarbonate and polyester blend comprising
   1) 1 to 99.9 percent by weight of the polymer and
   2) 0.1 to 99 percent by weight of the polyester that is miscible with said polymer, with the weight percent being based on the total weight of the polyester and the polymer; and
wherein the polymer and polyester blend has a Tg greater than 85° C., and
wherein a section of the article having a thickness of 10 to 50 μm has less than 200 particles per 250 mm².

In one aspect the invention relates to a display device comprising a compensation or protective film, the film comprising
(a) a polymer and polyester blend comprising
   1) 1 to 99.9 percent by weight of the polymer and
   2) 0.1 to 99 percent by weight of the polyester that is miscible with the polycarbonate with the weight percent being based on the total weight of the polyester and the polymer; and
wherein the polymer and polyester blend has a Tg greater than 85° C. and
wherein a section of the film having a thickness of 10 to 50 μm has less than 200 particles per 250 mm².

In one aspect, the invention relates to an LCD compensation or protective film or sheet comprising a composition comprising
(a) a polymer and polyester blend comprising
   1) 1 to 99.9 percent by weight of the polycarbonate and
   2) 0.1 to about 99 percent by weight of the polyester that is miscible with the polymer, with the weight percent being based on the total weight of the polyester and the polymer; and
wherein the polymer and polyester blend has a Tg greater than 90° C., and
wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 15 to 70 mole % of 2,2,4,4-tetramethyl-1,3-cyclobutanediol residues; and
   ii) 30 to 85 mole % of 1,4-cyclohexanedimethanol residues,
wherein the total mole % of the dicarboxylic acid component is 100 mole %, the total mole % of the glycol component is 100 mole %;
wherein the inherent viscosity of the polyester is from 0.35 to 0.75 dL/g as determined in 60/40 (wt/wt) phenol/tetrachloroethane at a concentration of 0.5 g/100 ml at 25° C.; and
wherein the polyester has a Tg of from 100 to 150° C. and
   wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 40 to 70 mole % of 2,2,4,4-tetramethyl-1,3-cyclobutanediol residues; and
   ii) 30 to 60 mole % of 1,4-cyclohexanedimethanol residues,
wherein the total mole % of the dicarboxylic acid component is 100 mole %, the total mole % of the glycol component is 100 mole %; and
   wherein the inherent viscosity of the polyester is from 0.35 to 0.75 dL/g as determined in 60/40 (wt/wt) phenol/tetrachloroethane at a concentration of 0.5 g/100 ml at 25° C.;
wherein the polyester has a Tg of from 110 to 150° C. and
   wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising a polymer and polyester blend comprising at least one polyester composition comprising at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 10 to 90 mole % of 2,2,4,4-tetramethyl-1,3-cyclobutanediol residues; and
   ii) 10 to 90 mole % of 1,4-cyclohexanedimethanol residues,
wherein the total mole % of the dicarboxylic acid component is 100 mole %, the total mole % of the glycol component is 100 mole %;
wherein the inherent viscosity of the polyester is from 0.1 to 1.2 dL/g as determined in 60/40 (wt/wt) phenol/tetrachloroethane at a concentration of 0.5 g/100 ml at 25° C.; and
wherein the polyester has a Tg of from 90 to 200° C. and
   wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising a polymer and polyester blend comprising at least one polyester composition comprising at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 10 to 70 mole % of 2,2,4,4-tetramethyl-1,3-cyclobutanediol residues; and
   ii) 30 to 90 mole % of 1,4-cyclohexanedimethanol residues,
wherein the total mole % of the dicarboxylic acid component is 100 mole %, the total mole % of the glycol component is 100 mole %;
wherein the inherent viscosity of the polyester is from 0.35 to 1.2 dL/g as determined in 60/40 (wt/wt) phenol/tetrachloroethane at a concentration of 0.5 g/100 ml at 25° C.;
wherein the polyester has a Tg of from 90 to 150° C. and
wherein the blend has a Tg greater than 85° C., and
   wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(I) at least one polyester which comprises:
   (a) a dicarboxylic acid component comprising:
      i) 70 to 100 mole % of terephthalic acid residues;
      ii) 0 to 30 mole % of aromatic dicarboxylic acid residues having up to 20 carbon atoms; and
      iii) 0 to 10 mole % of aliphatic dicarboxylic acid residues having up to 16 carbon atoms; and
   (b) a glycol component comprising:
      i) 10 to 99 mole % of 2,2,4,4-tetramethyl-1,3-cyclobutanediol residues; and
      ii) 1 to 90 mole % of 1,4-cyclohexanedimethanol residues, and
(II) residues of at least one branching agent;
wherein the total mole % of the dicarboxylic acid component is 100 mole %, the total mole % of the glycol component is 100 mole %; and
wherein the inherent viscosity of the polyester is from 0.1 to 1.2 dL/g as determined in 60/40 (wt/wt) phenol/tetrachloroethane at a concentration of 0.5 g/100 ml at 25° C.; and
wherein the polyester has a Tg of from 90 to 200° C. and
   wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising a polymer and polyester blend comprising at least one polyester composition comprising at least one polyester, which comprises:
(I) at least one polyester which comprises:
   (a) a dicarboxylic acid component comprising:
      i) 70 to 100 mole % of terephthalic acid residues;
      ii) 0 to 30 mole % of aromatic dicarboxylic acid residues having up to 20 carbon atoms; and
      iii) 0 to 10 mole % of aliphatic dicarboxylic acid residues having up to 16 carbon atoms; and
   (b) a glycol component comprising:
      i) 10 to 99 mole % of 2,2,4,4-tetramethyl-1,3-cyclobutanediol residues; and
      ii) 1 to 90 mole % of 1,4-cyclohexanedimethanol residues, and
(II) at least one thermal stabilizer or reaction products thereof;
wherein the total mole % of the dicarboxylic acid component is 100 mole %, the total mole % of the glycol component is 100 mole %; and
wherein the inherent viscosity of the polyester is from 0.1 to 1.2 dL/g as determined in 60/40 (wt/wt) phenol/tetrachloroethane at a concentration of 0.5 g/100 ml at 25° C.; and
wherein the polyester has a Tg of from 90 to 200° C. and
   wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising a polymer and polyester blend comprising at least one polyester composition comprising at least one polyester, which comprises:
(I) at least one polyester which comprises:
   (a) a dicarboxylic acid component comprising:
      i) 70 to 100 mole % of terephthalic acid residues;
      ii) 0 to 30 mole % of aromatic dicarboxylic acid residues having up to 20 carbon atoms; and
      iii) 0 to 10 mole % of aliphatic dicarboxylic acid residues having up to 16 carbon atoms; and
   (b) a glycol component comprising:
      i) 40 to 70 mole % of 2,2,4,4-tetramethyl-1,3-cyclobutanediol residues; and
      ii) 30 to 60 mole % of 1,4-cyclohexanedimethanol residues, and
(II) residues of at least one branching agent;
wherein the total mole % of the dicarboxylic acid component is 100 mole %, the total mole % of the glycol component is 100 mole %; and
wherein the inherent viscosity of the polyester is from 0.35 to 0.75 dL/g as determined in 60/40 (wt/wt) phenol/tetrachloroethane at a concentration of 0.5 g/100 ml at 25° C.; and
wherein the polyester has a Tg of from 110 to 150° C. and
   wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(a) a dicarboxylic acid component comprising:
   i) 65 to 100 mole % of terephthalic acid residues;
   ii) 0 to 35 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 0.1 to 43 mole % of ethylene glycol residues; and
   ii) 57 to 99.9 mole % of 1,4-cyclohexanedimethanol residues,
wherein the total mole % of the dicarboxylic acid component is 100 mole %, the total mole % of the glycol component is 100 mole %;
wherein the inherent viscosity of the polyester is from 0.35 to 1.2 dL/g as determined in 60/40 (wt/wt) phenol/tetrachloroethane at a concentration of 0.5 g/100 ml at 25° C.; and
wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(a) a dicarboxylic acid component comprising:
   i) 65 to 100 mole % of terephthalic acid residues;
   ii) 0 to 35 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 0 to 43 mole % of ethylene glycol residues; and
   ii) 57 to 100 mole % of 1,4-cyclohexanedimethanol residues,
wherein the total mole % of the dicarboxylic acid component is 100 mole %, the total mole % of the glycol component is 100 mole %;
wherein the inherent viscosity of the polyester is from 0.35 to 1.2 dL/g as determined in 60/40 (wt/wt) phenol/tetrachloroethane at a concentration of 0.5 g/100 ml at 25° C.; and
wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(I) at least one polyester which comprises:
   (a) a dicarboxylic acid component comprising:
      i) 70 to 100 mole % of terephthalic acid residues;
      ii) 0 to 30 mole % of aromatic dicarboxylic acid residues having up to 20 carbon atoms; and
      iii) 0 to 10 mole % of aliphatic dicarboxylic acid residues having up to 16 carbon atoms; and
   (b) a glycol component comprising:
      i) 40 to 70 mole % of 2,2,4,4-tetramethyl-1,3-cyclobutanediol residues; and
      ii) 30 to 60 mole % of 1,4-cyclohexanedimethanol residues, and
(II) at least one thermal stabilizer or reaction products thereof;
wherein the total mole % of the dicarboxylic acid component is 100 mole %, the total mole % of the glycol component is 100 mole %; and
wherein the inherent viscosity of the polyester is from 0.35 to 0.75 dL/g as determined in 60/40 (wt/wt) phenol/tetrachloroethane at a concentration of 0.5 g/100 ml at 25° C.; and
wherein the polyester has a Tg of from 110 to 150° C. and
   wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(I) at least one polyester which comprises:
   (a) a dicarboxylic acid component comprising:
      i) 70 to 100 mole % of terephthalic acid residues;
      ii) 0 to 30 mole % of aromatic dicarboxylic acid residues having up to 20 carbon atoms; and
      iii) 0 to 10 mole % of aliphatic dicarboxylic acid residues having up to 16 carbon atoms; and
   (b) a glycol component comprising:
      i) 15 to 70 mole % of 2,2,4,4-tetramethyl-1,3-cyclobutanediol residues; and
      ii) 30 to 85 mole % of 1,4-cyclohexanedimethanol residues, and
(II) residues of at least one branching agent;
wherein the total mole % of the dicarboxylic acid component is 100 mole %, the total mole % of the glycol component is 100 mole %; and
wherein the inherent viscosity of the polyester is from 0.35 to 0.75 dL/g as determined in 60/40 (wt/wt) phenol/tetrachloroethane at a concentration of 0.5 g/100 ml at 25° C.; and
wherein the polyester has a Tg of from 100 to 150° C. and
wherein the blend has a Tg greater than 85° C., and
   wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(I) at least one polyester which comprises:
   (a) a dicarboxylic acid component comprising:
      i) 70 to 100 mole % of terephthalic acid residues;
      ii) 0 to 30 mole % of aromatic dicarboxylic acid residues having up to 20 carbon atoms; and
      iii) 0 to 10 mole % of aliphatic dicarboxylic acid residues having up to 16 carbon atoms; and
   (b) a glycol component comprising:
      i) 15 to 70 mole % of 2,2,4,4-tetramethyl-1,3-cyclobutanediol residues; and
      ii) 30 to 85 mole % of 1,4-cyclohexanedimethanol residues, and
(II) at least one thermal stabilizer or reaction products thereof;
wherein the total mole % of the dicarboxylic acid component is 100 mole %, the total mole % of the glycol component is 100 mole %; and
wherein the inherent viscosity of the polyester is from 0.35 to 0.75 dL/g as determined in 60/40 (wt/wt) phenol/tetrachloroethane at a concentration of 0.5 g/100 ml at 25° C.; and
wherein the polyester has a Tg of from 100 to 150° C. and
   wherein the blend has a Tg greater than 85° C., and
wherein a section of the film having a thickness of 10 to 50 μm has less than 200 particles per 250 mm².

In one aspect, the invention relates to an LCD compensation or protective film or sheet comprising
a polymer and polyester blend comprising at least one polyester composition comprising at least one polyester, which comprises:
(I) at least one polyester which comprises:
   (a) a dicarboxylic acid component comprising: an aliphatic dicarboxylic acid residues having up to 16 carbon atoms; and
   (b) a glycol component comprising:
      i) 15 to 70 mole % of 2,2,4,4-tetramethyl-1,3-cyclobutanediol residues; and
      ii) 30 to 85 mole % of 1,4-cyclohexanedimethanol residues,
wherein the total mole % of the dicarboxylic acid component is 100 mole %, the total mole % of the glycol component is 100 mole %; and
wherein the inherent viscosity of the polyester is from 0.35 to 1.2 dL/g as determined in 60/40 (wt/wt) phenol/tetrachloroethane at a concentration of 0.5 g/100 ml at 25° C.; and
wherein the polyester has a Tg of from 100 to 150° C. and
wherein the blend has a Tg greater than 85° C., and
   wherein a section of the film having a thickness of 10 to 50 μm has less than 200 particles per 250 mm².

In one aspect the films or sheets of this invention include articles used in a backlight array and support layer for other functional components within a display panel.

In one aspect, the polyester composition contains at least one polycarbonate.

In one aspect, the polymer comprises a polycarbonate.

In one aspect, the polycarbonate has a Tg greater than 90° C.

In one aspect, the polycarbonate polyester blend has a Tg greater than 85° C. or greater than 100° C. or 110° C. or 120° C.

In one aspect, the polyester polymer blend provides a compensation or protective film wherein the number of particles in a section of the film having a thickness of 10 to 50 μm (0.01 to 0.05 mm) is no more than 200 per 250 mm².

In one aspect, the polyester polymer blend provides a compensation or protective film wherein the number of particles in a section of the film having a thickness of at least 50 μm is 5 or less.

In one aspect, the polymer comprises a polycarbonate, a polysulfone, a cyclic olefin copolymer, a polyarylate, a polyetherimide, an amorphous polyamide, a cellulose esters or mixtures thereof.

In one aspect, the polymer has a Tg greater than 85° C., preferably greater than 100° C., more preferably greater than 110° C., even more preferably greater than 120° C.

In one aspect, the polyester composition useful in the polyester polymer blend contains no polycarbonate.

In one aspect, the polyesters useful in the invention contain less than 15 mole % ethylene glycol residues, such as, for example, 0.01 to less than 15 mole % ethylene glycol residues.

In one aspect, the polyesters useful in the invention contain no ethylene glycol residues.

In one aspect the polyester compositions useful in the invention contain at least one thermal stabilizer and/or reaction products thereof.

In one aspect, the polyesters useful in the invention contain no branching agent, or alternatively, at least one branching agent is added either prior to or during polymerization of the polyester.

In one aspect, the polyesters useful in the invention contain at least one branching agent without regard to the method or sequence in which it is added.

In one aspect, the polyesters useful in the invention are made from no 1,3-propanediol, or, 1,4-butanediol, either singly or in combination. In other aspects, 1,3-propanediol or 1,4-butanediol, either singly or in combination, may be used in the making of the polyesters useful in this invention.

In one aspect of the invention, the mole % of cis-2,2,4,4-tetramethyl-1,3-cyclobutanediol useful in certain polyesters useful in the invention is greater than 50 mole % or greater than 55 mole % of cis-2,2,4,4-tetramethyl-1,3-cyclobutanediol or greater than 70 mole % of cis-2,2,4,4-tetramethyl-1,3-cyclobutanediol; wherein the total mole percentage of cis-2,2,4,4-tetramethyl-1,3-cyclobutanediol and trans-2,2,4,4-tetramethyl-1,3-cyclobutanediol is equal to a total of 100 mole %.

In one aspect of the invention, the mole % of the isomers of 2,2,4,4-tetramethyl-1,3-cyclobutanediol useful in certain polyesters useful in the invention is from 30 to 70 mole % of cis-2,2,4,4-tetramethyl-1,3-cyclobutanediol or from 30 to 70 mole % of trans-2,2,4,4-tetramethyl-1,3-cyclobutanediol, or from 40 to 60 mole % of cis-2,2,4,4-tetramethyl-1,3-cyclobutanediol or from 40 to 60 mole % of trans-2,2,4,4-tetramethyl-1,3-cyclobutanediol, wherein the total mole percentage of cis-2,2,4,4-tetramethyl-1,3-cyclobutanediol and trans-2,2,4,4-tetramethyl-1,3-cyclobutanediol is equal to a total of 100 mole %.

In one aspect, the polyester/polymer compositions are useful in LCD compensation or protective films or sheets including, but not limited to, solvent cast, extruded, calendered that are optionally oriented, and/or molded articles including but not limited to, injection molded articles, extruded articles, cast extrusion articles, thermoformed articles, profile extrusion articles, melt spun articles, extrusion molded articles, injection blow molded articles, injection stretch blow molded articles, extrusion blow molded articles, and extrusion stretch blow molded articles.

Also, in one aspect, use of the polyester compositions of the invention minimizes and/or eliminates the drying step prior to melt processing or thermoforming.

In one aspect, certain polyesters useful in the invention can be amorphous or semicrystalline. In one aspect, certain polyesters useful in the invention can have a relatively low crystallinity. Certain polyesters useful in the invention can thus have a substantially amorphous morphology, meaning that the polyesters comprise substantially unordered regions of polymer.

In one aspect, bulk light diffuser material comprises about 80 to about 99.8 percent by weight of a miscible blend of a polymer with a polyester, and about 0.2 to about 20 percent by weight of a particulate light diffusing component, based on the total weight of the miscible blend and the light diffusing particles, plus 10 to 1000 ppm (0.0010 to 0.10 parts per hundred) of a brightness enhancing agent based on the total weight of the miscible blend and the light diffusing particles. The bulk light diffuser has a percent transmittance of at least 40% and a haze of at least less than 99% as determined by a HunterLab UltraScan Sphere 8000 Colorimeter. The bulk light diffuser further has a luminance of at least 5000 cd/m² as measured by a Topcon BM-7. The compositions of the bulk diffusers having these properties are described in the embodiments below:

In one aspect, the invention also provides methods to improve effectiveness of a light diffusing article by adding to the miscible blend of polymer and polyester comprising the article a sufficient amount of a scattering agent such as polyalkyl silsesquioxane or a mixture thereof, whereby the alkyl groups can be methyl, C₂-C₁₈ alkyl, hydride, phenyl, vinyl, or cyclohexyl, or a sufficient amount of a brightness enhancing agent such that the brightness or luminance of the article is greater than said article in the absence of the brightness enhancing agent. The brightness enhancing agent may be incorporated either as an ingredient in the light diffusing article itself, or in a cap layer formed adjacent to the light diffusing article. In one aspect both a scattering agent and a brightness enhancing agent are added to the miscible blend of polymer and polyester.

In another aspect, the invention further provides a light diffusing article comprising 0.002 to 20 wt. parts per 100 wt. part of a light transmitting miscible polymer/polyester blend, of a polyalkyl silsesquioxane or a mixture thereof, whereby the alkyl groups can be methyl, C₂-C₁₈ alkyl, hydride, phenyl, vinyl, or cyclohexyl, and 10 to 1000 ppm (0.0010 to 0.10 parts per hundred) of a brightness enhancing agent based on the total weight of the miscible polyester/polymer blend and the light diffusing particles.

In one embodiment, the polyester/polymer blend composition according to the present invention comprises 0.2 to 20 percent by weight of a particulate light diffusing component and 10 to 1000 ppm of a brightness enhancing agent based on the total weight of the miscible blend and particulate light diffusing component plus 80 to 99.8 of a miscible blend of polycarbonate and polyester comprising:
(I) about 1 to 100% percent by weight of a linear or branched polycarbonate or copolycarbonate comprising about 90 to 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent; and
(II) about 0 to about 99% of a mixture of a linear or branched polyester that is miscible with component (I);
   wherein the blend has higher luminance or brightness than the same blend without the brightness enhancing agent.

In another embodiment, the polyester/polymer blend composition according to the present invention comprises 0.2 to 20 percent by weight of a particulate light diffusing component and 10 to 1000 ppm of a brightness enhancing agent based on the total weight of the miscible blend composition and particulate light diffusing component plus 80 to 99.8 of a miscible blend comprising:
(I) about 1 to 99% percent by weight of a linear or branched polycarbonate or copolycarbonate comprising about 90 to 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent; and
(II) about 1 to about 99% of a mixture of a linear or branched polyester that is miscible with component (I) comprising:
   A. diacid residues comprising terephthalic acid residues wherein the total mole percent of diacid residues is equal to 100 mol percent;
   B. diol residues comprising about 25 to 100 mole percent 1,4-cyclohexanedimethanol residues and about 75 to 1.0 mole percent of the residues of at least one aliphatic diol wherein the total mole percent of diol residues is equal to 100 mole percent; and optionally
   C. about 0.05 to 1.0 mole percent, based on the total moles or diacid or diol residues, of the residues of at least one branching monomer having 3 or more functional groups;
      wherein that the blend has higher luminance or brightness than the same blend without the brightness enhancing agent.

In yet another embodiment, the polyester/polymer blend composition according to the present invention comprises 0.2 to 20 percent by weight of a particulate light diffusing component and optionally 10 to 1000 ppm of a brightness enhancing agent based on the total weight of the miscible blend and particulate light diffusing component plus 80 to 99.8 of a miscible polyester/polymer blend comprising:
(I) about 1 to about 99% percent by weight of a linear or branched polycarbonate or copolycarbonate comprising a diol component comprising about 90 to about 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent; and
(II) about 1 to about 99 weight % of a mixture of a linear or branched polyester that is miscible with component (I) comprising:
   A. diacid residues comprising terephthalic acid residues wherein the total mole percent of diacid residues is equal to 100 mol percent;
   B. diol residues comprising about 25 to 100 mole percent of the residues of 1,4-cyclohexanedimethanol and about 75 to 0 mole percent of the residues of at least one aliphatic diol wherein the total mole percent of diol residues is equal to 100 mole percent; and, optionally,
   C. about 0.05 to about 1.0 mole percent, based on the total diacid or diol residues, of the residues of at least one branching monomer having 3 or more functional groups;
   wherein said blend in the form of film or sheet further comprises a cap-layer containing 10 to 1000 ppm of a brightness enhancing agent and the blend has higher luminance or brightness than the same blend without the brightness enhancing agent.
      In certain embodiments, the mole percent aliphatic glycol is determined based on the nature and amount of said aliphatic glycol required to render the formed polyester (II) miscible with polycarbonate (I).

In one aspect, the invention further provides a method of making an article from the polyester/polymer blend composition of the invention comprising the steps of:
(a) blending polymer (I) and polyester (II) with the particulate light diffusing component and brightness enhancing agent;
(b) before, during or after the blending, melting the polymer (I) and the polyester (II) and adding a particulate light diffusing component and a brightness enhancing agent to form after the blending and melting, a melt blend;
(c) then cooling the melt blend to form the polyester/polymer blend composition.

In another aspect, the invention additionally covers a method of making a film or sheet from the polyester/polymer blend composition of the invention comprising the steps of:
(a) blending polymer (I) and polyester (II) with the particulate light diffusing component and brightness enhancing agent;
(b) before, during or after the blending, melting the polymer (I) and the polyester (II) and adding the particulate light diffusing component and the brightness enhancing agent to form after the blending and melting, a melt blend;
(c) then cooling the melt blend to form a film, sheet, or plate.

In one embodiment, the invention also covers a method of making a film or sheet further comprising a cap layer having a brightness enhancing agent wherein the film or sheet is made from the polyester/polymer blend composition of the invention comprising the steps of:
(a) blending a polymer (I) and a polyester (II) with a particulate light diffusing component and optionally the brightness enhancing agent;
(b) before, during or after the blending, melting the polycarbonate (I) and the polyester (II) and adding the particulate light diffusing component and optionally the brightness enhancing agent to form after the blending and melting, a melt blend;
(c) then cooling the melt blend to form a film, sheet, or plate,
   wherein the film, sheet, or plate is adjacent to a cap layer containing the brightness enhancing agent wherein the cap layer is formed during or after the formation of a film, sheet, or plate from the cooled melt blend.

In another aspect of the invention, a backlight display device comprises an optical source for generating light; a light guide for guiding the light there along including a surface for communicating the light out of the light guide to a compensation or protective film or sheet made from any of the polyester/polymer blends described herein.

### BRIEF DESCRIPTION OF THE DRAWINGS

FIG. 1 is a graph showing the effect of comonomer on the fastest crystallization half-times of modified PCT copolyesters.

FIG. 2 is a graph showing the effect of comonomer on the brittle-to-ductile transition temperature (T_{bd}) in a notched Izod impact strength test (ASTM D256, ⅛-in thick, 10-mil notch).

FIG. 3 is a graph showing the effect of 2,2,4,4-tetramethyl-1,3-cyclobutanediol composition on the glass transition temperature (Tg) of the copolyester.

FIG. 4 is a perspective view of a backlight display device.

FIG. 5 is a cross-sectional view of prismatic surfaces of the first optical substrate.

FIG. 6 is a perspective view of a backlight display device comprising a stack of optical substrates.

FIG. 7 is a perspective view of two optical substrates, feature the orientation of the prismatic surfaces.

FIG. 8 is a cross-sectional view of an optical substrate containing light diffusing particles.

### DETAILED DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

It is believed that the polyester/polymer composition(s) and films formed therefrom which are useful in the protective and compensation films or sheets for liquid crystal displays (LCDs) described herein can have a unique combination of two or more physical properties such as high impact strengths, moderate to high glass transition temperatures, chemical resistance, hydrolytic stability, toughness, low ductile-to-brittle transition temperatures, controllable color and clarity, i.e., high % transmittance or low haze, low densities, long crystallization half-times, and good processability thereby easily permitting them to be formed into articles. In some of the embodiments of the invention, the polyesters have a unique combination of the properties of good impact strength, heat resistance, chemical resistance, density and/or the combination of the properties of good impact strength, heat resistance, and processability and/or the combination of two or more of the described properties, that have never before been believed to be present in LCD compensation or protective films or sheets comprising the polyester compositions which comprise the polyester(s) as disclosed herein.

Certain embodiments according to the present invention relate to the miscible polyesters/polymer blends with high glass transition temperatures (high heat resistance) including any polyester/polymer capable of being molded into films or other articles. The polyesters can be aliphatic, aromatic, or aliphatic-aromatic in nature. The polyesters can be homopolymers or copolymers. The polyester composition may comprise a single polyester or consist of a mixture of two or more polyesters or copolyesters, giving an advantage of controlling the refractive index. In addition, for certain embodiments of the present invention, the polyesters have side chains comprising hydroxyl groups and/or carboxylic acid groups, as well as other substituents. The copolyesters of our invention may be prepared using procedures well known in the art. For example, the copolyesters may be prepared by direct condensation using a dicarboxylic acid or by ester interchange using a dialkyl dicarboxylate. Thus, a dialkyl terephthalate such as dimethyl terephthalate is ester interchanged with the diols at elevated temperatures in the presence of a catalyst. Polycondensation is carried out at increasing temperatures and at reduced pressures until a copolyester having the desired inherent viscosity is obtained. The inherent viscosities (I.V., dl/g) reported herein are measured at 25° C. using 0.5 g polymer per 100 mL of a solvent consisting of 60 parts by weight phenol and 40 parts by weight tetrachloroethane. The polymer of the miscible high Tg polyester/polymer blend compositions can be any polymer that is miscible with said polyester where the resulting Tg meets the requirements of this invention. Although not limiting the scope of the invention, preferred polymers are polycarbonate, polysulfone, cyclic olefin copolymers, polyarylates, polyetherimides, amorphous polyamides, cellulose esters, and in general any polymer having a Tg greater than 85° C., preferably greater than 100° C., more preferably greater than 110° C., even more preferably greater than 120° C. More preferred polymers are polycarbonate, polyarylate, and cellulose esters. Most preferred polymers are polycarbonates.

At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used in the specification and the appended claims, the singular forms “a,” “an” and “the” include their plural referents unless the context clearly dictates otherwise. For example, reference a “polymer,” or a “shaped article,” is intended to include the processing or making of a plurality of polymers, or articles. References to a composition containing or including “an” ingredient or “a” polymer is intended to include other ingredients or other polymers, respectively, in addition to the one named.

By “comprising” or “containing” or “including” we mean that at least the named compound, element, particle, or method step, etc., is present in the composition or article or method, but does not exclude the presence of other compounds, catalysts, materials, particles, method steps, etc, even if the other such compounds, material, particles, method steps, etc., have the same function as what is named, unless expressly excluded in the claims.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated.

“LCD film or sheet,” as used herein, refers to an optical film or sheet in an LCD assembly or panel. Thus, in certain embodiments, the LCD film or sheet can be chosen from a protective or compensation film. Another embodiment of this invention include articles used in a backlight array and support layer for other functional components within a display panel. In one embodiment, the LCD assembly comprises a backlight that generates light that is directed to a series of layers and/or films, which further direct, diffuse, and/or transmit the light to adjacent layers within an LCD.

In one embodiment, the LCD assembly comprises at least one diffuser film or sheet to produce a substantially uniformly diffused light to the first polarizer protection film within an LCD assembly. In another embodiment, the diffuser film achieves a substantially homogenous light and/or enhances brightness. In one embodiment, the diffuser film comprises the polyester. In one embodiment, the diffuser is a sheet, which can have a thickness ranging from 1 to 50 mm with a thickness variation of ±10% over an area of 1 m², such as a thickness ranging from 2 to 30 mm. In another embodiment, the diffuser is a film, which can have a thickness ranging from 2 to 30 mils, with a thickness variation of ±10% over an area of 1 m². In another embodiment, the diffuser is a film, which can have a thickness ranging from 1 to 4 mils, with a thickness variation of ±10% over an area of 1 m². In another embodiment, the diffuser is a film, which can have a thickness ranging from 2 to 3 mils, with a thickness variation of ±10% over an area of 1 m². These films can be used in combination with other films of differing refractive index to produce a reflective multilayer film, i.e., a dielectric mirror.

In one embodiment, the light diffusing substrate has surface roughness. In one embodiment, the center line average roughness Ra can be 0.1 μm or less, a ten-point average roughness Rz can be 1 μm or less, and a maximum height surface roughness Rmax can be 1 μm or less. In another embodiment, the surface roughness can have a ten-point average roughness Rz of 0.5 μm or less, and a maximum height surface roughness of Rmax of 0.5 μm or less. In another embodiment, the surface roughness can have a ten-point average roughness Rz of 0.3 μm or less.

In another embodiment, the LCD assembly comprises a compensation film, which compensates for light transmitting through anisotropic crystal pathways. Accordingly, in one embodiment, the compensation film comprises the polyester/polymer blend. In another embodiment, the LCD comprises a brightness enhancing film. Accordingly, in one embodiment, the brightness enhancing film comprises the polyester. In one embodiment, the LCD comprises a protective layer for the polyvinyl alcohol polarizer. Accordingly, in one embodiment, the protective layer comprises the polyester/polymer blend.

In one embodiment, the protective film or sheet has at least one property chosen from toughness, clarity, chemical resistance, Tg, and hydrolytic stability. In one embodiment, the compensation film has at least one property chosen from toughness, clarity, chemical resistance, Tg, dimensional stability, thermal stability, hydrolytic stability, and optical properties.

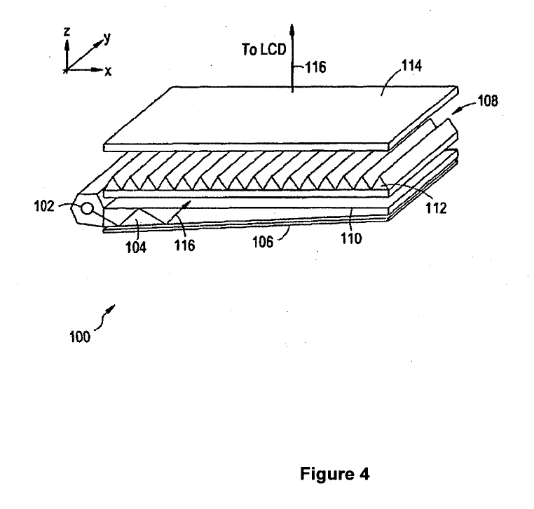

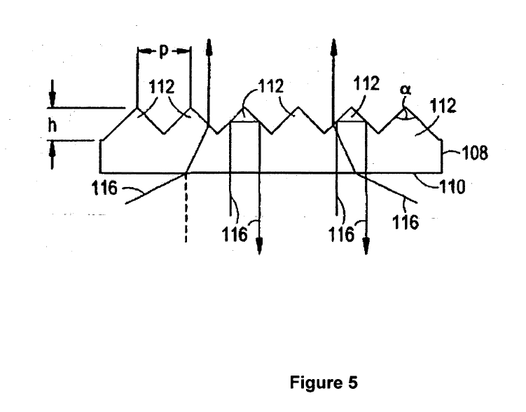

FIG. 4 is a perspective view of backlight display device 100. Backlight display device 100 comprises an optical source 102 for generating light 116, and a first optical substrate 108 for receiving light 116. First optical substrate 108 is positioned adjacent to optical source 102 and above light guide 104, which directs light 116 emanating from optical source 102. First optical substrate 108 comprises, on one side thereof, a planar surface 110 and on a second, opposing side thereof, a prismatic surface 112 (FIG. 5), such as 3M's prism film VIKUITI BEF (brightness enhancing film). Reflective device 106 is shown in planar form facing the planar surface 110 of the first optical substrate 108 such that light guide 104 is sandwiched between the reflective device 106 and the first optical substrate 108. A second optical substrate 114 faces the prismatic surface of the first optical substrate 108.

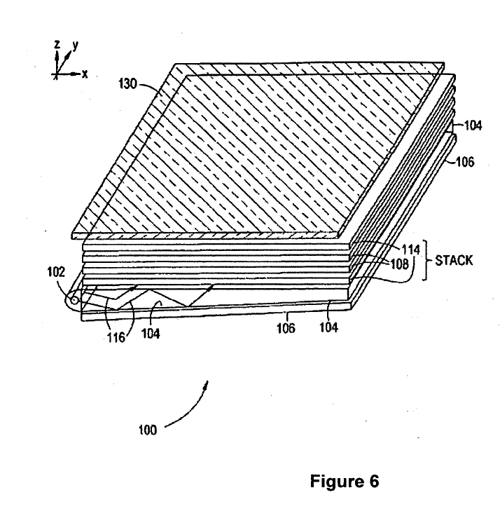

In operation, optical source 102 generates light 116 that is directed by light guide 104 by total internal reflection along reflective device 106. Reflective device 106 reflects the light 116 out of light guide 104 where it is received by first optical substrate 108. Planar surface 110 and prismatic surface 112 of first optical substrate 108 acts to redirect light 116 in a direction that is substantially normal to first optical substrate 108 (along direction z as shown). Light 116 is then directed to a second optical substrate 114 located above the first optical substrate 108, where second optical substrate 114 acts to diffuse light 116 (diffuser film or sheet). Light 116 proceeds from the second optical substrate 114 to the polarizer and the liquid crystal array 130 (shown in FIG. 6).

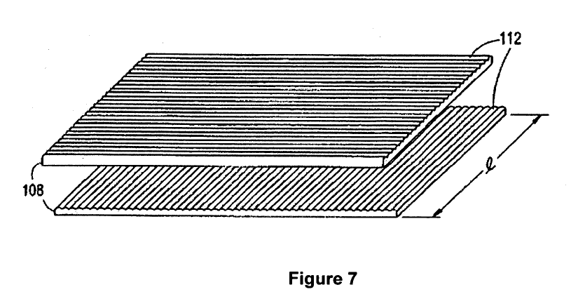

FIG. 5 is a cross-sectional view of the first optical substrate 108, showing the prismatic surface 112 and opposing planar surface 110. It will be appreciated that the second optical substrate 114 may also include the aforesaid planar and prismatic surfaces 110 and 112. Alternatively, optical substrates 108 and 114 may comprise opposing planar surfaces 110 or opposing prismatic surfaces 112. The opposing surfaces may also include a matte finish, for example a surface replicated from a sand blasted, laser machined, milled or electric discharged machine master as well as the planar and prismatic surfaces. FIG. 5 also depicts the prismatic surface 112 of optical substrate 108 having a peak angle, [α], a height, h, a pitch, p, and a length, l (FIG. 7), any of which may have prescribed values or may have values which are randomized or at least pseudo-randomized. The second optical substrate 114 may be a sheet material. Also shown in FIG. 5 are some possible pathways of light 116 in relation to the optical substrate 108.

FIG. 6 shows a perspective view of another embodiment of the backlight display device 100 including a plurality of optical substrates 108 and 114 arranged in a stack having edges that are substantially aligned with respect to each other. The stack is positioned parallel to planar LCD device 130.

FIG. 7 shows another arrangement of two optical substrates 108, where prismatic surfaces 112 are oriented such that the direction of respective prismatic surfaces 112 is positioned at an angle with respect to one another, e.g., 90 degrees. It is understood that more than two optical substrates 108 can be used where the respective prismatic surfaces can be aligned as desired.

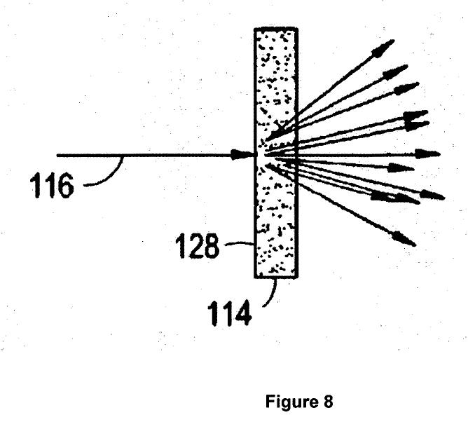

Light scattering or diffusion of light can occur as light passes through a transparent or opaque material. The amount of scattering/diffusion is often quantified as % haze. Haze can be inherent in the material, a result of a formation or molding process, or a result of surface texture (e.g., prismatic surfaces). FIG. 8 is a cross-sectional view of second optical substrate 114 containing light diffusing particles 128 (diffuser sheet). Light 116 that passes through optical substrate 114 can be emanated in directions different than the initial direction. Light scattering particles 128 can have a dimension of 0.01 to 100 micrometers, such as 0.1 to 50 micrometers, and 1 to 5 micrometers. By addition of light scattering agents or light scattering particles 128 to an optical substrate, the uniformity of diffuse light emanating from the diffuser may be improved, and further improvements may be realized when a sufficient amount of a brightness enhancing agent is added, which is an embodiment of the current invention. Light diffusing particles 128 may be round or irregular in shape, and have a refractive index different, typically a lower refractive index by about 0.1, from that of the second optical substrate 114. Typical refractive indices of the light diffusing particles 128 range from 1.4 to 1.6. Typical refractive indices of second optical substrate 114 can range from 1.47 to 1.65. Light diffusing particles 128 may be randomly, or at least pseudo-randomly, distributed or oriented in the optical substrate 114, or may be aligned in some deterministic fashion.

The lyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically the difunctional carboxylic acid can be a dicarboxylic acid and the difunctional hydroxyl compound can be a dihydric alcohol such as, for example, glycols. Furthermore, as used in this application, the term “diacid” or “dicarboxylic acid” includes multifunctional acids, such as branching agents. The term “glycol” as used in this application includes, but is not limited to, diols, glycols, and/or multifunctional hydroxyl compounds. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester. The term “foreign matter particles”, as used herein, means any particulate matter or substance that is not added intentionally to the melted polymer composition and is insoluble in that composition. The term “polymer” includes, but is not limited to, polycarbonate, polysulfone, cyclic olefin copolymers, polyarylates, polyetherimides, amorphous polyamides, cellulose esters, and in general any polymer having a Tg greater than 85° C., preferably greater than 100° C., more preferably greater than 110° C., even more preferably greater than 120° C. More preferred polymers are polycarbonate, polyarylate, and cellulose esters. Most preferred polymers are polycarbonates. The term “LCD film and/or sheet” includes compensation and protective films or articles including sheets used in a backlight array and support layer for other functional components within a display panel

In one embodiment, terephthalic acid may be used as the starting material. In another embodiment, dimethyl terephthalate may be used as the starting material. In another embodiment, mixtures of terephthalic acid and dimethyl terephthalate may be used as the starting material and/or as an intermediate material.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

In other aspects of the invention, the Tg of the polyesters useful in the LCD films or sheets of the invention can be at least one of the following ranges: 90 to 200° C.; 90 to 190° C.; 90 to 180° C.; 90 to 170° C.; 90 to 160° C.; 90 to 155° C.; 90 to 150° C.; 90 to 145° C.; 90 to 140° C.; 90 to 138° C.; 90 to 135° C.; 90 to 130° C.; 90 to 125° C.; 90 to 120° C.; 90 to 115° C.; 90 to 110° C.; 90 to 105° C.; 90 to 100° C.; 90 to 95° C.; 95 to 200° C.; 95 to 190° C.; 95 to 180° C.; 95 to 170° C.; 95 to 160° C.; 95 to 155° C.; 95 to 150° C.; 95 to 145° C.; 95 to 140° C.; 95 to 138° C.; 95 to 135° C.; 95 to 130° C.; 95 to 125° C.; 95 to 120° C.; 95 to 115° C.; 95 to 110° C.; 95 to 105° C.; 95 to less than 105° C.; 95 to 100° C.; 100 to 200° C.; 100 to 190° C.; 100 to 180° C.; 100 to 170° C.; 100 to 160° C.; 100 to 155° C.; 100 to 150° C.; 100 to 145° C.; 100 to 140° C.; 100 to 138° C.; 100 to 135° C.; 100 to 130° C.; 100 to 125° C.; 100 to 120° C.; 100 to 115° C.; 100 to 110° C.; 105 to 200° C.; 105 to 190° C.; 105 to 180° C.; 105 to 170° C.; 105 to 160° C.; 105 to 155° C.; 105 to 150° C.; 105 to 145° C.; 105 to 140° C.; 105 to 138° C.; 105 to 135° C.; 105 to 130° C.; 105 to 125° C.; 105 to 120° C.; 105 to 115° C.; 105 to 110° C.; greater than 105 to 125° C.; greater than 105 to 120° C.; greater than 105 to 115° C.; greater than 105 to 110° C.; 110 to 200° C.; 110 to 190° C.; 110 to 180° C.; 110 to 170° C.; 110 to 160° C.; 110 to 155° C.; 110 to 150° C.; 110 to 145° C.; 110 to 140° C.; 110 to 138° C.; 110 to 135° C.; 110 to 130° C.; 110 to 125° C.; 110 to 120° C.; 110 to 115° C.; 115 to 200° C.; 115 to 190° C.; 115 to 180° C.; 115 to 170° C.; 115 to 160° C.; 115 to 155° C.; 115 to 150° C.; 115 to 145° C.; 115 to 140° C.; 115 to 138° C.; 115 to 135° C.; 110 to 130° C.; 115 to 125° C.; 115 to 120° C.; 120 to 200° C.; 120 to 190° C.; 120 to 180° C.; 120 to 170° C.; 120 to 160° C.; 120 to 155° C.; 120 to 150° C.; 120 to 145° C.; 120 to 140° C.; 120 to 138° C.; 120 to 135° C.; 120 to 130° C.; 125 to 200° C.; 125 to 190° C.; 125 to 180° C.; 125 to 170° C.; 125 to 160° C.; 125 to 155° C.; 125 to 150° C.; 125 to 145° C.; 125 to 140° C.; 125 to 138° C.; 125 to 135° C.; 127 to 200° C.; 127 to 190° C.; 127 to 180° C.; 127 to 170° C.; 127 to 160° C.; 127 to 150° C.; 127 to 145° C.; 127 to 140° C.; 127 to 138° C.; 127 to 135° C.; 130 to 200° C.; 130 to 190° C.; 130 to 180° C.; 130 to 170° C.; 130 to 160° C.; 130 to 155° C.; 130 to 150° C.; 130 to 145° C.; 130 to 140° C.; 130 to 138° C.; 130 to 135° C.; 135 to 200° C.; 135 to 190° C.; 135 to 180° C.; 135 to 170° C.; 135 to 160° C.; 135 to 155° C.; 135 to 150° C.; 135 to 145° C.; 135 to 140° C.; 140 to 200° C.; 140 to 190° C.; 140 to 180° C.; 140 to 170° C.; 140 to 160° C.; 140 to 155° C.; 140 to 150° C.; 140 to 145° C.; 148 to 200° C.; 148 to 190° C.; 148 to 180° C.; 148 to 170° C.; 148 to 160° C.; 148 to 155° C.; 148 to 150° C.; 150 to 200° C.; 150 to 190° C.; 150 to 180° C.; 150 to 170° C.; 150 to 160; 155 to 190° C.; 155 to 180° C.; 155 to 170° C.; and 155 to 165° C.

In other aspects of the invention, the glycol component for the polyesters useful in the LCD compensation or protective films or articles used in a backlight array and support layer for other functional components within a display panel which includes but are not limited to at least one of the following combinations of ranges: 10 to 99 mole % 2,2,4,4-tetramethyl-1,3-cyclobutanediol and 1 to 90 mole % 1,4-cyclohexanedimethanol; 10 to 95 mole % 2,2,4,4-tetramethyl-1,3-cyclobutanediol and 5 to 90 mole % 1,4-cyclohexanedimethanol; 10 to 90 mole % 2,2,4,4-tetramethyl-1,3-cyclobutanediol and 10 to 90 mole % 1,4-cyclohexanedimethanol; 10 to 85 mole % 2,2,4,4-tetramethyl-1,3-cyclobutanediol and 15 to 90 mole % 1,4-cyclohexanedimethanol; 10 to 80 mole % 2,2,4,4-tetramethyl-1,3-cyclobutanediol and 20 to 90 mole % 1,4-cyclohexanedimethanol, 10 to 75 mole % 2,2,4,4-tetramethyl-1,3-cyclobutanediol and 25 to 90 mole % 1,4-cyclohexanedimethanol; 10 to 70 mole % 2,2,4,4-tetramethyl-1,3-cyclobutanediol and 30 to 90 mole % 1,4-cyclohexanedimethanol; 10 to 65 mole % 2,2,4,4-tetramethyl-1,3-cyclobutanediol and 35 to 90 mole % 1,4-cyclohexanedimethanol; 10 to 60 mole % 2,2,4,4-tetramethyl-1,3-cyclobutanediol and 40 to 90 mole % 1,4-cyclohexanedimethanol; 10 to 55 mole % 2,2,4,4-tetramethyl-1,3-cyclobutanediol and 45 to 90 mole % 1,4 -cyclohexanedimethanol; 10 to 50 mole % 2,2,4,4-tetramethyl-1,3-cyclobutanediol and 50 to 90 mole % 1,4-cyclohexanedimethanol; 10 to less than 50 mole % 2,2,4,4-tetramethyl-1,3-cyclobutanediol and greater than 50 to 90 mole % 1,4-cyclohexanedimethanol; 10 to 45 mole % 2,2,4,4-tetramethyl-1,3-cyclobutanediol and 55 to 90 mole % 1,4-cyclohexanedimethanol; 10 to 40 mole % 2,2,4,4-tetramethyl-1,3-cyclobutanediol and 60 to 90 mole % 1,4-cyclohexanedimethanol; 10 to 35 mole % 2,2,4,4-tetramethyl-1,3-cyclobutanediol and 65 to 90 mole % 1,4-cyclohexanedimethanol; 10 to less than 35 mole % 2,2,4,4-tetramethyl-1,3-cyclobutanediol and greater than 65 up to 90 mole % 1,4-cyclohexanedimethanol; 10 to 30 mole % 2,2,4,4-tetramethyl-1,3-cyclobutanediol and 70 to 90 mole % 1,4-cyclohexanedimethanol; 10 to 25 mole % 2,2,4,4-tetramethyl-1,3-cyclobutanediol and greater than 75 to 90 mole % 1,4-cyclohexanedimethanol; 11 to 25 mole % 2,2,4,4-tetramethyl-1,3-cyclobutanediol and 75 to 89 mole % 1,4-cyclohexanedimethanol; 12 to 25 mole % 2,2,4,4-tetramethyl-1,3-cyclobutanediol and 75 to 88 mole % 1,4-cyclohexanedimethanol; and 13 to 25 mole % 2,2,4,4-tetramethyl-1,3-cyclobutanediol and 75 to 87 mole % 1,4-cyclohexanedimethanol;

In other aspects of the invention, the glycol component for the polyesters useful in the LCD compensation or protective films or articles used in a backlight array and support layer for other functional components within a display panel which includes but are not limited to at least one of the following combinations of ranges: 14 to 99 mole % 2,2,4,4-tetramethyl-1,3-cyclobutanediol and 1 to 86 mole % 1,4-cyclohexanedimethanol; 14 to 95 mole % 2,2,4,4-tetramethyl-1,3-cyclobutanediol and 5 to 86 mole % 1,4-cyclohexanedimethanol; 14 to 90 mole % 2,2,4,4-tetramethyl-1,3-cyclobutanediol and 10 to 86 mole % 1,4-cyclohexanedimethanol; 14 to 85 mole % 2,2,4,4-tetramethyl-1,3-cyclobutanediol and 15 to 86 mole % 1,4-cyclohexanedimethanol; 14 to 80 mole % 2,2,4,4-tetramethyl-1,3-cyclobutanediol and 20 to 86 mole % 1,4-cyclohexanedimethanol, 14 to 75 mole % 2,2,4,4-tetramethyl-1,3-cyclobutanediol and 25 to 86 mole % 1,4-cyclohexanedimethanol; 14 to 70 mole % 2,2,4,4-tetramethyl-1,3-cyclobutanediol and 30 to 86 mole % 1,4-cyclohexanedimethanol; 14 to 65 mole % 2,2,4,4-tetramethyl-1,3-cyclobutanediol and 35 to 86 mole % 1,4-cyclohexanedimethanol; 14 to 60 mole % 2,2,4,4-tetramethyl-1,3-cyclobutanediol and 40 to 86 mole % 1,4-cyclohexanedimethanol; 14 to 55 mole % 2,2,4,4-tetramethyl-1,3-cyclobutanediol and 45 to 86 mole % 1,4-cyclohexanedimethanol; and 14 to 50 mole % 2,2,4,4-tetramethyl-1,3-cyclobutanediol and 50 to 86 mole % 1,4-cyclohexanedimethanol.

In other aspects of the invention, the glycol component for the polyesters useful in the LCD compensation or protective films or articles used in a backlight array and support layer for other functional components within a display panel which includes but are not limited to at least one of the following combinations of ranges: 14 to less than 50 mole % 2,2,4,4-tetramethyl-1,3-cyclobutanediol and greater than 50 up to 86 mole % 1,4-cyclohexanedimethanol; 14 to 45 mole % 2,2,4,4-tetramethyl-1,3-cyclobutanediol and 55 to 86 mole % 1,4-cyclohexanedimethanol; 14 to 40 mole % 2,2,4,4-tetramethyl-1,3-cyclobutanediol and 60 to 86 mole % 1,4-cyclohexanedimethanol; 14 to 35 mole % 2,2,4,4-tetramethyl-1,3-cyclobutanediol and 65 to 86 mole % 1,4-cyclohexanedimethanol; 14 to 30 mole % 2,2,4,4-tetramethyl-1,3-cyclobutanediol and 70 to 86 mole % 1,4-cyclohexanedimethanol; and 14 to 25 mole % 2,2,4,4-tetramethyl-1,3-cyclobutanediol and 75 to 86 mole % 1,4-cyclohexanedimethanol.

In other aspects of the invention, the glycol component for the polyesters useful in the LCD compensation or protective films or articles used in a backlight array and support layer for other functional components within a display panel which includes but are not limited to at least one of the following combinations of ranges: 15 to 99 mole % 2,2,4,4-tetramethyl-1,3-cyclobutanediol and 1 to 85 mole % 1,4-cyclohexanedimethanol; 15 to 95 mole % 2,2,4,4-tetramethyl-1,3-cyclobutanediol and 5 to 85 mole % 1,4-cyclohexanedimethanol; 15 to 90 mole % 2,2,4,4-tetramethyl-1,3-cyclobutanediol and 10 to 85 mole % 1,4-cyclohexanedimethanol; 15 to 85 mole % 2,2,4,4-tetramethyl-1,3-cyclobutanediol and 15 to 85 mole % 1,4-cyclohexanedimethanol; 15 to 80 mole % 2,2,4,4-tetramethyl-1,3-cyclobutanediol and 20 to 85 mole % 1,4-cyclohexanedimethanol, 15 to 75 mole % 2,2,4,4-tetramethyl-1,3-cyclobutanediol and 25 to 85 mole % 1,4-cyclohexanedimethanol; 15 to 70 mole % 2,2,4,4-tetramethyl-1,3-cyclobutanediol and 30 to 85 mole % 1,4-cyclohexanedimethanol; 15 to 65 mole % 2,2,4,4-tetramethyl-1,3-cyclobutanediol and 35 to 85 mole % 1,4-cyclohexanedimethanol; 15 to 60 mole % 2,2,4,4-tetramethyl-1,3-cyclobutanediol and 40 to 85 mole % 1,4-cyclohexanedimethanol; 15 to 55 mole % 2,2,4,4-tetramethyl-1,3-cyclobutanediol and 45 to 85 mole % 1,4-cyclohexanedimethanol; and 15 to 50 mole % 2,2,4,4-tetramethyl-1,3-cyclobutanediol and 50 to 85 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 15 to less than 50 mole % 2,2,4,4-tetramethyl-1,3-cyclobutanediol and greater than 50 up to 85 mole % 1,4-cyclohexanedimethanol; 15 to 45 mole % 2,2,4,4-tetramethyl-1,3-cyclobutanediol and 55 to 85 mole % 1,4-cyclohexanedimethanol; 15 to 40 mole % 2,2,4,4-tetramethyl-1,3-cyclobutanediol and 60 to 85 mole % 1,4-cyclohexanedimethanol; 15 to 35 mole % 2,2,4,4-tetramethyl-1,3-cyclobutanediol and 65 to 85 mole % 1,4-cyclohexanedimethanol; 15 to 30 mole % 2,2,4,4-tetramethyl-1,3-cyclobutanediol and 70 to 85 mole % 1,4-cyclohexanedimethanol; 15 to 25 mole % 2,2,4,4-tetramethyl-1,3-cyclobutanediol and 75 to 85 mole % 1,4-cyclohexanedimethanol; 15 to 20 mole % 2,2,4,4-tetramethyl-1,3-cyclobutanediol and 75 to 80 mole % 1,4-cyclohexanedimethanol; and 17 to 23 mole % 2,2,4,4-tetramethyl-1,3-cyclobutanediol and 77 to 83 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 20 to 99 mole % 2,2,4,4-tetramethyl-1,3-cyclobutanediol and 1 to 80 mole % 1,4-cyclohexanedimethanol; 20 to 95 mole % 2,2,4,4-tetramethyl-1,3-cyclobutanediol and 5 to 80 mole % 1,4-cyclohexanedimethanol; 20 to 90 mole % 2,2,4,4-tetramethyl-1,3-cyclobutanediol and 10 to 80 mole % 1,4-cyclohexanedimethanol; 20 to 85 mole % 2,2,4,4-tetramethyl-1,3-cyclobutanediol and 15 to 80 mole % 1,4-cyclohexanedimethanol; 20 to 80 mole % 2,2,4,4-tetramethyl-1,3-cyclobutanediol and 20 to 80 mole % 1,4-cyclohexanedimethanol, 20 to 75 mole % 2,2,4,4-tetramethyl-1,3-cyclobutanediol and 25 to 80 mole % 1,4-cyclohexanedimethanol; 20 to 70 mole % 2,2,4,4-tetramethyl-1,3-cyclobutanediol and 30 to 80 mole % 1,4-cyclohexanedimethanol; 20 to 65 mole % 2,2,4,4-tetramethyl-1,3-cyclobutanediol and 35 to 80 mole % 1,4-cyclohexanedimethanol; 20 to 60 mole % 2,2,4,4-tetramethyl-1,3-cyclobutanediol and 40 to 80 mole % 1,4-cyclohexanedimethanol; 20 to 55 mole % 2,2,4,4-tetramethyl-1,3-cyclobutanediol and 45 to 80 mole % 1,4-cyclohexanedimethanol; 20 to 50 mole % 2,2,4,4-tetramethyl-1,3-cyclobutanediol and 50 to 80 mole % 1,4-cyclohexanedimethanol; 20 to 45 mole % 2,2,4,4-tetramethyl-1,3-cyclobutanediol and 55 to 80 mole % 1,4-cyclohexanedimethanol; 20 to 40 mole % 2,2,4,4-tetramethyl-1,3-cyclobutanediol and 60 to 80 mole % 1,4-cyclohexanedimethanol; 20 to 35 mole % 2,2,4,4-tetramethyl-1,3-cyclobutanediol and 65 to 80 mole % 1,4-cyclohexanedimethanol; 20 to 30 mole % 2,2,4,4-tetramethyl-1,3-cyclobutanediol and 70 to 80 mole % 1,4-cyclohexanedimethanol; and 20 to 25 mole % 2,2,4,4-tetramethyl-1,3-cyclobutanediol and 75 to 80 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 25 to 99 mole % 2,2,4,4-tetramethyl-1,3-cyclobutanediol and 1 to 75 mole % 1,4-cyclohexanedimethanol; 25 to 95 mole % 2,2,4,4-tetramethyl-1,3-cyclobutanediol and 5 to 75 mole % 1,4-cyclohexanedimethanol; 25 to 90 mole % 2,2,4,4-tetramethyl-1,3-cyclobutanediol and 10 to 75 mole % 1,4-cyclohexanedimethanol; 25 to 85 mole % 2,2,4,4-tetramethyl-1,3-cyclobutanediol and 15 to 75 mole % 1,4-cyclohexanedimethanol; 25 to 80 mole % 2,2,4,4-tetramethyl-1,3-cyclobutanediol and 20 to 75 mole % 1,4-cyclohexanedimethanol, 25 to 75 mole % 2,2,4,4-tetramethyl-1,3-cyclobutanediol and 25 to 75 mole % 1,4-cyclohexanedimethanol; 25 to 70 mole % 2,2,4,4-tetramethyl-1,3-cyclobutanediol and 30 to 75 mole % 1,4-cyclohexanedimethanol; 25 to 65 mole % 2,2,4,4-tetramethyl-1,3-cyclobutanediol and 35 to 75 mole % 1,4-cyclohexanedimethanol; 25 to 60 mole % 2,2,4,4-tetramethyl-1,3-cyclobutanediol and 40 to 75 mole % 1,4-cyclohexanedimethanol; 25 to 55 mole % 2,2,4,4-tetramethyl-1,3-cyclobutanediol and 45 to 75 mole % 1,4-cyclohexanedimethanol; 25 to 50 mole % 2,2,4,4-tetramethyl-1,3-cyclobutanediol and 50 to 75 mole % 1,4-cyclohexanedimethanol; 25 to 45 mole % 2,2,4,4-tetramethyl-1,3-cyclobutanediol and 55 to 75 mole % 1,4-cyclohexanedimethanol; 25 to 40 mole % 2,2,4,4-tetramethyl-1,3-cyclobutanediol and 60 to 75 mole % 1,4-cyclohexanedimethanol; 25 to 35 mole % 2,2,4,4-tetramethyl-1,3-cyclobutanediol and 65 to 75 mole % 1,4-cyclohexanedimethanol; and 25 to 30 mole % 2,2,4,4-tetramethyl-1,3-cyclobutanediol and 70 to 75 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 30 to 99 mole % 2,2,4,4-tetramethyl-1,3-cyclobutanediol and 1 to 70 mole % 1,4-cyclohexanedimethanol; 30 to 95 mole % 2,2,4,4-tetramethyl-1,3-cyclobutanediol and 5 to 70 mole % 1,4-cyclohexanedimethanol; 30 to 90 mole % 2,2,4,4-tetramethyl-1,3-cyclobutanediol and 10 to 70 mole % 1,4-cyclohexanedimethanol; 30 to 85 mole % 2,2,4,4-tetramethyl-1,3-cyclobutanediol and 15 to 70 mole % 1,4-cyclohexanedimethanol; 30 to 80 mole % 2,2,4,4-tetramethyl-1,3-cyclobutanediol and 20 to 70 mole % 1,4-cyclohexanedimethanol, 30 to 75 mole % 2,2,4,4-tetramethyl-1,3-cyclobutanediol and 25 to 70 mole % 1,4-cyclohexanedimethanol; 30 to 70 mole % 2,2,4,4-tetramethyl-1,3-cyclobutanediol and 30 to 70 mole % 1,4-cyclohexanedimethanol; 30 to 65 mole % 2,2,4,4-tetramethyl-1,3-cyclobutanediol and 35 to 70 mole % 1,4-cyclohexanedimethanol; 30 to 60 mole % 2,2,4,4-tetramethyl-1,3-cyclobutanediol and 40 to 70 mole % 1,4-cyclohexanedimethanol; 30 to 55 mole % 2,2,4,4-tetramethyl-1,3-cyclobutanediol and 45 to 70 mole % 1,4-cyclohexanedimethanol; 30 to 50 mole % 2,2,4,4-tetramethyl-1,3-cyclobutanediol and 50 to 70 mole % 1,4-cyclohexanedimethanol; 30 to less than 50 mole % 2,2,4,4-tetramethyl-1,3-cyclobutanediol and greater than 50 to 70 mole % 1,4-cyclohexanedimethanol; 30 to 45 mole % 2,2,4,4-tetramethyl-1,3-cyclobutanediol and 55 to 70 mole % 1,4-cyclohexanedimethanol; 30 to 40 mole % 2,2,4,4-tetramethyl-1,3-cyclobutanediol and 60 to 70 mole % 1,4-cyclohexanedimethanol; 30 to 35 mole % 2,2,4,4-tetramethyl-1,3-cyclobutanediol and 65 to 70 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 35 to 99 mole % 2,2,4,4-tetramethyl-1,3-cyclobutanediol and 1 to 65 mole % 1,4-cyclohexanedimethanol; 35 to 95 mole % 2,2,4,4-tetramethyl-1,3-cyclobutanediol and 5 to 65 mole % 1,4-cyclohexanedimethanol; 35 to 90 mole % 2,2,4,4-tetramethyl-1,3-cyclobutanediol and 10 to 65 mole % 1,4-cyclohexanedimethanol; 35 to 85 mole % 2,2,4,4-tetramethyl-1,3-cyclobutanediol and 15 to 65 mole % 1,4-cyclohexanedimethanol; 35 to 80 mole % 2,2,4,4-tetramethyl-1,3-cyclobutanediol and 20 to 65 mole % 1,4-cyclohexanedimethanol, 35 to 75 mole % 2,2,4,4-tetramethyl-1,3-cyclobutanediol and 25 to 65 mole % 1,4-cyclohexanedimethanol; 35 to 70 mole % 2,2,4,4-tetramethyl-1,3-cyclobutanediol and 30 to 65 mole % 1,4-cyclohexanedimethanol; 35 to 65 mole % 2,2,4,4-tetramethyl-1,3-cyclobutanediol and 35 to 65 mole % 1,4-cyclohexanedimethanol; 35 to 60 mole % 2,2,4,4-tetramethyl-1,3-cyclobutanediol and 40 to 65 mole % 1,4-cyclohexanedimethanol; 35 to 55 mole % 2,2,4,4-tetramethyl-1,3-cyclobutanediol and 45 to 65 mole % 1,4-cyclohexanedimethanol; 35 to 50 mole % 2,2,4,4-tetramethyl-1,3-cyclobutanediol and 50 to 65 mole % 1,4-cyclohexanedimethanol; 35 to less than 50 mole % 2,2,4,4-tetramethyl-1,3-cyclobutanediol and greater than 50 to 65 mole % 1,4-cyclohexanedimethanol; 35 to 45 mole % 2,2,4,4-tetramethyl-1,3-cyclobutanediol and 55 to 65 mole % 1,4-cyclohexanedimethanol; 35 to 40 mole % 2,2,4,4-tetramethyl-1,3-cyclobutanediol and 60 to 65 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 37 to 99 mole % 2,2,4,4-tetramethyl-1,3-cyclobutanediol and 1 to 63 mole % 1,4-cyclohexanedimethanol; 37 to 95 mole % 2,2,4,4-tetramethyl-1,3-cyclobutanediol and 5 to 63 mole % 1,4-cyclohexanedimethanol; 37 to 90 mole % 2,2,4,4-tetramethyl-1,3-cyclobutanediol and 10 to 63 mole % 1,4-cyclohexanedimethanol; 37 to 85 mole % 2,2,4,4-tetramethyl-1,3-cyclobutanediol and 15 to 63 mole % 1,4-cyclohexanedimethanol; 37 to 80 mole % 2,2,4,4-tetramethyl-1,3-cyclobutanediol and 20 to 63 mole % 1,4-cyclohexanedimethanol, 37 to 75 mole % 2,2,4,4-tetramethyl-1,3-cyclobutanediol and 25 to 63 mole % 1,4-cyclohexanedimethanol; 37 to 70 mole % 2,2,4,4-tetramethyl-1,3-cyclobutanediol and 30 to 63 mole % 1,4-cyclohexanedimethanol; 37 to 63 mole % 2,2,4,4-tetramethyl-1,3-cyclobutanediol and 37 to 63 mole % 1,4-cyclohexanedimethanol; 37 to 60 mole % 2,2,4,4-tetramethyl-1,3-cyclobutanediol and 40 to 63 mole % 1,4-cyclohexanedimethanol; 37 to 55 mole % 2,2,4,4-tetramethyl-1,3-cyclobutanediol and 45 to 63 mole % 1,4-cyclohexanedimethanol; 37 to 50 mole % 2,2,4,4-tetramethyl-1,3-cyclobutanediol and 50 to 63 mole % 1,4-cyclohexanedimethanol; 37 to less than 50 mole % 2,2,4,4-tetramethyl-1,3-cyclobutanediol and greater than 50 to 63 mole % 1,4-cyclohexanedimethanol; 37 to 45 mole % 2,2,4,4-tetramethyl-1,3-cyclobutanediol and 55 to 63 mole % 1,4-cyclohexanedimethanol; 37 to 40 mole % 2,2,4,4-tetramethyl-1,3-cyclobutanediol and 60 to 63 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 40 to 99 mole % 2,2,4,4-tetramethyl-1,3-cyclobutanediol and 1 to 60 mole % 1,4-cyclohexanedimethanol; 40 to 95 mole % 2,2,4,4-tetramethyl-1,3-cyclobutanediol and 5 to 60 mole % 1,4-cyclohexanedimethanol; 40 to 90 mole % 2,2,4,4-tetramethyl-1,3-cyclobutanediol and 10 to 60 mole % 1,4-cyclohexanedimethanol; 40 to 85 mole % 2,2,4,4-tetramethyl-1,3-cyclobutanediol and 15 to 60 mole % 1,4-cyclohexanedimethanol; 40 to 80 mole % 2,2,4,4-tetramethyl-1,3-cyclobutanediol and 20 to 60 mole % 1,4-cyclohexanedimethanol, 40 to 75 mole % 2,2,4,4-tetramethyl-1,3-cyclobutanediol and 25 to 60 mole % 1,4-cyclohexanedimethanol; 40 to 70 mole % 2,2,4,4-tetramethyl-1,3-cyclobutanediol and 30 to 60 mole % 1,4-cyclohexanedimethanol; 40 to 65 mole % 2,2,4,4-tetramethyl-1,3-cyclobutanediol and 35 to 60 mole % 1,4-cyclohexanedimethanol; 40 to 60 mole % 2,2,4,4-tetramethyl-1,3-cyclobutanediol and 40 to 60 mole % 1,4-cyclohexanedimethanol; 40 to 55 mole % 2,2,4,4-tetramethyl-1,3-cyclobutanediol and 45 to 60 mole % 1,4-cyclohexanedimethanol; 40 to less than 50 mole % 2,2,4,4-tetramethyl-1,3-cyclobutanediol and greater than 50 to 60 mole % 1,4-cyclohexanedimethanol; 40 to 50 mole % 2,2,4,4-tetramethyl-1,3-cyclobutanediol and 50 to 60 mole % 1,4-cyclohexanedimethanol; and 40 to 45 mole % 2,2,4,4-tetramethyl-1,3-cyclobutanediol and 55 to 60 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 45 to 99 mole % 2,2,4,4-tetramethyl-1,3-cyclobutanediol and 1 to 55 mole % 1,4-cyclohexanedimethanol; 45 to 95 mole % 2,2,4,4-tetramethyl-1,3-cyclobutanediol and 5 to 55 mole % 1,4-cyclohexanedimethanol; 45 to 90 mole % 2,2,4,4-tetramethyl-1,3-cyclobutanediol and 10 to 55 mole % 1,4-cyclohexanedimethanol; 45 to 85 mole % 2,2,4,4-tetramethyl-1,3-cyclobutanediol and 15 to 55 mole % 1,4-cyclohexanedimethanol; 45 to 80 mole % 2,2,4,4-tetramethyl-1,3-cyclobutanediol and 20 to 55 mole % 1,4-cyclohexanedimethanol, 45 to 75 mole % 2,2,4,4-tetramethyl-1,3-cyclobutanediol and 25 to 55 mole % 1,4-cyclohexanedimethanol; 45 to 70 mole % 2,2,4,4-tetramethyl-1,3-cyclobutanediol and 30 to 55 mole % 1,4-cyclohexanedimethanol; 45 to 65 mole % 2,2,4,4-tetramethyl-1,3-cyclobutanediol and 35 to 55 mole % 1,4-cyclohexanedimethanol; 45 to 60 mole % 2,2,4,4-tetramethyl-1,3-cyclobutanediol and 40 to 55 mole % 1,4-cyclohexanedimethanol; greater than 45 to 55 mole % 2,2,4,4-tetramethyl-1,3-cyclobutanediol and 45 to less than 55 mole % 1,4-cyclohexanedimethanol; 45 to 55 mole % 2,2,4,4-tetramethyl-1,3-cyclobutanediol and 45 to 55 mole % 1,4-cyclohexanedimethanol; and 45 to 50 mole % 2,2,4,4-tetramethyl-1,3-cyclobutanediol and 50 to 55 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: greater than 50 to 99 mole % 2,2,4,4-tetramethyl-1,3-cyclobutanediol and 1 to less than 50 mole % 1,4-cyclohexanedimethanol; greater than 50 to 95 mole % 2,2,4,4-tetramethyl-1,3-cyclobutanediol and 5 to less than 50 mole % 1,4-cyclohexanedimethanol; greater than 50 to 90 mole % 2,2,4,4-tetramethyl-1,3-cyclobutanediol and 10 to less than 50 mole % 1,4-cyclohexanedimethanol; greater than 50 to 85 mole % 2,2,4,4-tetramethyl-1,3-cyclobutanediol and 15 to less than 50 mole % 1,4-cyclohexanedimethanol; greater than 50 to 80 mole % 2,2,4,4-tetramethyl-1,3-cyclobutanediol and 20 to less than 50 mole % 1,4-cyclohexanedimethanol, greater than 50 to 75 mole % 2,2,4,4-tetramethyl-1,3-cyclobutanediol and 25 to less than 50 mole % 1,4-cyclohexanedimethanol; greater than 50 to 70 mole % 2,2,4,4-tetramethyl-1,3-cyclobutanediol and 30 to less than 50 mole % 1,4-cyclohexanedimethanol; greater than 50 to 65 mole % 2,2,4,4-tetramethyl-1,3-cyclobutanediol and 35 to less than 50 mole % 1,4-cyclohexanedimethanol; greater than 50 to 60 mole % 2,2,4,4-tetramethyl-1,3-cyclobutanediol and 40 to less than 50 mole % 1,4-cyclohexanedimethanol; and greater than 50 to 55 mole % 2,2,4,4-tetramethyl-1,3-cyclobutanediol and 45 to less than 50 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 50 to 99 mole % 2,2,4,4-tetramethyl-1,3-cyclobutanediol and 1 to 50 mole % 1,4-cyclohexanedimethanol; 50 to 95 mole % 2,2,4,4-tetramethyl-1,3-cyclobutanediol and 5 to 50 mole % 1,4-cyclohexanedimethanol; 50 to 90 mole % 2,2,4,4-tetramethyl-1,3-cyclobutanediol and 10 to 50 mole % 1,4-cyclohexanedimethanol; 50 to 85 mole % 2,2,4,4-tetramethyl-1,3-cyclobutanediol and 15 to 50 mole % 1,4-cyclohexanedimethanol; 50 to 80 mole % 2,2,4,4-tetramethyl-1,3-cyclobutanediol and 20 to 50 mole % 1,4-cyclohexanedimethanol, 50 to 75 mole % 2,2,4,4-tetramethyl-1,3-cyclobutanediol and 25 to 50 mole % 1,4-cyclohexanedimethanol; 50 to 70 mole % 2,2,4,4-tetramethyl-1,3-cyclobutanediol and 30 to 50 mole % 1,4-cyclohexanedimethanol; 50 to 65 mole % 2,2,4,4-tetramethyl-1,3-cyclobutanediol and 35 to 50 mole % 1,4-cyclohexanedimethanol; 50 to 60 mole % 2,2,4,4-tetramethyl-1,3-cyclobutanediol and 40 to 50 mole % 1,4-cyclohexanedimethanol; and 50 to 55 mole % 2,2,4,4-tetramethyl-1,3-cyclobutanediol and 45 to 50 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 55 to 99 mole % 2,2,4,4-tetramethyl-1,3-cyclobutanediol and 1 to 45 mole % 1,4-cyclohexanedimethanol; 55 to 95 mole % 2,2,4,4-tetramethyl-1,3-cyclobutanediol and 5 to 45 mole % 1,4-cyclohexanedimethanol; 55 to 90 mole % 2,2,4,4-tetramethyl-1,3-cyclobutanediol and 10 to 45 mole % 1,4-cyclohexanedimethanol; 55 to 85 mole % 2,2,4,4-tetramethyl-1,3-cyclobutanediol and 15 to 45 mole % 1,4-cyclohexanedimethanol; 55 to 80 mole % 2,2,4,4-tetramethyl-1,3-cyclobutanediol and 20 to 45 mole % 1,4-cyclohexanedimethanol, 55 to 75 mole % 2,2,4,4-tetramethyl-1,3-cyclobutanediol and 25 to 45 mole % 1,4-cyclohexanedimethanol; 55 to 70 mole % 2,2,4,4-tetramethyl-1,3-cyclobutanediol and 30 to 45 mole % 1,4-cyclohexanedimethanol; 55 to 65 mole % 2,2,4,4-tetramethyl-1,3-cyclobutanediol and 35 to 45 mole % 1,4-cyclohexanedimethanol; and 55 to 60 mole % 2,2,4,4-tetramethyl-1,3-cyclobutanediol and 40 to 45 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 60 to 99 mole % 2,2,4,4-tetramethyl-1,3-cyclobutanediol and 1 to 40 mole % 1,4-cyclohexanedimethanol; 60 to 95 mole % 2,2,4,4-tetramethyl-1,3-cyclobutanediol and 5 to 40 mole % 1,4-cyclohexanedimethanol; 60 to 90 mole % 2,2,4,4-tetramethyl-1,3-cyclobutanediol and 10 to 40 mole % 1,4-cyclohexanedimethanol; 60 to 85 mole % 2,2,4,4-tetramethyl-1,3-cyclobutanediol and 15 to 40 mole % 1,4-cyclohexanedimethanol; 60 to 80 mole % 2,2,4,4-tetramethyl-1,3-cyclobutanediol and 20 to 40 mole % 1,4-cyclohexanedimethanol, 60 to 75 mole % 2,2,4,4-tetramethyl-1,3-cyclobutanediol and 25 to 40 mole % 1,4-cyclohexanedimethanol; and 60 to 70 mole % 2,2,4,4-tetramethyl-1,3-cyclobutanediol and 30 to 40 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 65 to 99 mole % 2,2,4,4-tetramethyl-1,3-cyclobutanediol and 1 to 35 mole % 1,4-cyclohexanedimethanol; 65 to 95 mole % 2,2,4,4-tetramethyl-1,3-cyclobutanediol and 5 to 35 mole % 1,4-cyclohexanedimethanol; 65 to 90 mole % 2,2,4,4-tetramethyl-1,3-cyclobutanediol and 10 to 35 mole % 1,4-cyclohexanedimethanol; 65 to 85 mole % 2,2,4,4-tetramethyl-1,3-cyclobutanediol and 15 to 35 mole % 1,4-cyclohexanedimethanol; 65 to 80 mole % 2,2,4,4-tetramethyl-1,3-cyclobutanediol and 20 to 35 mole % 1,4-cyclohexanedimethanol, 65 to 75 mole % 2,2,4,4-tetramethyl-1,3-cyclobutanediol and 25 to 35 mole % 1,4-cyclohexanedimethanol; and 65 to 70 mole % 2,2,4,4-tetramethyl-1,3-cyclobutanediol and 35 to 40 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 70 to 99 mole % 2,2,4,4-tetramethyl-1,3-cyclobutanediol and 1 to 30 mole % 1,4-cyclohexanedimethanol; 70 to 95 mole % 2,2,4,4-tetramethyl-1,3-cyclobutanediol and 5 to 30 mole % 1,4-cyclohexanedimethanol; 70 to 90 mole % 2,2,4,4-tetramethyl-1,3-cyclobutanediol and 10 to 30 mole % 1,4-cyclohexanedimethanol; 70 to 85 mole % 2,2,4,4-tetramethyl-1,3-cyclobutanediol and 15 to 30 mole % 1,4-cyclohexanedimethanol; 70 to 80 mole % 2,2,4,4-tetramethyl-1,3-cyclobutanediol and 20 to 30 mole % 1,4-cyclohexanedimethanol, and 70 to 75 mole % 2,2,4,4-tetramethyl-1,3-cyclobutanediol and 25 to 30 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 75 to 99 mole % 2,2,4,4-tetramethyl-1,3-cyclobutanediol and 1 to 25 mole % 1,4-cyclohexanedimethanol; 75 to 95 mole % 2,2,4,4-tetramethyl-1,3-cyclobutanediol and 5 to 25 mole % 1,4-cyclohexanedimethanol; 75 to 90 mole % 2,2,4,4-tetramethyl-1,3-cyclobutanediol and 10 to 25 mole % 1,4-cyclohexanedimethanol; 75 to 85 mole % 2,2,4,4-tetramethyl-1,3-cyclobutanediol and 15 to 25 mole % 1,4-cyclohexanedimethanol, and 75 to 80 mole % 2,2,4,4-tetramethyl-1,3-cyclobutanediol and 20 to 25 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: 80 to 99 mole % 2,2,4,4-tetramethyl-1,3-cyclobutanediol and 1 to 20 mole % 1,4-cyclohexanedimethanol; 80 to 95 mole % 2,2,4,4-tetramethyl-1,3-cyclobutanediol and 5 to 20 mole % 1,4-cyclohexanedimethanol; 80 to 90 mole % 2,2,4,4-tetramethyl-1,3-cyclobutanediol and 10 to 20 mole % 1,4-cyclohexanedimethanol, and 80 to 85 mole % 2,2,4,4-tetramethyl-1,3-cyclobutanediol and 15 to 20 mole % 1,4-cyclohexanedimethanol.

In other aspects of the invention, the glycol component for the polyesters useful in the LCD compensation or protective films or articles used in a backlight array and support layer for other functional components within a display panel which include but are not limited to at least one of the following combinations of ranges: greater than 45 to 55 mole % 2,2,4,4-tetramethyl-1,3-cyclobutanediol and 45 to less than 55 mole % 1,4-cyclohexanedimethanol; greater than 45 to 50 mole % 2,2,4,4-tetramethyl-1,3-cyclobutanediol and 50 to less than 55 mole % 1,4-cyclohexanedimethanol; 46 to 55 mole % 2,2,4,4-tetramethyl-1,3-cyclobutanediol and 45 to 54 mole % 1,4-cyclohexanedimethanol; and 46 to 65 mole % 2,2,4,4-tetramethyl-1,3-cyclobutanediol and 35 to 54 mole % 1,4-cyclohexanedimethanol.

In addition to the diols set forth above, the polyesters useful in the polyester compositions of the LCD film and/or sheet such as compensation and protective films or articles used in a backlight array and support layer for other functional components within a display panel of the invention may also be made from 1,3-propanediol, 1,4-butanediol, or mixtures thereof. It is contemplated that compositions of the invention made from 1,3-propanediol, 1,4-butanediol, or mixtures thereof can possess at least one of the Tg ranges described herein, at least one of the inherent viscosity ranges described herein, and/or at least one of the glycol or diacid ranges described herein. In addition or in the alternative, the polyesters made from 1,3-propanediol or 1,4-butanediol or mixtures thereof may also be made from 1,4-cyclohexanedmethanol in at least one of the following amounts: from 0.1 to 99 mole %; from 0.1 to 90 mole %; from 0.1 to 80 mole %; from 0.1 to 70 mole %; from 0.1 to 60 mole %; from 0.1 to 50 mole %; from 0.1 to 40 mole %; from 0.1 to 35 mole %; from 0.1 to 30 mole %; from 0.1 to 25 mole %; from 0.1 to 20 mole %; from 0.1 to 15 mole %; from 0.1 to 10 mole %; from 0.1 to 5 mole %; from 1 to 99 mole %; from 1 to 90 mole %, from 1 to 80 mole %; from 1 to 70 mole %; from 1 to 60 mole %; from 1 to 50 mole %; from 1 to 40 mole %; from 1 to 35 mole %; from 1 to 30 mole %; from 1 to 25 mole %; from 1 to 20 mole %; from 1 to 15 mole %; from 1 to 10 mole %; from 1 to 5 mole %; from 5 to 99 mole %, from 5 to 90 mole %, from 5 to 80 mole %; 5 to 70 mole %; from 5 to 60 mole %; from 5 to 50 mole %; from 5 to 40 mole %; from 5 to 35 mole %; from 5 to 30 mole %; from 5 to 25 mole %; from 5 to 20 mole %; and from 5 to 15 mole %; from 5 to 10 mole %; from 10 to 99 mole %; from 10 to 90 mole %; from 10 to 80 mole %; from 10 to 70 mole %; from 10 to 60 mole %; from 10 to 50 mole %; from 10 to 40 mole %; from 10 to 35 mole %; from 10 to 30 mole %; from 10 to 25 mole %; from 10 to 20 mole %; from 10 to 15 mole %; from 20 to 99 mole %; from 20 to 90 mole %; from 20 to 80 mole %; from 20 to 70 mole %; from 20 to 60 mole %; from 20 to 50 mole %; from 20 to 40 mole %; from 20 to 35 mole %; from 20 to 30 mole %; and from 20 to 25 mole %.

In certain embodiments the polyester comprises ethylene glycol from 0.1 to 43 mole % and 1,4-cyclohexanedimethanol from 57 to 99.9 mole %. In certain embodiments the polyester comprises ethylene glycol from 0 to 43 mole % and 1,4-cyclohexanedimethanol from 57 to 100 mole %. In certain embodiments the polyester comprises ethylene glycol from 0.1 to 43 mole % and 1,4-cyclohexanedimethanol from 57 to 99.9 mole %. In other embodiments the polyester comprises ethylene glycol from 0 to 43 mole % and 1,4-cyclohexanedimethanol from 57 to 100 mole % and from 0 to 35 mole % isophthalic acid and 65 to 100 mole % terephthalic acid.

For certain embodiments of the invention, the polyesters useful in the invention may exhibit at least one of the following inherent viscosities as determined in 60/40 (wt/wt) phenol/tetrachloroethane at a concentration of 0.5 g/100 ml at 25° C.: 0.10 to 1.2 dL/g; 0.10 to 1.1 dL/g; 0.10 to 1 dL/g; 0.10 to less than 1 dL/g; 0.10 to 0.98 dL/g; 0.10 to 0.95 dL/g; 0.10 to 0.90 dL/g; 0.10 to 0.85 dL/g; 0.10 to 0.80 dL/g; 0.10 to 0.75 dL/g; 0.10 to less than 0.75 dL/g; 0.10 to 0.72 dL/g; 0.10 to 0.70 dL/g; 0.10 to less than 0.70 dL/g; 0.10 to 0.68 dL/g; 0.10 to less than 0.68 dL/g; 0.10 to 0.65 dL/g; 0.20 to 1.2 dL/g; 0.20 to 1.1 dL/g; 0.20 to 1 dL/g; 0.20 to less than 1 dL/g; 0.20 to 0.98 dL/g; 0.20 to 0.95 dL/g; 0.20 to 0.90 dL/g; 0.20 to 0.85 dL/g; 0.20 to 0.80 dL/g; 0.20 to 0.75 dL/g; 0.20 to less than 0.75 dL/g; 0.20 to 0.72 dL/g; 0.20 to 0.70 dL/g; 0.20 to less than 0.70 dL/g; 0.20 to 0.68 dL/g; 0.20 to less than 0.68 dL/g; 0.20 to 0.65 dL/g; 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments of the invention, the polyesters useful in the invention may exhibit at least one of the following inherent viscosities as determined in 60/40 (wt/wt) phenol/tetrachloroethane at a concentration of 0.5 g/100 ml at 25° C.: 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g; 0.68 to 1.2 dL/g; 0.68 to 1.1 dL/g; 0.68 to 1 dL/g; 0.68 to less than 1 dL/g; 0.68 to 0.98 dL/g; 0.68 to 0.95 dL/g; 0.68 to 0.90 dL/g; 0.68 to 0.85 dL/g; 0.68 to 0.80 dL/g; 0.68 to 0.75 dL/g; 0.68 to less than 0.75 dL/g; 0.68 to 0.72 dL/g; greater than 0.76 dL/g to 1.2 dL/g; greater than 0.76 dL/g to 1.1 dL/g; greater than 0.76 dL/g to 1 dL/g; greater than 0.76 dL/g to less than 1 dL/g; greater than 0.76 dL/g to 0.98 dL/g; greater than 0.76 dL/g to 0.95 dL/g; greater than 0.76 dL/g to 0.90 dL/g; greater than 0.80 dL/g to 1.2 dL/g; greater than 0.80 dL/g to 1.1 dL/g; greater than 0.80 dL/g to 1 dL/g; greater than 0.80 dL/g to less than 1 dL/g; greater than 0.80 dL/g to 1.2 dL/g; greater than 0.80 dL/g to 0.98 dL/g; greater than 0.80 dL/g to 0.95 dL/g; greater than 0.80 dL/g to 0.90 dL/g.

It is contemplated that compositions useful in the LCD compensation and protective films or sheets of the invention can possess at least one of the inherent viscosity ranges described herein and at least one of the monomer ranges for the compositions described herein unless otherwise stated. It is also contemplated that compositions useful in the LCD compensation and protective films or sheets of the invention can posses at least one of the Tg ranges described herein and at least one of the monomer ranges for the compositions described herein unless otherwise stated. It is also contemplated that compositions useful in the LCD compensation and protective films or sheets of the invention can posses at least one of the Tg ranges described herein, at least one of the inherent viscosity ranges described herein, and at least one of the monomer ranges for the compositions described herein unless otherwise stated.

For certain embodiments according to the present invention, it is contemplated that the polycarbonate polyester blends possess a Tg greater than 90° C., or greater than 100° C. or greater that 110° C.

For certain polyesters, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30% cis or 50 to 70 mole % cis and 50 to 30% trans; or 60 to 70 mole % cis and 30 to 40 mole % trans; or greater than 70 mole cis and less than 30 mole % trans; wherein the total sum of the mole percentages for cis- and trans-2,2,4,4-tetramethyl-1,3-cyclobutanediol is equal to 100 mole %. The molar ratio of cis/trans 1,4-cyclohexandimethanol can vary within the range of 50/50 to 0/100, such as between 40/60 to 20/80.

In certain embodiments, terephthalic acid or an ester thereof, such as, for example, dimethyl terephthalate, or a mixture of terephthalic acid and an ester thereof, makes up most or all of the dicarboxylic acid component used to form the polyesters useful in the invention. In certain embodiments, terephthalic acid residues can make up a portion or all of the dicarboxylic acid component used to form the present polyester at a concentration of at least 70 mole %, such as at least 80 mole %, at least 90 mole %, at least 95 mole %, at least 99 mole %, or 100 mole %. In certain embodiments, higher amounts of terephthalic acid can be used in order to produce a higher impact strength polyester. In one embodiment, dimethyl terephthalate is part or all of the dicarboxylic acid component used to make the polyesters useful in the present invention. For the purposes of this disclosure, the terms “terephthalic acid” and “dimethyl terephthalate” are used interchangeably herein. In all embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, the dicarboxylic acid component of the polyester useful in the compensation and protective film and sheet of this invention can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, 4,4′-diphenic acid and esters thereof. In one embodiment, the modifying aromatic dicarboxylic acid is isophthalic acid.

The carboxylic acid component of the polyesters useful in the compensation and protective film and sheet of this invention can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The 1,4-cyclohexanedimethanol may be cis, trans, or a mixture thereof, for example a cis/trans ratio of 60:40 to 40:60. In another embodiment, the trans-1,4-cyclohexanedimethanol can be present in an amount of 60 to 80 mole %.

The glycol component of the polyester portion of the polyester composition useful in the invention can contain 25 mole % or less of one or more modifying glycols which are not 2,2,4,4-tetramethyl-1,3-cyclobutanediol or 1,4-cyclohexanedimethanol; in one embodiment, the polyesters useful in the invention may contain less than 15 mole % of one or more modifying glycols. In another embodiment, the polyesters useful in the invention can contain 10 mole % or less of one or more modifying glycols. In another embodiment, the polyesters useful in the invention can contain 5 mole % or less of one or more modifying glycols. In another embodiment, the polyesters useful in the invention can contain 3 mole % or less of one or more modifying glycols. In another embodiment, the polyesters useful in the invention can contain 0 mole % modifying glycols. Certain embodiments can also contain 0.01 or more mole %, such as 0.1 or more mole %, 1 or more mole %, 5 or more mole %, or 10 or more mole % of one or more modifying glycols. Thus, if present, it is contemplated that the amount of one or more modifying glycols can range from any of these preceding endpoint values including, for example, from 0.01 to 15 mole % and from 0.1 to 10 mole %.

Modifying glycols useful in the polyesters useful in the invention refer to diols other than 2,2,4,4,-tetramethyl-1,3-cyclobutanediol and 1,4-cyclohexanedimethanol and may contain 2 to 16 carbon atoms. Examples of suitable modifying glycols include, but are not limited to, ethylene glycol, 1,2-propanediol, 1,3-propanediol, neopentyl glycol, 1,4-butanediol, 1,5-pentanediol, 1,6-hexanediol, p-xylene glycol or mixtures thereof. In one embodiment, the modifying glycol is ethylene glycol. In another embodiment, the modifying glycols are 1,3-propanediol and/or 1,4-butanediol. In another embodiment, ethylene glycol is excluded as a modifying diol. In another embodiment, 1,3-propanediol and 1,4-butanediol are excluded as modifying diols. In another embodiment, 2,2-dimethyl-1,3-propanediol is excluded as a modifying diol.

The polyesters and/or the polycarbonates useful in the polyesters compositions of the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The polyester(s) useful in the invention can thus be linear or branched. The polycarbonate can also be linear or branched. In certain embodiments, the branching monomer or agent may be added prior to and/or during and/or after the polymerization of the polycarbonate.

Examples of branching monomers include, but are not limited to, multifunctional acids or multifunctional alcohols such as trimellitic acid, trimellitic anhydride, hemimellitic acid, hemimellitic anhydride, trimesic acid, tricarballyic acid, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The glass transition temperature (Tg) of the polyesters useful in the invention was determined using a TA DSC 2920 from Thermal Analyst Instrument at a scan rate of 20° C./min.

Because of the long crystallization half-times (e.g., greater than 5 minutes) at 170° C. exhibited by certain polyesters useful in the present invention, it is possible to produce injection blow molded LCD compensation and protective films or sheets, injection stretch blow molded LCD compensation and protective films or sheets, extrusion blow molded LCD compensation and protective films or sheets and extrusion stretch blow molded LCD compensation and protective films or sheets. The polyesters of the invention can be amorphous or semicrystalline. In one aspect, certain polyesters useful in the invention can have relatively low crystallinity. Certain polyesters useful in the invention can thus have a substantially amorphous morphology, meaning that the polyesters comprise substantially unordered regions of polymer.

In one embodiment, an “amorphous” polyester can have a crystallization half-time of greater than 5 minutes at 170° C. or greater than 10 minutes at 170° C. or greater than 50 minutes at 170° C. or greater than 100 minutes at 170° C. In one embodiment, of the invention, the crystallization half-times are greater than 1,000 minutes at 170° C. In another embodiment of the invention, the crystallization half-times of the polyesters useful in the invention are greater than 10,000 minutes at 170° C. The crystallization half time of the polyester, as used herein, may be measured using methods well-known to persons of skill in the art. For example, the crystallization half time of the polyester, t_{1/2}, can be determined by measuring the light transmission of a sample via a laser and photo detector as a function of time on a temperature controlled hot stage. This measurement can be done by exposing the polymers to a temperature, Tₘₐₓ, and then cooling it to the desired temperature. The sample can then be held at the desired temperature by a hot stage while transmission measurements are made as a function of time. Initially, the sample can be visually clear with high light transmission and becomes opaque as the sample crystallizes. The crystallization half-time is the time at which the light transmission is halfway between the initial transmission and the final transmission. Tₘₐₓ is defined as the temperature required to melt the crystalline domains of the sample (if crystalline domains are present). The sample can be heated to Tₘₐₓ to condition the sample prior to crystallization half time measurement. The absolute Tₘₐₓ temperature is different for each composition. For example PCT can be heated to some temperature greater than 290° C. to melt the crystalline domains.

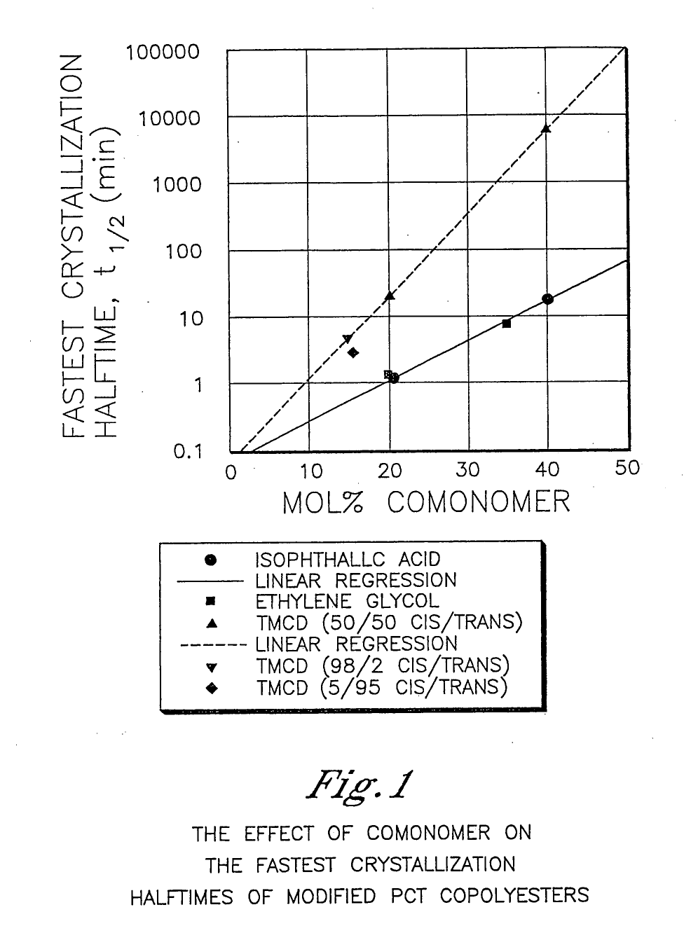

As shown in Table 1 and FIG. 1 of the Examples, 2,2,4,4-tetramethyl-1,3-cyclobutanediol is more effective than other comonomers such as ethylene glycol and isophthalic acid at increasing the crystallization half-time, i.e., the time required for a polymer to reach half of its maximum crystallinity. By decreasing the crystallization rate of PCT, i.e. increasing the crystallization half-time, amorphous articles based on modified PCT may be fabricated by methods known in the art such as extrusion, injection molding, and the like. As shown in Table 1, these materials can exhibit higher glass transition temperatures and lower densities than other modified PCT copolyesters.

The polyesters can exhibit an improvement in toughness combined with processability for some of the embodiments of the invention. For example, it is unexpected that lowering the inherent viscosity slightly of the polyesters useful in the invention results in a more processable melt viscosity while retaining good physical properties of the polyesters such as toughness and heat resistance.

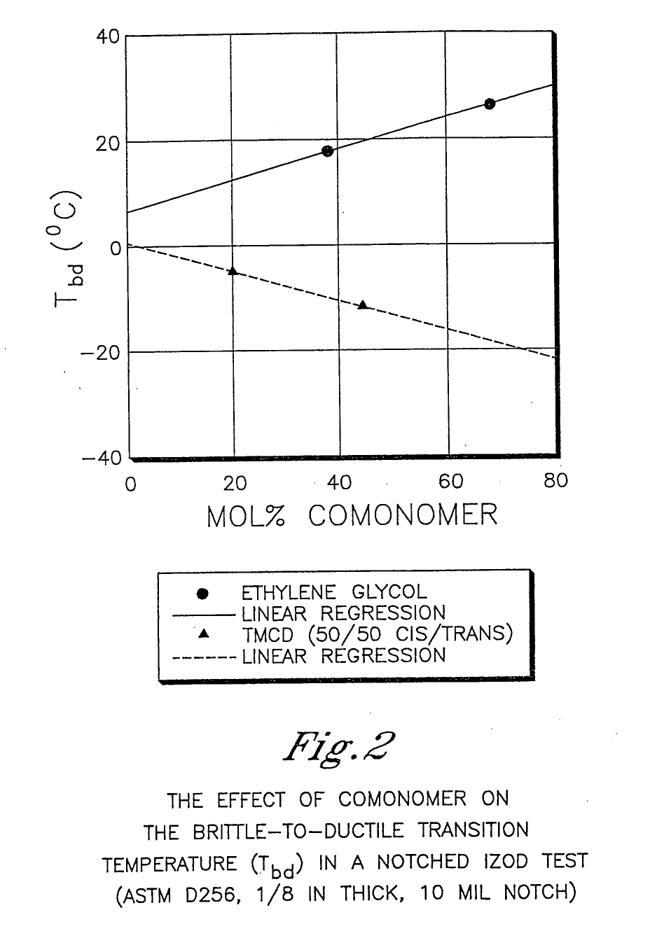

Increasing the content of 1,4-cyclohexanedimethanol in a copolyester based on terephthalic acid, ethylene glycol, and 1,4-cyclohexanedimethanol can improve toughness, which can be determined by the brittle-to-ductile transition temperature in a notched Izod impact strength test as measured by ASTM D256. This toughness improvement, by lowering of the brittle-to-ductile transition temperature with 1,4-cyclohexanedimethanol, is believed to occur due to the flexibility and conformational behavior of 1,4-cyclohexanedimethanol in the copolyester. Incorporating 2,2,4,4-tetramethyl-1,3-cyclobutanediol into PCT is believed to improve toughness, by lowering the brittle-to-ductile transition temperature, as shown in Table 2 and FIG. 2 of the Examples. This is unexpected given the rigidity of 2,2,4,4-tetramethyl-1,3-cyclobutanediol.

In one embodiment, the melt viscosity of the polyester(s) useful in the invention is less than 100,000, or less than 60,000 or less than 30,000 poise as measured a 1 radian/second on a rotary melt rheometer at 290° C. In another embodiment, the melt viscosity of the polyester(s) useful in the invention is less than 20,000 poise as measured a 1 radian/second on a rotary melt rheometer at 290° C.

In one embodiment, the melt viscosity of the polyester(s) useful in the invention is less than 15,000 poise as measured at 1 radian/second (rad/sec) on a rotary melt rheometer at 290° C. In one embodiment, the melt viscosity of the polyester(s) useful in the invention is less than 10,000 poise as measured at 1 radian/second (rad/sec) on a rotary melt rheometer at 290° C. In another embodiment, the melt viscosity of the polyester(s) useful in the invention is less than 6,000 poise as measured at 1 radian/second on a rotary melt rheometer at 290° C. Viscosity at rad/sec is related to processability. Typical polymers have viscosities of less than 10,000 poise as measured at 1 radian/second when measured at their processing temperature. Polyesters are typically not processed above 290° C. Polycarbonate is typically processed at 290° C. The viscosity at 1 rad/sec of a typical 12 melt flow rate polycarbonate is 7000 poise at 290° C.

In one embodiment, certain polyesters useful in this invention are visually clear. The term “visually clear” is defined herein as an appreciable absence of cloudiness, haziness, and/or muddiness, when inspected visually. When the polyesters are blended with polycarbonate, including bisphenol A polycarbonates, the blends can be visually clear in one aspect of the invention.

The present polyesters possess one or more of the following properties. In other embodiments, the polyesters useful in the invention may have a yellowness index (ASTM D-1925) of less than 50, such as less than 20.

In one embodiment, polyesters of this invention exhibit superior notched toughness in thick sections. Notched Izod impact strength, as described in ASTM D256, is a common method of measuring toughness. When tested by the Izod method, polymers can exhibit either a complete break failure mode, where the test specimen breaks into two distinct parts, or a partial or no break failure mode, where the test specimen remains as one part. The complete break failure mode is associated with low energy failure. The partial and no break failure modes are associated with high energy failure. A typical thickness used to measure Izod toughness is ⅛″. At this thickness, very few polymers are believed to exhibit a partial or no break failure mode, polycarbonate being one notable example. When the thickness of the test specimen is increased to 14″, however, no commercial amorphous materials exhibit a partial or no break failure mode. In one embodiment, compositions of the present example exhibit a no break failure mode when tested in Izod using a ¼″ thick specimen.

The polyesters useful in the invention can possess one or more of the following properties. In one embodiment, the polyesters useful in the invention exhibit a notched Izod impact strength of at least 150 J/m (3 ft-lb/in) at 23° C. with a 10-mil notch in a 3.2 mm (⅛-inch) thick bar determined according to ASTM D256; in one embodiment, the polyesters useful in the invention exhibit a notched Izod impact strength of at least (400 J/m) 7.5 ft-lb/in at 23° C. with a 10-mil notch in a 3.2 mm (⅛-inch) thick bar determined according to ASTM D256; in one embodiment, the polyesters useful in the invention exhibit a notched Izod impact strength of at least 1000 J/m (18 ft-lb/in) at 23° C. with a 10-mil notch in a 3.2 mm (⅛-inch) thick bar determined according to ASTM D256. In one embodiment, the polyesters useful in the invention exhibit a notched Izod impact strength of at least 150 J/m (3 ft-lb/in) at 23° C. with a 10-mil notch in a 6.4 mm (¼-inch) thick bar determined according to ASTM D256; in one embodiment, the polyesters useful in the invention exhibit a notched Izod impact strength of at least (400 J/m) 7.5 ft-lb/in at 23° C. with a 10-mil notch in a 6.4 mm (¼-inch) thick bar determined according to ASTM D256; in one embodiment, the polyesters useful in the invention exhibit a notched Izod impact strength of at least 1000 J/m (18 ft-lb/in) at 23° C. with a 10-mil notch in a 6.4 mm (¼-inch) thick bar determined according to ASTM D256.

In another embodiment, certain polyesters useful in the invention can exhibit an increase in notched Izod impact strength when measured at 0° C. of at least 3% or at least 5% or at least 10% or at least 15% as compared to the notched Izod impact strength when measured at −5° C. with a 10-mil notch in a ⅛-inch thick bar determined according to ASTM D256. In addition, certain other polyesters useful in the invention can also exhibit a retention of notched Izod impact strength within plus or minus 5% when measured at 0° C. through 30° C. with a 10-mil notch in a ⅛-inch thick bar determined according to ASTM D256.

In yet another embodiment, certain polyesters useful in the invention can exhibit a retention in notched Izod impact strength with a loss of no more than 70% when measured at 23° C. with a 10-mil notch in a ¼-inch thick bar determined according to ASTM D256 as compared to notched Izod impact strength for the same polyester when measured at the same temperature with a 10-mil notch in a ⅛-inch thick bar determined according to ASTM D256.

In one embodiment, the polyesters useful in the invention and/or the polyester compositions of the invention, with or without toners, can have color values L*, a* and b*, which can be determined using a Hunter Lab Ultrascan Spectra Colorimeter manufactured by Hunter Associates Lab Inc., Reston, Va. The color determinations are averages of values measured on either pellets of the polyesters or plaques or other items injection molded or extruded from them They are determined by the L*a*b* color system of the CIE (International Commission on Illumination) (translated), wherein L* represents the lightness coordinate, a* represents the red/green coordinate, and b* represents the yellow/blue coordinate. In certain embodiments, the b* values for the polyesters useful in the invention can be from −10 to less than 10 and the L* values can be from 50 to 90. In other embodiments, the b* values for the polyesters useful in the invention can be present in one of the following ranges: −10 to 9; −10 to 8; −10 to 7; −10 to 6; −10 to 5; −10 to 4; −10 to 3; −10 to 2; from −5 to 9; −5 to 8; −5 to 7; −5 to 6; −5 to 5; −5 to 4; −5 to 3; −5 to 2; 0 to 9; 0 to 8; 0 to 7; 0 to 6; 0 to 5; 0 to 4; 0 to 3; 0 to 2; 1 to 10; 1 to 9; 1 to 8; 1 to 7; 1 to 6; 1 to 5; 1 to 4; 1 to 3; and 1 to 2. In other embodiments, the L* value for the polyesters useful in the invention can be present in one of the following ranges: 50 to 60; 50 to 70; 50 to 80; 50 to 90; 60 to 70; 60 to 80; 60 to 90; 70 to 80; 79 to 90.

In one embodiment, the polyesters useful in the invention exhibit a ductile-to-brittle transition temperature of less than 0° C. based on a 10-mil notch in a ⅛-inch thick bar as defined by ASTM D256.

In one embodiment, the polyesters useful in the invention can exhibit at least one of the following densities: a density of less than 1.2 g/ml at 23° C.; a density of less than 1.18 g/ml at 23° C.; a density of 0.8 to 1.3 g/ml at 23° C.; a density of 0.80 to 1.2 g/ml at 23° C.; a density of 0.80 to less than 1.2 g/ml at 23° C.; a density of 1.0 to 1.3 g/ml at 23° C.; a density of 1.0 to 1.2 g/ml at 23° C.; a density of 1.0 to 1.1 g/ml at 23° C.; a density of 1.13 to 1.3 g/ml at 23° C.; a density of 1.13 to 1.2 g/ml at 23° C.

In some embodiments, use of the polyester compositions useful in the invention minimizes and/or eliminates the drying step prior to melt processing and/or thermoforming.

The polyester portion of the polyester/polymer blend compositions useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

In another aspect, the invention relates to LCD compensation and protective films or sheets comprising a polyester produced by a process comprising:
(I) heating a mixture comprising the monomers useful in any of the polyesters in the invention in the presence of a catalyst at a temperature of 150 to 240° C. for a time sufficient to produce an initial polyester;
(II) heating the initial polyester of step (I) at a temperature of 240 to 320° C. for 1 to 4 hours; and
(III) removing any unreacted glycols.

Suitable catalysts for use in this process include, but are not limited to, organo-zinc or tin compounds. The use of this type of catalyst is well known in the art. Examples of catalysts useful in the present invention include, but are not limited to, zinc acetate, butyltin tris-2-ethylhexanoate, dibutyltin diacetate, and dibutyltin oxide. Other catalysts may include, but are not limited to, those based on titanium, zinc, manganese, lithium, germanium, and cobalt. Catalyst amounts can range from 10 ppm to 20,000 ppm or 10 to 10,000 ppm, or 10 to 5000 ppm or 10 to 1.000 ppm or 10 to 500 ppm, or 10 to 300 ppm or 10 to 250 based on the catalyst metal and based on the weight of the final polymer. The process can be carried out in either a batch or continuous process.

Typically, step (I) can be carried out until 50% by weight or more of the 2,2,4,4-tetramethyl-1,3-cyclobutanediol has been reacted. Step (I) may be carried out under pressure, ranging from atmospheric pressure to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

Typically, Step (II) and Step (III) can be conducted at the same time. These steps can be carried out by methods known in the art such as by placing the reaction mixture under a pressure ranging from 0.002 psig to below atmospheric pressure, or by blowing hot nitrogen gas over the mixture.

The invention further relates to a polyester product made by the process described above.

The invention further relates to a polyester/polymer blend. The blend comprises:
(a) 5 to 95 wt % of at least one of the polyesters described above; and
(b) 5 to 95 wt % of at least one polymeric component.

Suitable examples of polymeric components include, but are not limited to, nylon, polyesters different from those described herein, polyamides such as ZYTEL® from DuPont; polystyrene, polystyrene copolymers, styrene acrylonitrile copolymers, acrylonitrile butadiene styrene copolymers, poly(methylmethacrylate), acrylic copolymers, poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; polyarylate, poly(ester-carbonates); polycarbonates such as LEXAN® (a polycarbonate from General Electric); polysulfones; polysulfone ethers; and poly(ether-ketones) of aromatic dihydroxy compounds; or mixtures of any of the other foregoing polymers. The blends can be prepared by conventional processing techniques known in the art, such as melt blending or solution blending. In one embodiment, the polycarbonate is not present in the polyester composition. If polycarbonate is used in a blend in the polyester compositions useful in the invention, the blends can be visually clear. However, the polyester compositions useful in the invention also contemplate the exclusion of polycarbonate as well as the inclusion of polycarbonate.

Polycarbonates useful in the invention may be prepared according to known procedures, for example, by reacting the dihydroxyaromatic compound with a carbonate precursor such as phosgene, a haloformate or a carbonate ester, a molecular weight regulator, an acid acceptor and a catalyst. Methods for preparing polycarbonates are known in the art and are described, for example, in U.S. Pat. No. 4,452,933, where the disclosure regarding the preparation of polycarbonates is hereby incorporated by reference herein.

Examples of suitable carbonate precursors include, but are not limited to, carbonyl bromide, carbonyl chloride, or mixtures thereof; diphenyl carbonate; a di(halophenyl)carbonate, e.g., di(trichlorophenyl)carbonate, di(tribromophenyl)carbonate, and the like; di(alkylphenyl)carbonate, e.g., di(tolyl)carbonate; di(naphthyl)carbonate; di(chloronaphthyl)carbonate, or mixtures thereof; and bis-haloformates of dihydric phenols.

Examples of suitable molecular weight regulators include, but are not limited to, phenol, cyclohexanol, methanol, alkylated phenols, such as octylphenol, para-tertiary-butyl-phenol, and the like. In one embodiment, the molecular weight regulator is phenol or an alkylated phenol.

The acid acceptor may be either an organic or an inorganic acid acceptor. A suitable organic acid acceptor can be a tertiary amine and includes, but is not limited to, such materials as pyridine, triethylamine, dimethylaniline, tributylamine, and the like. The inorganic acid acceptor can be either a hydroxide, a carbonate, a bicarbonate, or a phosphate of an alkali or alkaline earth metal.

The catalysts that can be used include, but are not limited to, those that typically aid the polymerization of the monomer with phosgene. Suitable catalysts include, but are not limited to, tertiary amines such as triethylamine, tripropylamine, N,N-dimethylaniline, quaternary ammonium compounds such as, for example, tetraethylammonium bromide, cetyl triethyl ammonium bromide, tetra-n-heptylammonium iodide, tetra-n-propyl ammonium bromide, tetramethyl ammonium chloride, tetra-methyl ammonium hydroxide, tetra-n-butyl ammonium iodide, benzyltrimethyl ammonium chloride and quaternary phosphonium compounds such as, for example, n-butyltriphenyl phosphonium bromide and methyltriphenyl phosphonium bromide.

The polycarbonates useful in the polyester compositions of the invention also may be copolyestercarbonates such as those described in U.S. Pat. Nos. 3,169,121; 3,207,814; 4,194,038; 4,156,069; 4,430,484, 4,465,820, and 4,981,898, the disclosure regarding copolyestercarbonates from each of the U.S. patents is incorporated by reference herein.

Copolyestercarbonates useful in this invention can be available commercially and/or can be prepared by known methods in the art. For example, they can be typically obtained by the reaction of at least one dihydroxyaromatic compound with a mixture of phosgene and at least one dicarboxylic acid chloride, especially isophthaloyl chloride, terephthaloyl chloride, or both.

In addition, the polyester compositions and the polymer blend compositions useful in the LCD films or sheets of this invention may also contain from 0.01 to 25% by weight of the overall composition common additives such as colorants, dyes, mold release agents, flame retardants, plasticizers, nucleating agents, stabilizers, including but not limited to, UV stabilizers, thermal stabilizers and/or reaction products thereof, fillers, and impact modifiers. For example, UV additives can be incorporated into the LCD films or sheets through addition to the bulk, through application of a hard coat, or through the coextrusion of a cap layer. Examples of typical commercially available impact modifiers well known in the art and useful in this invention include, but are not limited to, ethylene/propylene terpolymers; functionalized polyolefins, such as those containing methyl acrylate and/or glycidyl methacrylate; styrene-based block copolymeric impact modifiers, and various acrylic core/shell type impact modifiers. Residues of such additives are also contemplated as part of the polyester composition.

The polyesters of the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, preferably about 0.1 to about 5 percent by weight, based on the total weigh of the polyester.

Thermal stabilizers are compounds that stabilize polyesters during polyester manufacture and/or post polymerization, including, but not limited to, phosphorous compounds, including, but not limited to, phosphoric acid, phosphorous acid, phosphonic acid, phosphinic acid, phosphonous acid, and various esters and salts thereof. The esters can be alkyl, branched alkyl, substituted alkyl, difunctional alkyl, alkyl ethers, aryl, and substituted aryl. In one embodiment, the number of ester groups present in the particular phosphorous compound can vary from zero up to the maximum allowable based on the number of hydroxyl groups present on the thermal stabilizer used. The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive. These can be present in the polyester compositions useful in the invention.

Reinforcing materials may be useful in the compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials are glass, such as, fibrous glass filaments, mixtures of glass and talc, glass and mica, and glass and polymeric fibers.

LCD films and/or sheets useful in the present invention can be of any thickness which would be apparent to one of ordinary skill in the art. In one embodiment, the films(s) of the invention have a thickness of less than 1 mil. In one embodiment, the sheets of the invention have a thickness of no less than 1 mil, typically about 2-3 mils.

The invention further relates to the LCD films and/or sheets comprising the polyester compositions of the invention. The methods of forming the polyesters into LCD films and/or sheets are well known in the art. Examples of LCD films and/or sheets of the invention including but not limited to extruded films and/or sheets, calendered films and/or sheets, compression molded films and/or sheets, solution casted films and/or sheets. Methods of making LCD film and/or sheet include but are not limited to extrusion, calendering, compression molding, and solution casting.

The invention further relates to LCD films or sheets described herein. These LCD films or sheets include, but are not limited to, extruded films or sheets, injection molded films or sheets, calendered LCD films or sheets, compression molded LCD films or sheets, and solution casted LCD films or sheets. Methods of making LCD films or sheets include, but are not limited to, extrusion molding, calendering, compression molding, and solution casting. These films or sheets may be made or subjected to further processing such as orientation (uniaxial or biaxial), heat setting, surface treatment, etc.

The invention further relates to LCD films or sheets or plates. The plates, a term used interchangeably with sheets, includes, but is not limited to, light guide plates or wedges. The LCD films, sheets or plates may be used as replacements for mother glass, liquid crystal alignment layers, antireflective film, and/or antiglare film.

In one embodiment, the invention provides a bulk light diffuser material. The bulk light diffuser material comprises about 80 to about 99.8 percent by weight of a miscible blend of a polycarbonate with a polyester, and about 0.2 to about 20 percent by weight of a particulate light diffusing component, based on the total weight of the miscible blend and the light diffusing particles, plus 10 to 1000 ppm (0.0010 to 0.10 parts per hundred) of a brightness enhancing agent based on the total weight of the miscible blend and the light diffusing particles. The term “miscible”, as used herein, is intended to mean that the blend has a single, homogeneous amorphous phase as indicated by a single composition-dependent Tg. For example, a first polymer that is miscible with second polymer may be used to “plasticize” the second polymer as illustrated, for example, in U.S. Pat. No. 6,211,309. By contrast, the term “immiscible”, as used herein, denotes a blend that shows at least 2, randomly mixed, phases and exhibits more than one Tg. Some polymers may be immiscible and yet be compatible (partial miscibility or good interfacial adhesion). A further general description of miscible and immiscible polymer blends and the various analytical techniques for their characterization may be found in Polymer Blends Volumes 1 and 2, Edited by D. R. Paul and C. B. Bucknall, 2000, John Wiley & Sons, Inc.

In one embodiment, the compensation or protective film comprises miscible high Tg polyester/polymer blend wherein the polyester is wholly aromatic, wholly aliphatic, or partially aliphatic and partially aromatic, such that the Tg of said polyester is at least 30° C., at least 50, at least 70° C., 85° C., preferably at least 100° C., more preferably at least 110° C., and even more preferably at least 120° C. In another embodiment, the film comprises miscible high Tg polyester/polycarbonate blend comprising:
(I) about 0.1 to 99.9% percent by weight of a linear or branched polycarbonate or copolycarbonate comprising about 90 to 100 mol percent, based on the total diol residues, of residues of 4,4′-isopropylidenediphenol and 0 to about 10 mol percent of the residues of at least one diol having 2 to 16 carbons, wherein the total mol percent of diol residues is equal to 100 mol percent; and
(II) about 0.1-99.9% of a mixture of a linear or branched polyester or copolyester that is miscible with component (I);
   wherein the blend has a Tg of at least 85° C. In other embodiments, the blend may have a Tg of at least 100° C., at least 110° C., and at least 120° C. In certain embodiments the Tg of the polyester is at least −50° C. or at least −35° C. or at least −10° C. or at least 0° C. or at least 15° C.

In another embodiment, the compensation or protective film comprises miscible high Tg polyester/polycarbonate blend comprising:
(I) about 1 to 99% percent by weight of a linear or branched polycarbonate or copolycarbonate comprising about 90 to 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent; and
(II) about 1-99% of a mixture of a linear or branched polyester or copolyester that is miscible with component (I) comprising:
   A. diacid residues comprising terephthalic acid residues wherein the total mole percent of diacid residues is equal to 100 mol percent;
   B. diol residues comprising about 25 to 100 mole percent 1,4-cyclohexanedimethanol residues and about 75 to 0 mole percent of the residues of at least one aliphatic glycol wherein the total mole percent of diol residues is equal to 100 mole percent; and optionally
   C. about 0.05 to 1.0 mole percent, based on the total diacid or diol residues, of the residues of a branching monomer having 3 or more functional groups;
      wherein the blend has a Tg of at least 85° C. In other representative embodiments, the blends have a Tg of at least 100° C., at least 110° C., and at least 120° C. The mole percent aliphatic glycol is determined on the nature of said aliphatic glycol required to render the formed polyester (II) miscible with polycarbonate (I) or any other possible polymers (I).

The mole percent aliphatic glycol is determined based on the nature of said aliphatic glycol required to render the formed polyester (II) miscible with polycarbonate (I) or any other possible polymers (I). The invention further includes a method of making an article from the blend composition of the invention comprising the steps of:
(a) blending polycarbonate (I) and polyester (II);
(b) before, during or after the blending, melting polycarbonate (I) and polyester (II) to form after the blending and melting, a melt blend;
(c) then cooling the melt blend to form a blend composition.

The invention further comprises a method of making an article from the blend composition of the invention comprising:
(a) blending polycarbonate (I) and polyester (II);
(b) before, during or after the blending, melting polycarbonate (I) and polyester (II) to form after the blending and melting, a melt blend;
(c) then cooling the melt blend to form a film, sheet, or plate.

Another aspect of the invention comprises a display device wherein at least one layer in the display comprises the miscible high Tg polyester/polymer blend composition of this invention. One embodiment of the invention is a process for the preparation of a novel film from at least one miscible high Tg polyester/polymer blend comprising (1) melt compounding of at least one polyester with polycarbonate and any needed additives to form a miscible high Tg polyester/polymer blend 2) melt processing the blend of (1) as a film and (3) uniaxially or biaxially orienting the film to achieve the necessary surface and optical properties. Steps (1) and (2) can occur in separate steps where either the product of (1) is collected and pelletized prior to film formation or the product of (1) leads directly to the film formation process of (2). A filtration process may occur prior to or during either one or both of the above said steps (1) and (2) such that the number of foreign matter particles having a size of preferably 10 to 50 μm (0.01 to 0.05 mm) is preferably no more than 200 per 250 mm² (0.8 particles/mm²) and the number of foreign matter particles having a size of at least 50 μm is preferably 5 or less and, more preferably, 2 or less, and most preferably 0. More preferably, the number of foreign matter particles having a size of 10 to 50 μm is no more than 100 per 250 mm². More preferably, the number of foreign matter particles having a size of 5 to 50 μm is no more than 100 per 250 mm². The polyester/polymer blend has a Tg of at least 85° C., preferably at least 100° C., more preferably at least 110° C., and even more preferably at least 120° C. Most preferred polymers are bisphenol A polycarbonates. The term “foreign matter particles”, as used herein, means any particulate matter or substance that is not added intentionally to the melted polymer composition and is insoluble in that composition.

Another embodiment of the invention is a process for the preparation of a novel film from at least one miscible high Tg polyester/polymer blend comprising (1) melt compounding of at least one polyester with polycarbonate and any needed additives to form a miscible high Tg polyester/polymer blend, (2) melt processing the blend of (1) through an appropriate film forming die, (3) casting film coming from said die of step (2) onto a thermally controllable substrate enabling controlled cooling of the blend composition of (1) in film form to achieve the necessary surface and optical properties and (4) uniaxially or biaxially orienting the film to further achieve the necessary surface and optical properties. Steps (1) and (2) can occur in separate steps where either the product of (1) is collected and pelletized prior to film formation or the product of (1) leads directly to the film formation process of (2). A filtration process occurs prior to or during either one or both of the above said steps (1) and (2) such that the number of foreign matter particles having a size of preferably 10 to 50 μm (0.01 to 0.05 mm) is preferably no more than 200 per 250 mm² (0.8 particles/mm²) and the number of foreign matter particles having a size of at least 50 μm is preferably 5 or less and, more preferably, 2 or less, and most preferably 0. More preferably, the number of foreign matter particles having a size of 10 to 50 μm is no more than 100 per 250 mm². More preferably, the number of foreign matter particles having a size of 5 to 50 μm is no more than 100 per 250 mm². The blend has a Tg of at least 85° C., preferably at least 100° C., more preferably at least 110° C., and even more preferably at least 120° C. Most preferred polymers are bisphenol A polycarbonates.

Yet another embodiment of the invention is a process for the preparation of a novel film from at least one miscible high Tg polyester/polymer blend comprising (1) melt compounding of at least one polyester with polycarbonate and any needed additives to form a miscible high Tg polyester/polymer blend, (2) melt processing the blend composition of (1) through an appropriate film forming die, and (3) casting film coming from said die of step (2) onto a thermally controllable substrate enabling controlled cooling of the blend composition of (1) in film form to achieve the necessary surface and optical properties. Steps (1) and (2) can occur in separate steps where either the product of (1) is collected and pelletized prior to film formation or the product of (1) leads directly to the film formation process of (2). A filtration process occurs prior to or during either one or both of the above said steps (1) and (2) such that the number of foreign matter particles having a size of preferably 10 to 50 μm (0.01 to 0.05 mm) is preferably no more than 200 per 250 mm² (0.8 particles/mm²) and the number of foreign matter particles having a size of at least 50 μm is preferably 5 or less and, more preferably, 2 or less, and most preferably 0. More preferably, the number of foreign matter particles having a size of 10 to 50 μm is no more than 100 per 250 mm². More preferably, the number of foreign matter particles having a size of 5 to 50 μm is no more than 100 per 250 mm². The blend has a Tg of at least 85° C., preferably at least 100° C., more preferably at least 110° C., and even more preferably at least 120° C. Most preferred polymers are bisphenol A polycarbonates.

Another embodiment of the invention is a process for the preparation of a novel film from at least one miscible high Tg polyester/polymer blend comprising (1) melt compounding of at least one polyester with polycarbonate and any needed additives to form a miscible high Tg polyester/polymer blend, (2) melt processing the blend composition of (1) through an appropriate film forming die, (3) casting film coming from said die of step (2) onto a thermally controllable substrate enabling controlled cooling of the blend composition of (1) in film form to achieve the necessary surface and optical properties, and optionally (4) uniaxially or biaxially orienting the film to further achieve the necessary surface and optical properties. Steps (1) and (2) can occur in separate steps where either the product of (1) is collected and pelletized prior to film formation or the product of (1) leads directly to the film formation process of (2). A filtration process occurs prior to or during either one or both of the above said steps (1) and (2) such that the number of foreign matter particles having a size of preferably 10 to 50 μm (0.01 to 0.05 mm) is preferably no more than 200 per 250 mm² (0.8 particles/mm²) and the number of foreign matter particles having a size of at least 50 μm is preferably 5 or less and, more preferably, 2 or less, and most preferably 0. More preferably, the number of foreign matter particles having a size of 10 to 50 μm is no more than 100 per 250 mm². More preferably, the number of foreign matter particles having a size of 5 to 50 μm is no more than 100 per 250 mm². The blend has a Tg of at least 85° C., preferably at least 100° C., more preferably at least 110° C., and even more preferably at least 120° C. Most preferred polymers are bisphenol A polycarbonates.

An additional embodiment of the invention is a process for the preparation of a novel film from at least one miscible high Tg polyester/polymer blend comprising (1) melt compounding of at least one polyester with polycarbonate and any needed additives to form a miscible high Tg polyester/polymer blend, (2) melt processing the blend composition of (1) as a film and (3) uniaxially or biaxially orienting the film to achieve the necessary surface and optical properties, wherein the melt composition is passed through a filtering process prior to or during either one or both of the above said steps (1) and (2) such that the number of foreign matter particles having a size of preferably 10 to 50 μm (0.01 to 0.05 mm) is preferably no more than 200 per 250 mm² (0.8 particles/mm²) and the number of foreign matter particles having a size of at least 50 μm is preferably 5 or less and, more preferably, 2 or less, and most preferably 0. More preferably, the number of foreign matter particles having a size of 10 to 50 μm is no more than 100 per 250 mm². More preferably, the number of foreign matter particles having a size of 5 to 50 μm is no more than 100 per 250 mm². The blend has a Tg of at least 85° C., preferably at least 100° C., more preferably at least 110° C., and even more preferably at least 120° C. Most preferred polymers are bisphenol A polycarbonates.

The resulting melt-cast film of miscible high Tg polyester/polymer blend has a smooth surface and excellent qualities of light transmission, low haze, stiffness, dimensional stability and contaminant content, and is comparable to high quality TFT grade CTA films for LCD applications prepared by the conventional solvent cast process.

The invention also provides a novel film which has the required properties for films which can be used as polarizer protection films or compensation films used in LCD displays. The film is defined as one of the compositions disclosed above and formed by one of the methods disclosed above. This film and the process used to make them have advantages over the conventional solution cast films. These advantages include: no toxic solvents are used in the process; a more robust process relative to the sensitivities of solvent casting, e.g. skinning etc.; higher draw ratios; no residual solvent in the film; controlled orientation/birefringent/compensation characteristics; control of the refractive index; ease of formation of coextruded structures for protective or compensating films due to differences in optical properties of used layers in multilayered structures.

Another aspect of the invention is a display device where at least one layer in the display comprises the miscible high Tg polyester/polymer blend composition of this invention.

Suitable light diffusing particles may comprise organic or inorganic materials, or mixtures thereof, and do not significantly adversely affect the physical properties desired in the polyester, for example impact strength or tensile strength. Examples of suitable light diffusing organic materials or scattering agents include cellulose or cellulose esters, poly(acrylates); poly (alkyl methacrylates), for example poly(methyl methacrylate) (PMMA); poly (tetrafluoroethylene) (PTFE); silicones, for example hydrolyzed poly(alkyl trialkoxysilanes) available Gelest; and mixtures comprising at least one of the foregoing organic materials, wherein the alkyl groups have from one to about twelve carbon atoms. Other light diffusing particles, or light scattering agent, include but are not limited to polyalkyl silsesquioxane or a mixture thereof, wherein the alkyl groups can be methyl, C₂-C₁₈ alkyl, hydride, phenyl, vinyl, or cyclohexyl, e.g., polymethyl silsesquioxane (“PMSQ”). Examples of suitable light diffusing inorganic materials include materials comprising antimony, titanium, barium, and zinc, for example the oxides or sulfides of the foregoing such as zinc oxide, antimony oxide and mixtures comprising at least one of the foregoing inorganic materials. Light diffusing particles typically have a diameter of about 0.5 to about 10 or about 1 to about 5 micron and a refractive index below that of the matrix. Typically the light diffusing particles can have a refractive index about 0.05 to 0.3 or 0.1 to 0.2 less than that of the matrix.

In certain embodiments the invention provides a bulk light diffuser material. The bulk light diffuser material comprises about 80 to about 99.8 percent by weight of a miscible blend of a polycarbonate with a polyester, and about 0.2 to about 20 percent by weight of a particulate light diffusing component, based on the total weight of the miscible blend and the light diffusing particles, plus 10 to 1000 ppm (0.0010 to 0.10 parts per hundred) of a brightness enhancing agent based on the total weight of the miscible blend and the light diffusing particles. The bulk light diffuser has a percent transmittance of at least 40% and a haze of at least less than 99% as determined by a HunterLab UltraScan Sphere 8000 Colorimeter. The bulk light diffuser further has a luminance of at least 5000 cd/m² as measured by a Topcon BM-7.

Certain embodiments of the invention also provide methods to improve effectiveness of a light diffusing article by adding to the miscible blend of polycarbonate and polyester comprising the article a sufficient amount of a sufficient amount of a polyalkyl silsesquioxane or a mixture thereof, whereby the alkyl groups can be methyl, C2-C18 alkyl, hydride, phenyl, vinyl, or cyclohexyl, and a sufficient amount of a brightness enhancing agent such that the brightness or luminance of the article is greater than said article in the absence of the brightness enhancing agent. The brightness enhancing agent may be incorporated either as an ingredient in the light diffusing article itself, or in a cap layer formed adjacent to the light diffusing article.

In other embodiments the invention further provides a light diffusing article comprising 0.002 to 20 wt. parts per 100 wt. part of a light transmitting miscible polycarbonate polyester blend, of a polyalkyl silsesquioxane or a mixture thereof, whereby the alkyl groups can be methyl, C2-C18 alkyl, hydride, phenyl, vinyl, or cyclohexyl, and 10 to 1000 ppm (0.0010 to 0.10 parts per hundred) of a brightness enhancing agent based on the total weight of the miscible blend and the light diffusing particles.

In one embodiment, the polyester/polymer blend composition according to the present invention comprises 0.2 to 20 percent by weight of a particulate light diffusing component and 10 to 1000 ppm of a brightness enhancing agent based on the total weight of the miscible blend and particulate light diffusing component plus 80 to 99.8 of a miscible blend comprising:
(I) about 1 to 100% percent by weight of a linear or branched polycarbonate or copolycarbonate comprising about 90 to 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent; and
(II) about 0 to about 99% of a mixture of a linear or branched polyester that is miscible with component (I),
wherein the polyester polymer blend has a Tg greater than 85° C., and
wherein a section of the blend having a thickness of 10 to 50 μm has less than 200 particles per 250 mm².

In another embodiment, the polyester/polymer blend composition according to the present invention comprises 0.2 to 20 percent by weight of a particulate light diffusing component and about 10 to about 1000 ppm of a brightness enhancing agent based on the total weight of the blend composition and particulate light diffusing component plus about 80 to about 99.8 of a miscible blend comprising:
(I) about 1 to about 99% percent by weight of a linear or branched polycarbonate or copolycarbonate comprising about 90 to 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent; and
(II) about 1 to about 99% of a mixture of a linear or branched polyester that is miscible with component (I) comprising:
   A. diacid residues comprising terephthalic acid residues wherein the total mole percent of diacid residues is equal to 100 mol percent;
   B. diol residues comprising about 25 to 100 mole percent 1,4-cyclohexanedimethanol residues and about 75 to 0 mole percent of the residues of at least one aliphatic diol wherein the total mole percent of diol residues is equal to 100 mole percent; and optionally
   C. about 0.05 to 1.0 mole percent, based on the total moles or diacid or diol residues, of the residues of at least one branching monomer having 3 or more functional groups;
      wherein the polyester polymer blend has a Tg greater than 85° C., and
      wherein a section of the blend having a thickness of 10 to 50 μm has less than 200 particles per 250 mm².

In yet another embodiment, the polyester/polymer blend composition according to the present invention comprises 0.2 to 20 percent by weight of a particulate light diffusing component and optionally 10 to 1000 ppm of a brightness enhancing agent based on the total weight of the miscible blend and particulate light diffusing component plus 80 to 99.8 of a miscible blend comprising:
(I) about 1 to about 99% percent by weight of a linear or branched polycarbonate or copolycarbonate comprising a diol component comprising about 90 to about 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent; and
(II) about 1 to about 99 weight % of a mixture of a linear or branched polyester that is miscible with component (I) comprising:
   A. diacid residues comprising terephthalic acid residues wherein the total mole percent of diacid residues is equal to 100 mol percent;
   B. diol residues comprising about 25 to 100 mole percent of the residues of 1,4-cyclohexanedimethanol and about 75 to 0 mole percent of the residues of at least one aliphatic glycol wherein the total mole percent of diol residues is equal to 100 mole percent; and, optionally,
   C. about 0.05 to about 1.0 mole percent, based on the total diacid or diol residues, of the residues of at least one branching monomer having 3 or more functional groups;
wherein said blend in the form of film or sheet further comprises a cap-layer containing 10 to 1000 ppm of a brightness enhancing agent and wherein the polyester polymer blend has a Tg greater than 85° C., and
   wherein a section of the blend having a thickness of 10 to 50 μm has less than 200 particles per 250 mm².
      The mole percent aliphatic glycol is determined on the nature of said aliphatic glycol required to render the formed polyester miscible with polycarbonate.

In another embodiment the invention further provides a method of making a polymer/polyester blend composition comprising:
(a) blending polycarbonate and polyester with the particulate light diffusing component and brightness enhancing agent;
(b) before, during or after the blending, melting polycarbonate (I) and polyester (II) and particulate light diffusing component and brightness enhancing agent to form after the blending and melting, a melt blend; and
(c) cooling the melt blend to form a blend composition,
   wherein the polyester polymer blend has a Tg greater than 85° C., and
   wherein a section of the blend having a thickness of 10 to 50 μm has less than 200 particles per 250 mm².

In another embodiment, the invention provides a method of making a film or sheet from the polyester/polymer blend composition of the invention comprising:
(a) blending polycarbonate (I) and polyester (II) with the particulate light diffusing component and brightness enhancing agent;
(b) before, during or after the blending, melting polycarbonate (I) and polyester (II) and particulate light diffusing component and brightness enhancing agent to form after the blending and melting, a melt blend;
(c) then cooling the melt blend to form a film, sheet, or plate,
   wherein the polyester polymer blend has a Tg greater than 85° C., and
   wherein a section of the film or sheet having a thickness of 10 to 50 μm has less than 200 particles per 250 mm².

Another embodiment of the invention also covers a method of making a film or sheet further comprising a cap layer having a brightness enhancing agent wherein the film or sheet is made from the polyester/polymer blend composition of the invention comprising the steps of:
(a) blending polycarbonate and polyester with the particulate light diffusing component and optionally a brightness enhancing agent;
(b) before, during or after the blending, melting polycarbonate and polyester and particulate light diffusing component and optional brightness enhancing agent to form after the blending and melting, a melt blend; and
(c) cooling the melt blend to form a film, sheet, or plate
wherein the film, sheet, or plate is adjacent to a cap layer containing a brightness enhancing agent, wherein the cap layer is formed during or after the formation of a film, sheet, or plate from the cooled melt blend and wherein the polyester polymer blend has a Tg greater than 85° C., and
   wherein a section of the blend having a thickness of 10 to 50 μm has less than 200 particles per 250 mm².

In another aspect of the invention, a backlight display device comprises an optical source for generating light; a light guide for guiding the light there along including a surface for communicating the light out of the light guide; and the aforesaid bulk light diffuser material as a sheet material receptive of the light from the surface.

The choice of the appropriate combination of diacid and diol monomers are made such that the polyester is rendered miscible with the polycarbonate; i.e., the correct combination of diacid and diol monomers are chosen, the polyester is made and melt blended with the polycarbonate such that a single Tg is observed, and in the absence of any light scattering agents or light diffusing agents, the blend is transparent with a % haze of less than 3% or less than 2%. The compositions of this invention are also suitable for melt processing, injection molding, extrusion blow molding, injection or stretch blow molding, thermoforming, and profile extrusion.

Typically, the diacid residues comprise at least 40 mole percent, preferably at least 100 mole percent, terephthalic acid residues. The remainder of the diacid residues may be made up of one more alicyclic and/or aromatic dicarboxylic acid residues commonly present in polyesters. Examples of such dicarboxylic acids include 1,2-, 1,3- and 1,4-cyclohexanedicarboxylic, 2,6- and 2,7-naphthalenedicarboxylic, isophthalic and the like. Further examples of modifying diacids containing about 2 to about 20 carbon atoms that may be used include but are not limited to aliphatic dicarboxylic acids, alicyclic dicarboxylic acids, aromatic dicarboxylic acids, or mixtures of two or more of these acids. Specific examples of modifying dicarboxylic acids include, but are not limited to, one or more of succinic acid, glutaric acid, adipic acid, suberic acid, sebacic acid, azelaic acid, dimer acid, sulfoisophthalic acid. Additional examples of modifying diacids are fumaric, maleic, itaconic, 1,3-cyclohexanedicarboxylic, diglycolic, 2,5-norbornanedicarboxyclic, phthalic acid, diphenic, 4,4′-oxydibenzoic, and 4,4′-sulfonyidibenzoic. Other examples of modifying dicarboxylic acid residues include but are not limited to 1,4 cyclohexanedicarboxylic acid 4,4′-biphenyldicarboxylic acid, 4,4′-oxybenzoic, trans-4,4′-stilbenedicarboxylic acid. Any of the various isomers of naphthalenedicarboxylic acid or mixtures of isomers may be used, but the 1,4-, 1,5-, 2,6-, and 2,7-isomers are preferred. Cycloaliphatic dicarboxylic acids such as, for example, 1,4-cyclohexanedicarboxylic acid may be present at the pure cis or trans isomer or as a mixture of cis and trans isomers.

In certain embodiments the preferred aromatic diacids are terephthalic acid, isophthalic acid, 2,6- and 2,7-naphthalenedicarboxylic, trans-4,4′-stilbenedicarboxylic acid, 4,4′-diphenic acid and mixtures thereof. More preferred aromatic diacids are terephthalic acid and isophthalic acid, and mixtures thereof. Most preferred is terephthalic acid. In certain embodiments the preferred aliphatic diacids are 1,4-cyclohexanedicarboxylic acid, succinic acid, and carbonic acid. The most preferred aliphatic diacid is 1,4-cyclohexanedicarboxylic acid.

The mole percent aliphatic glycol is determined on the nature of said aliphatic glycol required to render the formed polyester miscible with polycarbonate. Although not limiting the scope of this invention, examples of aliphatic glycols are ethylene glycol, 1,2-propanediol, 1,3-propanediol, 1,4-butanediol, 1,5-pentanediol, diethylene glycol, 1,6-hexanediol, 1,8-octanediol, 2,2,4-trimethyl-1,3-pentanediol, 2,2,4,4-tetramethyl-1,3-cyclobutanediol, neopentyl glycol, 1,3-cyclohexanedimethanol, bisphenol A, polyalkylene glycol, triethylene glycol, polyethylene glycols, 2,4-dimethyl-2-ethylhexane-1,3-diol, 2,2-dimethyl-1,3-propanediol, 2 ethyl-2-butyl-1,3-propanediol, 2-ethyl-2-isobutyl-1,3-propanediol, 1,3-butanediol, thiodiethanol, 1,2-cyclohexanedimethanol, 2,2′-(sulfonylbis(4,1-phenyleneoxy))-bis(ethanol), isosorbide, or combinations of one or more of any of these glycols. The cycloaliphatic diols, for example, 1,3- and 1,4-cyclohexanedimethanol, may be present as their pure cis or trans isomers or as a mixture of cis and trans isomers.

Preferred aromatic diols are 2,2′-(sulfonylbis(4,1-phenyleneoxy))-bis(ethanol), p-xylylenediol, bisphenol S, bisphenol A, and mixtures thereof. Preferred aliphatic diols are 2,2,4,4-tetramethyl-1,3-cyclobutanediol, neopentyl glycol, ethylene glycol, and 1,4-cyclohexanedimethanol, 2,6-decalindimethanol, tricyclodecandedimethanol, norcamphanedimethanol and mixtures thereof. More preferred aliphatic diols are 2,2,4,4-tetramethyl-1,3-cyclobutanediol, ethylene glycol, and 1,4-cyclohexanedimethanol, and mixtures thereof. More preferred aliphatic diols are 2,2,4,4-tetramethyl-1,3-cyclobutanediol and 1,4-cyclohexanedimethanol, and mixtures thereof. In one embodiment the preferred aliphatic diols are ethylene glylcol, 1,4-cyclohexanediol and mixtures thereof.

In certain embodiments the branching monomer can be derived from tricarboxylic acids or ester forming derivatives thereof such as trimellitic (1,2,4-benzenetricarboxylic) acid and anhydride, hemimellitic (1,2,3-benzenetricarboxylic) acid and anhydride, trimesic (1,3,5-benzenetricarboxylic) acid and tricarballyic (1,2,3-propanetricarboxylic) acid. Generally, any tricarboxyl residue containing about 6 to 9 carbon atoms may be used as the branching monomer. The branching monomer also may be derived from an aliphatic triol containing about 3 to 8 carbon atoms such as glycerin, trimethylolethane and trimethylolpropane. The amount of the branching monomer residue present in the copolyester preferably is in the range of about 0.10 to 0.25 mole percent. The preferred branching monomer residues are residues of benzenetricarboxylic acids (including anhydrides), especially trimellitic acid or anhydride.

The thermoplastic resin constituting the LCD compensation or protective film of the present invention is a light transmitting miscible blend of 1 to 99% polyester with the balance primarily being a polymer miscible with said polyester, most preferably the polymer is polycarbonate. A preferred light transmitting miscible blend comprises 1 to 99% by weight polyester and 99 to 1% by weight polycarbonate. A more preferred light transmitting miscible blend comprises 25 to 90% by weight polycarbonate and 10 to 75% by weight polyester. An even more preferred light transmitting miscible blend comprises 30 to 90% by weight polycarbonate and 10 to 70% by weight polyester. A most preferred light transmitting miscible blend comprises 40 to 60% by weight polycarbonate and 60 to 40% by weight polyester. Another preferred light transmitting miscible blend comprises 40 to 60% by weight polycarbonate and 60 to 40% by weight polyester.

Table A below shows abbreviations or nomenclature used to describe some selected monomers, primarily those chosen from preferred species:

TABLE A

| Name | Diacid or Diol | Abbreviation |
|---|---|---|
| Terephthalic acid | Diacid | T |
| Isophthalic acid | Diacid | I |
| 1,4 cyclohexanedicarboxylic acid | Diacid | CHDA |
| 2,6 or 2,7-naphthalenedicarboxylic | Diacid | N |
| ethylene glycol | Diol | EG |
| 2,2,4,4-tetramethyl-1,3- | Diol | TMCB |
| cyclobutanediol | | |
| neopentyl glycol | Diol | NPG |
| 1,4-cyclohexanedimethanol | Diol | CHDM |

In Table B below, appropriate illustrative combinations of monomers are presented that yield polyesters or copolyesters that form miscible blends with polycarbonate. These are considered preferred polyesters. The information shown in Table B is by no means limiting to the scope of the invention.

TABLE B

| | | Diacid 1 | | Diacid 2 | | Diol 1 | | Diol 2 |
|---|---|---|---|---|---|---|---|---|
| Composition | Diacid 1 | (mol %) | Diacid 2 | (mol %) | Diol 1 | (mol %) | Diol 2 | (mol %) |
| 1 | T | 100 | | 0 | CHDM | 100 | | 0 |
| 2 | T | 75 | I | 25 | CHDM | 100 | | 0 |
| 3 | T | 50 | CHDA | 50 | CHDM | 100 | | 0 |
| 4 | N | 50 | T | 50 | CHDM | 90 | EG | 10 |
| 5 | T | 100 | | 0 | CHDM | 81 | EG | 19 |
| 6 | T | 100 | | 0 | CHDM | 62 | EG | 38 |
| 7 | T | 100 | | 0 | CHDM | 55 | EG | 45 |
| 8 | T | 50 | I | 50 | NPG | 55 | CHDM | 45 |
| 9 | CHDA | 100 | | 0 | CHDM | 100 | | 0 |
| 10 | CHDA | 100 | | 0 | CHDM | 50 | EG | 50 |
| 11 | T | 100 | | 0 | TMCB | 100 | | 0 |
| 12 | T | 100 | | 0 | TMCB | 70 | EG | 30 |
| 13 | T | 100 | | 0 | CHDM | 55 | TMCB | 45 |
| 14 | T | 100 | | 0 | CHDM | 80 | TMCB | 20 |
| 15 | G | 100 | | 0 | TMCB | 70 | CHDM | 30 |
| 16 | T | 100 | | 0 | CHDM | 60 | NPG | 40 |
| 17 | T | 100 | | 0 | CHDM | 83 | NPG | 17 |
| 18 | T | 100 | | 0 | TMCB | 99 | CHDM | 1 |
| 19 | T | 100 | | 0 | CHDM | 99 | TMCB | 1 |
| 20 | CHDA | 100 | | 0 | TMCB | 99 | EG | 1 |
| 21 | CHDA | 100 | | 0 | EG | 99 | TMCB | 1 |
| 22 | CHDA | 100 | | 0 | TMCB | 100 | | 0 |
| 23 | CHDA | 100 | | 0 | TMCB | 50 | CHDM | 50 |
| 24 | T | 50 | CHDA | 50 | TMCB | 60 | CHDM | 40 |
| 25 | CHDA | 75 | T | 25 | TMCB | 70 | NPG | 30 |

The copolyesters useful in the invention may be prepared using procedures well known in the art for the preparation of high molecular weight polyesters. For example, the copolyesters may be prepared by direct condensation using a dicarboxylic acid or by ester interchange using a dialkyl dicarboxylate. Thus, a dialkyl terephthalate such as dimethyl terephthalate is ester interchanged with the diols at elevated temperatures in the presence of a catalyst. Polycondensation is carried out at increasing temperatures and at reduced pressures until copolyester having the desired inherent viscosity is obtained. The inherent viscosities (I.V., dl/g) reported herein were measured at 25° C. using 0.5 g polymer per 100 mL of a solvent consisting of 60 parts by weight phenol and 40 parts by weight tetrachloroethane. The mole percentages of the diol residues of the polyesters were determined by nuclear magnetic resonance.

Examples of the catalyst materials that may be used in the synthesis of the polyesters utilized in the present invention include titanium, manganese, zinc, cobalt, antimony, gallium, lithium, calcium, silicon and germanium. Such catalyst systems are described in U.S. Pat. Nos. 3,907,754, 3,962,189,4,010,145, 4,356,299, 5,017,680, 5,668,243 and 5,681,918. Preferred catalyst metals include titanium and manganese and most preferred is titanium. The amount of catalytic metal used may range from about 5 to 100 ppm but the use of catalyst concentrations of about 5 to about 35 ppm titanium is preferred in order to provide polyesters having good color, thermal stability and electrical properties. Phosphorus compounds frequently are used in combination with the catalyst metals and any of the phosphorus compounds normally used in making polyesters may be used. Up to about 100 ppm phosphorus typically may be used.

Interactions may occur during melt blending of polyesters and polycarbonates. These interactions may result in changes in melt viscosity, crystallinity, color, and the production of gaseous by-products. In particular, a yellowish color occurs during the melt blending of a colorless polycarbonate and a colorless polyester. These unfavorable interactions are generally controlled through the use of stabilization additives, typically phosphorus based compounds. Examples of methods to prepare polyester/polycarbonate blends with reduced yellowness can be found in U.S. patent application Ser. No. 10/669,215, incorporated herein by reference.

In accordance with certain embodiments of the present invention, the polyester can comprise as a catalyst a titanium-containing compound in an amount of from about 1 to about 30 ppm, preferably from about 1 to about 20 ppm, and more preferably from about 1 to about 15 ppm elemental titanium. The titanium-containing compound is useful as an esterification and/or polycondensation catalyst.

For example, the polyester/polycarbonate blends useful in the present invention typically have reduced yellowness and improved thermal and melt stability when the polyester is produced with a reduced level of a titanium-containing catalyst in an amount of from about 1 to about 30 ppm elemental titanium, with ppm based on the total weight of the polyester. Thus, in one embodiment of the invention, the polyester comprises residues of (i) a titanium-containing catalyst compound in an amount of from about 1 to about 30 ppm elemental titanium, (ii) a pre-polycondensation phosphorus-containing compound in an amount of from about 1 to about 150 ppm elemental phosphorus and (iii) optionally, an ester exchange catalyst in an amount of from about 1 to about 150 ppm of an active element utilized when the acid component is derived from a diester of the dicarboxylic acid, with ppm based on the total weight of the polyester. For example, the polyester can be prepared in the presence of a titanium-containing catalyst compound in an amount of from about 1 to about 30 ppm elemental titanium, with ppm based on the total weight of the polyester. Optionally, an ester exchange catalyst in an amount of from about 1 to about 150 ppm of an active element can be utilized when the acid component is derived from a diester of the dicarboxylic acid.

In another example, the polyester/polycarbonate blend may comprise of about 1 to about 99 weight percent of a polyester and about 99 to about 1 weight percent of a polycarbonate in which the polyester comprises catalyst residues of (i) a titanium-containing catalyst compound in an amount of from about 1 to about 30 ppm elemental titanium, (ii) a pre-polycondensation phosphorus-containing compound in an amount of from about 1 to about 150 ppm elemental phosphorus and (iii) optionally, an ester exchange catalyst in an amount of from about 1 to about 150 ppm of an active element utilized when the acid component is derived from a diester of the dicarboxylic acid, with ppm based on the total weight of the polyester.

In another example, the polyester/polycarbonate blend may comprise a miscible blend of from about 1 to about 99 weight percent of a polyester comprising an acid component comprising repeat units from terephthalic acid, isophthalic acid, and mixtures thereof and a diol component comprising repeat units from about 50 to 100 mole percent 1,4-cyclohexanedimethanol and about 0 to about 50 mole percent ethylene glycol, based on 100 mole percent acid component and 100 mole percent diol component, and from about 99 to about 1 weight percent of a polycarbonate of 4,4-isopropylidenediphenol. The polyester component is prepared in the presence of a catalyst consisting essentially of (i) a titanium-containing catalyst compound in an amount of about 1 to about 15 ppm elemental titanium, (ii) a pre-polycondensation phosphorus-containing compound in an amount of about 45 to about 100 ppm elemental phosphorus, (iii) optionally from about 1 to about 5 ppm of at least one copolymerizable compound of a 6-arylamino-1-cyano-3H-dibenz[f,ij]isoquinoline-2,7-dione or a 1,4-bis(2,6-dialkylanilino) anthraquinone in combination with at least one bis anthraquinone or bis anthrapyridone(6-arylamino-3H-dibenz[f,ij]isoquinoline-2,7-done) compound, wherein the compounds contain at least one polyester reactive group, and (iv) optionally, an ester exchange catalyst in an amount of from about 10 to about 65 ppm of an active element utilized when the acid component is derived from a diester of the dicarboxylic acid, with ppm based on the total weight of the polyester; and the miscible blend comprises from about 0.05 to about 0.15 weight percent of a post-polycondensation phosphorus-containing compound selected from the group consisting of an aliphatic phosphite compound, aromatic phosphite compound or a mixture thereof, based on the total weight percent of the blend.

In certain embodiments, the titanium-containing compound is preferably an alkyl titanate. Exemplary compounds include: acetyl triisopropyl titanate, titanium tetraisopropoxide, titanium glycolates, titanium butoxide, hexyleneglycol titanate, tetraisooctyl titanate, titanium tetramethylate, titanium tetrabutylate, titanium tetra-isopropylate, titanium tetrapropylate, tetrabutyl titanate, and the like. A preferred alkyl titanate is acetyl triisopropyl titanate. Preferably, the residues comprise about 1 to about 20 ppm elemental titanium from tetraisopropyl titanate. Polyesters are typically produced in two steps. The first step involves direct esterification when reacting a diacid with a diol or ester exchange when reacting a dialkyl ester of a diacid with a diol. For esterification, an esterification catalyst is used. Preferably, titanium based catalyst compounds are used. When using a dialkyl ester, an ester exchange catalyst is used. Preferably, manganese or zinc based catalyst compounds are used in the ester exchange and are present from about 10 to about 65 ppm. After the first step, the desired product then undergoes polycondensation to the desired molecular weight, commonly measured as inherent viscosity (IV). During the manufacturing process of the polyester, a phosphorus-containing compound is typically added between step 1 and step 2 to control the activity of the esterification or ester exchange catalysts so that the catalysts from step 1 will not be involved during polycondensation. These phosphorus-containing compounds are referred herein as pre-polycondensation phosphorus as distinguished from post-polycondensation phosphorus discussed below.

Suitable pre-polycondensation phosphorus-containing compounds for use in preparing polyesters of the invention include, but are not limited to, phosphates, organic phosphate esters, organic phosphite esters, phosphoric acid, diphosphoric acid, polyphosphoric acid, phosphonic acid and substituted derivatives of all the above.

Special examples of phosphoric acid derivatives are the “PHM esters”, that is, mixtures of oxalkylated alkyl hydroxyalkyl phosphoric esters. Suitable phosphate esters for use as pre-polycondensation phosphorus-containing compounds in preparing the polyesters of the present invention include, but are not limited to, ethyl acid phosphate, diethyl acid phosphate, arylalkyl phosphates and trialkyl phosphates such as triethyl phosphate and tris-2-ethylhexyl phosphate. The preferred pre-polycondensation phosphorus-containing compound is a phosphate ester. While the compounded polyester/polycarbonate blends of the present invention typically have reduced yellowness over similar conventional blends, minimal yellow coloration may still be present. For applications that require a more neutral color, the yellow coloration may be further suppressed by adding a blend stabilizer, typically a phosphorus-containing compound, to the blend.

This phosphorus-containing compound, which is added after polycondensation of the polyester either in the manufacture of the polyester or in compounding the polyester/polycarbonate blend, is distinguished from the phosphorus-containing compound added during formation of the polyester. Preferably, the thermoplastic compositions of this invention contain from about 0.01 to about 0.35 weight percent, preferably from about 0.05 to about 0.15 weight percent of a post-polycondensation phosphorus-containing compound. These stabilizers may be used alone or in combination. These stabilizers may be added to the polycarbonate or polyester prior to forming a polyester/polycarbonate mixture, during the process of forming the polyester/polycarbonate mixture, or during the compounding of the polyester/polycarbonate mixture to make a polyester/polycarbonate blend. The suitability of a particular compound for use as a stabilizer and the determination of how much is to be used as a stabilizer may be readily determined by preparing a mixture of the polyester component, the polycarbonate with and without the particular compound and determining the effect on melt viscosity or color stability.

The polycarbonate portion of the present blend has a diol component containing about 90 to 100 mol percent bisphenol A residues, wherein the total mol percent of diol residues is 100 mol percent, 0 to about 10 mol percent of the residues the diol component of the polycarbonate portion can be substituted with the residues of at least one modifying aliphatic or aromatic diol, besides bisphenol A, having from 2 to 16 carbons. The polycarbonate can contain branching agents. It is preferable to have at least 95 mol percent of diol residues in the polycarbonate being bisphenol A. Suitable examples of modifying aromatic diols include the aromatic diols disclosed in U.S. Pat. Nos. 3,030,335 and 3,317,466.

In certain embodiment of the present invention the inherent viscosity of the polycarbonate portion of the blends is preferably at least about 0.3 dL/g, more preferably at least 0.5 dL/g, determined at 25° C. in 60/40 wt/wt phenol/tetrachloroethane.

The polycarbonate portion of the present blend can be prepared in the melt, in solution, or by interfacial polymerization techniques well known in the art. Suitable methods include the steps of reacting a carbonate source with a diol at a temperature of about 0° C. to 315° C. at a pressure of about 0.1 to 760 mm Hg for a time sufficient to form a polycarbonate. Commercially available polycarbonates that are typically used in the present invention, are normally made by reacting an aromatic diol with a carbonate source such as phosgene, dibutyl carbonate or diphenyl carbonate, to incorporate 100 mol percent of carbonate residues, along with 100 mol percent diol residues into the polycarbonate. Examples of methods of producing polycarbonates are disclosed in U.S. Pat. Nos. 5,498,688, 5,494,992, and 5,489,665.

Processes for preparing polycarbonates are known in the art. The linear or branched polycarbonate useful in the LCD film or sheet of the present invention disclosed herein is not limited to or bound by the polycarbonate type used or its production method. Generally a dihydric phenol, such as bisphenol A is reacted with phosgene with the use of optional mono-functional compounds as chain terminators and tri-functional or higher functional compounds as branching or crosslinking agents. Reactive acyl halides are also condensation polymerizable and have been used in polycarbonates as terminating compounds (mono-functional), comonomers (di-functional) or branching agents (tri-functional or higher).

For example, one method of forming branched polycarbonates disclosed, for example, in U.S. Pat. No. 4,001,884, involves the incorporation of an aromatic polycarboxylic acid or functional derivative thereof in a conventional polycarbonate-forming reaction mixture. In this method, phosgene undergoes reaction with a bisphenol, under alkaline conditions typically involving a pH above 10. Experience has shown that a preferred aromatic polycarboxylic acid derivative is trimellitic acid trichloride. A monohydric phenol may be employed as a molecular weight regulator; it functions as a chain termination agent by reacting with chloroformate groups on the forming polycarbonate chain. Cross-linked polycarbonates also may be prepared wherein a cross-linkable polycarbonate contains methacrylic acid chloride as a chain terminator. In this latter process, typically a mixture of bisphenol A, aqueous sodium hydroxide and methylene chloride is prepared and a solution of methacrylic acid chloride in methylene chloride is added. Phosgene is then added and additional amounts of aqueous sodium hydroxide are added to keep the pH between 13 and 14. Finally, a triethylamine coupling catalyst is added. Branched poly(ester)carbonates include those which are end capped with a reactive structure of the formula —C(O)—CH═CH—R, wherein R is hydrogen or an alkyl group containing 1 to 3 carbons. This polycarbonate can be prepared in a conventional manner using a branching agent, such as trimellityl trichloride and an acryloyl chloride to provide the reactive end groups. The process can be carried out by mixing water, methylene chloride, triethylamine, bisphenol A and optionally para-t-butyl phenol as a chain terminating agent. The pH is maintained at 9 to 10 by addition of aqueous sodium hydroxide. A mixture of terephthaloyl dichloride, isophthaloyl dichloride, methylene chloride, and optionally acryloyl chloride and trimellityl trichloride is added dropwise. Phosgene is then introduced slowly into the reaction mixture. Randomly branched polycarbonates and methods of preparing them are also known. At least 20 weight percent of a stoichiometric quantity of a carbonate precursor, such as an acyl halide or a haloformate, can be reacted with a mixture of a dihydric phenol and at least 0.05 mole percent of a polyfunctional aromatic compound in a medium of water and a solvent for the polycarbonate. The medium contains at least 1.2 mole percent of a polymerization catalyst. Sufficient alkali metal hydroxide is added to the reaction medium to maintain a pH range of 3 to 6 and then sufficient alkali metal hydroxide is added to raise the pH to at least 9 but less than 12 while reacting the remaining carbonate precursor. Also known is a process for preparing polycarbonates which allows the condensation reaction incorporation of an acyl halide compound into the polycarbonate in a manner which is suitable in batch processes and in continuous processes. Such acyl halide compounds can be mono-, di-, tri- or higher-functional and are preferably for branching or terminating the polymer molecules or providing other functional moieties at terminal or pendant locations in the polymer molecule. One method for making branched polycarbonates with high melt strengths is a variation of the melt-polycondensation process where the diphenyl carbonate and Bisphenol A are polymerized together with polyfunctional alcohols or phenols as branching agents. Branched polycarbonates may be prepared through a melt-polymerization process using aliphatic alcohols. For example, alkali metal compounds and alkaline earth compounds, when used as catalysts added to the monomer stage of the melt process, will not only generate the desired polycarbonate compound, but also other products after a rearrangement reaction known as the “Fries” rearrangement. The presence of the Fries rearrangement products in a certain range can increase the melt strength of the polycarbonate resin to make it suitable for bottle and sheet applications. This method of making a polycarbonate resin with high melt strength has the advantage of having lower raw material costs compared with the method of making a branched polycarbonate by adding “branching agents.” In general, these catalysts are less expensive and much lower amounts are required compared to the branching agents. Aromatic polycarbonates can be prepared in the presence of a polycondensation catalyst, without the use of a branching agent, which results in a polycarbonate possessing a branched structure in a specific proportion. This may be accomplished through a fusion polycondensation reaction of a specific type of aromatic dihydroxy compound and diester carbonate in the presence of an alkali metal compound and/or alkaline earth metal compound and/or a nitrogen-containing basic compound to produce a polycarbonate having an intrinsic viscosity of at least 0.2. The polycarbonate can then be subjected to further reaction in a special self-cleaning style horizontal-type biaxial reactor having a specified range of the ratio L/D of 2 to 30 (where L is the length of the horizontal rotating axle and D is the rotational diameter of the stirring fan unit). The production of a branched polycarbonate composition, having increased melt strength, also can be carried out by late addition of branch-inducing catalysts to the polycarbonate oligomer in a melt polycondensation process, the resulting branched polycarbonate composition, and various applications of the branched polycarbonate composition. The use of polyhydric phenols having three or more hydroxy groups per molecule, for example, 1,1,1-tris-(4-hydroxyphenyl)ethane (THPE), 1,3,5-tris-(4-hydroxyphenyl)benzene, 1,4-bis-[di-(4-hydroxyphenyl)phenylmethyl]benzene and the like, as branching agents for high melt strength blow-moldable polycarbonate 30 resins prepared interfacially has been described in U.S. Pat. Nos. Re. 27,682 and 3,799,953.

Other methods known to prepare branched polycarbonates through heterogeneous interfacial polymerization methods include the use of cyanuric chloride as a branching agent; branched dihydric phenols as branching agents and 3,3-bis-(4-hydroxyaryl)-oxindoles as branching agents. Additionally, aromatic polycarbonates end-capped with branched alkyl acyl halides and/or acids also may be prepared. Trimellitic triacid chloride has also been used as a branching agent in the interfacial preparation of branched polycarbonate. For example, branched polycarbonate compositions having improved melt strength may be prepared from aromatic cyclic polycarbonate oligomers in a melt equilibration process. Another suitable material for the non-polyester portion of the thermoplastic resin is copolycarbonates such as polyestercarbonates. Still suitable is reduced carbonate in the polyestercarbonate to ultimately reach a polyarylate composition and is considered among the set defined as polycarbonate herein.

In certain embodiments according to the present invention, the high Tg miscible polyester polymer blends and LCD films made therefrom preferably contain a phosphorus catalyst quencher component, typically one or more phosphorus compounds such as a phosphorus acid, e.g., phosphoric and/or phosphorous acids, phosphorous salts, or an ester of a phosphorus acid such as a phosphate or phosphite ester. Further examples of phosphorus catalyst quenchers are described in U.S. Pat. Nos. 5,907,026 and 6,448,334. The amount of phosphorus catalyst quencher present typically provides an elemental phosphorus content of about 0 to 0.5 weight percent, preferably 0.1 to 0.25 weight percent, based on the total weight of the blend.

The miscible high Tg polyester/polymer blends may be prepared using procedures well known in the art including, but not restricted to, compounding in a single screw extruder, compounding in a twin screw extruder, or simply pellet blending the components together prior to processing into film, sheet, or other articles. The various components of the polyester/polymer blends may be blended in batch, semicontinuous, or continuous processes. Small scale batches may be readily prepared in any high-intensity mixing devices well-known to those skilled in the art, such as Banbury mixers, batch mixers, continuous mixers, Cokneader, ribbon blenders, static mixers, roll mill, torque rheometer, a single screw extruder, or a twin screw extruder. The components also may be blended in solution in an appropriate solvent. The melt blending method includes blending the polyester, polycarbonate, plasticizer, flame retardant, additive, and any additional non-polymerized components at a temperature sufficient to melt the polyester/polymer blend components. The blend may be cooled and pelletized for further use or the melt blend can be processed directly from this molten blend into film or sheet. In the process of preparing the miscible high Tg polyester/polymer blend compositions, for example, the polyester and polymer pellets or flake, are mixed together in a tumbler with other additives and then placed in a hopper of an extruder or other melt mixing apparatus for melt compounding. Alternatively, the pellets, flake, plasticizer, additive, etc. may be added to the hopper of an extruder or other melt mixing apparatus by various feeders, which meter the components in their desired weight ratios. The term “melt” as used herein includes, but is not limited to, merely softening the polyester. For melt mixing methods generally known in the polymer art, see “Mixing and Compounding of Polymers” (I. Manas-Zloczower & Z. Tadmor editors, Carl Hanser Verlag Publisher, 1994, New York, N.Y.). For more melt mixing methods generally known in the polymer art, see Chapter 4—Processing of Plastics in “Plastics Engineering, 3^{rd} ed”, R. J. Crawford, Butterworth-Heinemann Publisher, 1998, Oxford, England. And even for more melt mixing methods generally known in the polymer art, see “Engineering Principles of Plasticating Extrusion” Z. Tadmor & I. Klein, Van Nostrand Reinhold Co. Publisher, 1970, New York, N.Y.

When colored sheet or film is desired, pigments or colorants may be included in the polyester mixture during the reaction of the diol and the dicarboxylic acid or they may be melt blended with the preformed polyester. A preferred method of including colorants is to use a colorant having thermally stable organic colored compounds having reactive groups such that the colorant is copolymerized and incorporated into the polyester to improve its hue. For example, colorants such as dyes possessing reactive hydroxyl and/or carboxyl groups, including, but not limited to, blue and red substituted anthraquinones, may be copolymerized into the polymer chain. When dyes are employed as colorants, they may be added to the polyester reaction process after an ester interchange or direct esterification reaction.

The polyester/polymer blend compositions useful in the films and sheets of the present invention may also include other additives, such as heat stabilizers, anti-static agents, UV stabilizers, antioxidants, lubricants, UV absorbers/stabilizers, slip agents, mold releases, biocides, plasticizers, toners, flame retardant, or fillers such as clay, mica, talc, ceramic spheres, glass spheres, glass flakes, other compatible plastics, and the like. Additives such as these are typically used in relatively small quantities. These additives may be incorporated into the blends of the invention by way of concentrates. These concentrates may use polyesters that are not of the composition described above. If so, these other polyesters are not added in quantities exceeding 5 percent. The additives may be used in conventional effective amounts. In one embodiment, they are present in an amount from 0.1 to a total of about 50% relative to the total weight of the composition. The use of such additives may be desirable in enhancing the processing of the composition as well as improving the products or articles formed therefrom. Examples of such include: oxidative and thermal stabilizers, lubricants, mold release agents, flame-retarding agents, oxidation inhibitors, dyes, pigments and other coloring agents, ultraviolet light stabilizers, nucleators, plasticizers, as well as other conventional additives known to the art. These conventional additives may be incorporated into compositions at any suitable stage of the production process, and typically are introduced in the mixing step and included in an extrudate. These additives may be incorporated into the blends of the invention by way of concentrates. These concentrates may use polyesters that are not of the composition described above. If so, these other polyesters are not added in quantities exceeding 5 percent.

The miscible high Tg polyester/polymer blend compositions may also comprise one or more plasticizers to increase the flexibility and softness of the produced film, improve the processing of the material, and aid in the precise control of the finished film birefringence and/or optical properties. For many purposes, it may be desirable to incorporate other conventional additives with the miscible high Tg polyester/polymer blend compositions of the present invention. For example, there may be added antioxidants, ultraviolet absorbent, heat and light stabilizers, dyes, antistatic agents, lubricants, preservatives, processing aids, slip agents, antiblocking agents, pigments, flame retardants, blowing agents, and the like. More than one additive may be used. The additive may be present in any desired amount. Accordingly, the amount of additive utilized will depend upon the particular miscible high Tg polyester/polymer blend composition used and the application or usage intended for the blend composition and film. Miscible high Tg polyester/polymer blend compositions containing such other additives are within the scope of this invention. It is within the skill of the ordinary artisan in possession of the present disclosure to select the appropriate additive(s) and amount thereof depending on the processing conditions and end use of the blend compositions. The various components of the miscible high Tg polyester/polymer blend compositions such as, for example, the plasticizer(s), flame retardant, release additive, other processing aids, and toners, may be blended in batch, semicontinuous, or continuous processes.

The miscible high Tg polyester/polymer blend composition of the present invention may include any various additives conventional in the art. For example, the composition can include from about 0.01 to about 50 weight percent, based on the total weight of the composition, of at least one additional additive selected from a lubricant, a non-polymeric plasticizer, a polymeric plasticizer, a thermal stabilizer, an antioxidant, a pro-oxidant, an acid scavenger, an ultraviolet light stabilizer, a promoter of photodegradation, an antistatic agent, a pigment, a dye, or a colorant. Typical non-polymeric plasticizers include dioctyl adipate, phosphates, and diethyl phthalate. Representative inorganics include, talc, TiO2, CaCO3, NH4CL, and silica. Colorants can be monomeric, oligomeric, and polymeric. Examples of polymeric colorants are described by Weaver et al. in U.S. Pat. Nos. 4,892,922, 4,892,923, 4,882,412, 4,845,188, 4,826,903 and 4,749,773.

The miscible high Tg polyester/polymer blend of the invention to be utilized as compensation films may contain retardation-increasing agents comprised of an aromatic compound having at least two aromatic rings. The aromatic compound is added in an amount of 0.01 to 20 weight parts, preferably in an amount of 0.05 to 15 weight parts, more preferably in an amount of 0.1 to 10 weight parts, based on 100 weight parts of blend. Two or more aromatic compounds may be used in combination. Additional detail regarding the structure of retardation-increasing agents is outlined in U.S. Patent Application Publication 2003/0218709.

The miscible high Tg polyester/polymer blend compositions described above may comprise an additive that is effective to prevent sticking of the compositions to the calendaring rolls, melt-process rolls, cooling rolls, or other casting surfaces such as the belts of a double belt press or rotating continuous belt when the miscible high Tg polyester/polymer blend compositions is used to make film. As used herein, the term “effective” means that the miscible high Tg polyester/polymer blend compositions passes freely between the rolls without wrapping itself around the rolls or producing an excessive layer of miscible high Tg polyester/polymer blend composition on the surface of the rolls. Also used herein, the term “effective” means that the miscible high Tg polyester/polymer blend compositions do not significantly stick to a roll or belt such as to hinder removal of the film during the take-up and winding process. The amount of additive used in the miscible high Tg polyester/polymer blend composition is typically about 0.1 to about 10 weight percent, based on the total weight percent of the miscible high Tg polyester/polymer blend composition. The optimum amount of additive used is determined by factors well known in the art and is dependent upon variations in equipment, material, process conditions, and film thickness. Additional examples of additive levels are about 0.1 to about 5 weight percent and about 0.1 to about 2 weight percent. Examples of additives of the present invention include fatty acid amides such as erucylamide and stearamide; metal salts of organic acids such as calcium stearate and zinc stearate; fatty acids such as stearic acid, oleic acid, and palmitic acid; fatty acid salts; fatty acid esters; hydrocarbon waxes such as paraffin wax, phosphoric acid esters, polyethylene waxes, and polypropylene waxes; chemically modified polyolefin waxes; ester waxes such as carnauba wax; glycerin esters such as glycerol mono- and di-stearates; talc; microcrystalline silica; and acrylic copolymers (for example, PARALOID® K175 available from Rohm & Haas). Typically, the additive comprises one or more of: erucylamide, stearamide, calcium stearate, zinc stearate, stearic acid, montanic acid, montanic acid esters, montanic acid salts, oleic acid, palmitic acid, paraffin wax, polyethylene waxes, polypropylene waxes, carnauba wax, glycerol monostearate, or glycerol distearate.

Another additive which may be used comprises a fatty acid or a salt of a fatty acid containing more than 18 carbon atoms and (ii) an ester wax comprising a fatty acid residue containing more than 18 carbon atoms and an alcohol residue containing from 2 to about 28 carbon atoms. The ratio of the fatty acid or salt of a fatty acid to the ester wax may be 1:1 or greater. In this embodiment, the combination of the fatty acid or fatty acid salt and an ester wax at the above ratio gives the additional benefit of providing a film or sheet with a haze value of less than 5%. The additives with fatty acid components containing 18 or less carbon atoms.

In the melt process, if a plasticizer is used, higher molecular weight plasticizers are preferred to prevent smoking and loss of plasticizer during the high-heat process. The preferred range of plasticizer content will depend on the properties of the base miscible high Tg polyester/polymer blend and the plasticizer. In particular, as the Tg of the miscible high Tg polyester/polymer blend as predicted by the well-known Fox equation (T. G. Fox, Bull. Am. Phys. Soc., 1, 123 (1956)) decreases, the amount of plasticizer needed to obtain a miscible high Tg polyester/polymer blend that may be melt-processed satisfactorily also decreases. Typically, the plasticizer comprises from about 1 to about 50 weight percent (weight percent) of the composition based on the total weight of the blend composition. Other examples of plasticizer levels are about 2 to about 40 weight percent, about 4 to about 40 weight percent, and about 5 to about 30 weight percent of the blend composition.

Plasticizers

The miscible high Tg polyester/polymer blend compositions of the invention may comprise a plasticizer. The presence of the plasticizer is useful to enhance flexibility and the good mechanical properties of the melt formed film or sheet. The plasticizer also helps to lower the processing temperature of the blend. The plasticizers typically comprise one or more aromatic rings. The preferred plasticizers are soluble in the miscible high Tg polyester/polymer blend as indicated by dissolving a 5-mil (0.127 mm) thick film of the miscible high Tg polyester/polymer blend to produce a clear solution at a temperature of 160° C. or less. More preferably, the plasticizers are soluble in the miscible high Tg polyester/polymer blend as indicated by dissolving a 5-mil (0.127 mm) thick film of the blend to produce a clear solution at a temperature of 150° C. or less. The solubility of the plasticizer in the miscible high Tg polyester/polymer blend may be determined as follows:
1. Placing into a small vial a ½ inch section of a standard reference film, 5 mils (0.127 mm) in thickness and about equal to the width of the vial.
2. Adding the plasticizer to the vial until the film is covered completely.
3. Placing the vial with the film and plasticizer on a shelf to observe after one hour and again at 4 hours. Note the appearance of the film and liquid.
4. After the ambient observation, placing the vial in a heating block and allow the temperature to remain constant at 75° C. for one hour and observe the appearance of the film and liquid.
5. Repeating step 4 for each of the following temperatures (° C.): 100, 140, 150, and 160.

The plasticizers used in the invention include at least one phosphate plasticizer, phthalate plasticizer, glycolic acid ester, citric acid ester plasticizer or hydroxyl-functional plasticizer, but the invention is not limited thereto. Examples of plasticizers include a phosphate plasticizer such as triphenyl phosphate, tricresyl phosphate, cresyldiphenyl phosphate, octyidiphenyl phosphate, diphenylbiphenyl phosphate, trioctyl phosphate, or tributyl phosphate; a phthalate plasticizer such as diethyl phthalate, dimethoxyethyl phthalate, dimethyl phthalate, dioctyl phthalate, dibutyl phthalate, di-2-ethylhexyl phthalate, butylbenzyl phthalate or dibenzyl phthalate; a glycolic acid ester such as butyl phthalyl butyl glycolate, ethyl phthalyl ethyl glycolate or methyl phthalyl ethyl glycolate; and a citric acid ester plasticizer such as triethyl citrate, tri-n-butyl citrate, acetyltriethyl citrate, acetyl-tri-n-butyl citrate, or acetyl-tri-n-(2-ethylhexyl)citrate. Further examples of plasticizers which may be used according to the invention are esters comprising: (i) acid residues comprising one or more residues of: phthalic acid, adipic acid, trimellitic acid, benzoic acid, azelaic acid, terephthalic acid, isophthalic acid, butyric acid, glutaric acid, citric acid or phosphoric acid; and (ii) alcohol residues comprising one or more residues of an aliphatic, cycloaliphatic, or aromatic alcohol containing up to about 20 carbon atoms. Further, non-limiting examples of alcohol residues of the plasticizer include methanol, ethanol, propanol, isopropanol, butanol, isobutanol, stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol. The plasticizer also may comprise one or more benzoates, phthalates, phosphates, arylene-bis(diaryl phosphate), or isophthalates. In another example, the plasticizer comprises diethylene glycol dibenzoate, abbreviated herein as “DEGDB”.

TABLE 3
Plasticizers

Adipic Acid Derivatives
Dicapryl adipate
Di-(2-ethylhexyl adipate)
Di(n-heptyl, n-nonyl) adipate
Diisobutyl adipate
Diisodecyl adipate
Dinonyl adipate
Di-(tridecyl) adipate
Azelaic Acid Derivatives
Di-(2-ethylhexyl azelate)
Diisodecyl azelate
Diisoctyl azealate
Dimethyl azelate
Di-n-hexyl azelate
Benzoic Acid Derivatives
Diethylene glycol dibenzoate (DEGDB)
Dipropylene glycol dibenzoate
Propylene glycol dibenzoate
Polyethylene glycol 200 dibenzoate
Neopentyl glycol dibenzoate
Citric Acid Derivatives
Acetyl tri-n-butyl citrate
Acetyl triethyl citrate
Tri-n-Butyl citrate
Triethyl citrate
Dimer Acid Derivatives
Bis-(2-hydroxyethyl dimerate)
Epoxy Derivatives
Epoxidized linseed oil
Epoxidized soy bean oil
2-Ethylhexyl epoxytallate
Fumaric Acid Derivatives
Dibutyl fumarate
Glycerol Derivatives
Glycerol Tribenzoate
Glycerol triacetate
Glycerol diacetate monolaurate
Isobutyrate Derivative
2,2,4-Trimethyl-1,3-pentanediol,
Diisobutyrate
Texanol diisobutyrate
Isophthalic Acid Derivatives
Dimethyl isophthalate
Diphenyl isophthalate
Di-n-butylphthalate
Lauric Acid Derivatives
Methyl laurate
Linoleic Acid Derivative
Methyl linoleate, 75%
Maleic Acid Derivatives
Di-(2-ethylhexyl) maleate
Di-n-butyl maleate
Mellitates
Tricapryl trimellitate
Triisodecyl trimellitate
Tri-(n-octyl,n-decyl) trimellitate
Triisonyl trimellitate
Myristic Acid Derivatives
Isopropyl myristate
Oleic Acid Derivatives
Butyl oleate
Glycerol monooleate
Glycerol trioleate
Methyl oleate
n-Propyl oleate
Tetrahydrofurfuryl oleate
Palmitic Acid Derivatives
Isopropyl palmitate
Methyl palmitate
Paraffin Derivatives
Chloroparaffin, 41% C1
Chloroparaffin, 50% C1
Chloroparaffin, 60% C1
Chloroparaffin, 70% C1
Phosphoric Acid Derivatives
2-Ethylhexyl diphenyl phosphate
Isodecyl diphenyl phosphate
t-Butylphenyl diphenyl phosphate
Resorcinol bis(diphenyl phosphate) (RDP)
100% RDP
Blend of 75% RDP, 25% DEGDB (by wt)
Blend of 50% RDP, 50% DEGDB (by wt)
Blend of 25% RDP, 75% DEGDB (by wt)
Tri-butoxyethyl phosphate
Tributyl phosphate
Tricresyl phosphate
Triphenyl phosphate
Phthalic Acid Derivatives
Butyl benzyl phthalate
Texanol benzyl phthalate
Butyl octyl phthalate
Dicapryl phthalate
Dicyclohexyl phthalate
Di-(2-ethylhexyl) phthalate
Diethyl phthalate
Dihexyl phthalate
Diisobutyl phthalate
Diisodecyl phthalate
Diisoheptyl phthalate
Diisononyl phthalate
Diisooctyl phthalate
Dimethyl phthalate
Ditridecyl phthalate
Diundecyl phthalate
Ricinoleic Acid Derivatives
Butyl ricinoleate
Glycerol tri(acetyl) ricinoleate
Methyl acetyl ricinoleate
Methyl ricinoleate
n-Butyl acetyl ricinoleate
Propylene glycol ricinoleate
Sebacic Acid Derivatives
Dibutyl sebacate
Di-(2-ethylhexyl) sebacate
Dimethyl sebacate
Stearic Acid Derivatives
Ethylene glycol monostearate
Glycerol monostearate
Isopropyl isostearate
Methyl stearate
n-Butyl stearate
Propylene glycol monostearate
Succinic Acid Derivatives
Diethyl succinate
Sulfonic Acid Derivatives
N-Ethyl o,p-toluenesulfonamide
o,p-toluenesulfonamide

A similar test to that above is described in The Technology of Plasticizers, by J. Kern Sears and Joseph R. Darby, published by Society of Plastic Engineers/Wiley and Sons, New York, 1982, pp 136-137. In this test, a grain of the polymer is placed in a drop of plasticizer on a heated microscope stage. If the polymer disappears, then it is solubilized. The plasticizers that are most effective at solubilizing the blend of the instant invention have a solubility of greater than 4 according to Table 3 and can also be classified according to their solubility parameter. The solubility parameter, or square root of the cohesive energy density, of a plasticizer can be calculated by the method described by Coleman et al., Polymer 31, 1187 (1990). The most preferred plasticizers will have a solubility parameter (δ) in the range of about 9.5 to about 13.0 cal^{0.5} cm^{-1.5}. It is generally understood that the solubility parameter of the plasticizer should be within 1.5 units of the solubility parameter of blend. The plasticizers in Table 4 that are preferred in the context of this invention are as follows:

TABLE 4
Preferred Plasticizers

Glycerol diacetate
monolaurate
Texanol diisobutyrate
Di-2-ethylhexyladipate
Trioctyltrimellitate
Di-2-ethylhexylphthalate
Texanol benzyl phthalate
Neopentyl glycol dibenzoate
Dipropylene glycol
dibenzoate
Butyl benzyl phthalate
Propylene glycol dibenzoate
Diethylene glycol dibenzoate
Glycerol tribenzoate

Examples of preferred plasticizers which may be used according to the invention are esters comprising: (i) acid residues comprising one or more residues of: phthalic acid, adipic acid, trimellitic acid, benzoic acid, azelaic acid, terephthalic acid, isophthalic acid, butyric acid, glutaric acid, citric acid or phosphoric acid; and (ii) alcohol residues comprising one or more residues of an aliphatic, cycloaliphatic, or aromatic alcohol containing up to about 20 carbon atoms. Further, non-limiting examples of alcohol residues of the plasticizer include methanol, ethanol, propanol, isopropanol, butanol, isobutanol, stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol. The plasticizer also may comprise one or more benzoates, phthalates, phosphates, arylene-bis(diaryl phosphate), or isophthalates. In another example, the plasticizer comprises diethylene glycol dibenzoate, abbreviated herein as “DEGDB”.

Plasticizers or softeners may include esters of dicarboxylic acids (including, but not limited to, adipic acid, azelaic acid, sebacic acid), esters of aromatic acids, (including, but not limited to, esters of phthalic acid, terephthalic acid, and trimellitic acid), derivatives of citric acid (including, but not limited to, those available from Morflex, Inc.), derivatives of phosphoric acid (including, but not limited to, triphenyl phosphate, tricresyl phosphate, tri(biphenyl)phosphate, and di-triphenyl phosphate).

A transient plasticizer may be used to aid in the melt processing of the miscible high Tg polyester/polymer blend compositions. A transient plasticizer, i.e., one or more solvents, is fed at an appropriate point during the compounding or melt-casting step and stripped, suctioned off or evaporated off at a later point. The advantage of using a transient plasticizer is that it serves as a type of replacement for the conventional plasticizers used for miscible high Tg polyester/polymer blend melt processing because its presence enables a reduction in the content required of the conventional plasticizer, thereby yielding a final film product with higher thermal resistance and stiffness. The transient plasticizer, also known as the solvent, used during melt processing the blend composition may be any solvent as long as it can dissolve the blend. Even a solvent, which does not dissolve blend, can be used if its mixture with another solvent dissolves the blend.

The solvent used ultimately depends upon the miscible high Tg polyester/polymer blend composition; i.e., its relative contents and types of diols and diacids of the polyester as well as the polycarbonate or other polymer type. To estimate the correct good solvent, solubility parameter methods may be utilized. Note that temperature affects are not accounted for in this method, and higher temperatures will only serve to broaden the window of potential solvents. The solubility parameter, or square root of the cohesive energy density, of a polymer or solvent can be calculated by the method described by Coleman et al., Polymer 31, 1187 (1990). When using the method described by Coleman et al., the most preferred solvents will have a solubility parameter (6) in the range of about 9 to about 15 cal0.5 cm−1.5. It is generally understood that when using this method the solubility parameter of the solvent should be within 5 units of the solubility parameter of miscible high Tg polyester/polymer blend, preferably within 2 units of the solubility parameter of the miscible high Tg polyester/polymer blend.

Alternatively, solubility parameters can be calculated by the Hansen method as disclosed in Chapter 1 of “Hansen Solubility Parameters, a users handbook”, by Charles M. Hansen, CRC Press, 2000. When employing this method, the following relationship is used to determine the difference between the solubility parameters of the solvent and the blend, where it is generally understood that good solubility only occurs with Δδ of ≦5, again, this method does not take into account temperature affects, which only serve to aid in broadening the choice of potential solvents:
Δδ=(δd,P−δd,S)2+(δp,P−δp,S)2+(δh,P−δh,S)2
Where:
Δδ=the difference in blend and solvent solubility parameters
A subscript of P with δ refers to the blend
A subscript of S with δ refers to the solvent
A subscript of d refers to dispersion force contribution to δ
A subscript of p refers to polar force contribution to δ
A subscript of h refers to hydrogen-bonding force contribution to δ

For example δd,P refers to the solubility parameter of the blend determined from dispersion forces. Another example, δh,S refers to the solubility parameter of the solvent determined from hydrogen bonding forces.

A flame retardant may be added to the miscible high Tg polyester/polymer blend composition at a concentration of about 5 weight percent to about 40 weight percent based on the total weight of the composition. Other examples of flame retardant levels are about 7 weight percent to about 35 weight percent, about 10 weight percent to about 30 weight percent, and about 10 weight percent to about 25 weight percent. Preferably, the flame retardant comprises one or more monoesters, diesters, or triesters of phosphoric acid. The phosphorus-containing flame retardant may also function as a plasticizer for the blend. In another example, the plasticizer comprises diethylene glycol dibenzoate and the flame retardant comprises resorcinol bis(diphenyl phosphate). The flame retardant film or sheet will typically give a V2 or greater rating in a UL94 burn test. In addition, our flame retardant film or sheet typically gives a burn rate of 0 in the Federal Motor Vehicle Safety Standard 302 (typically referred to as FMVSS 302).

The phosphorus-containing flame retardant is preferably miscible with the miscible high Tg polyester/polymer blend. The term “miscible”, as used herein, is understood to mean that the flame retardant and the miscible high Tg polyester/polymer blend composition will mix together to form a stable mixture which will not separate into multiple phases under processing conditions or conditions of use. Thus, the term “miscible” is intended include both “soluble” mixtures, in which flame retardant and blend composition form a true solution, and “compatible” mixtures, meaning that the mixture of flame retardant and blend composition do not necessarily form a true solution but only a stable blend. Preferably, the phosphorus-containing compound is a non-halogenated, organic compound such as, for example, a phosphorus acid ester containing organic substituents. The flame retardant may comprise a wide range of phosphorus compounds well-known in the art such as, for example, phosphines, phosphites, phosphinites, phosphonites, phosphinates, phosphonates, phosphine oxides, and phosphates. Examples of phosphorus-containing flame retardants include tributyl phosphate, triethyl phosphate, tri-butoxyethyl phosphate, t-Butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine.

The term “phosphorus acid” as used in describing the phosphorus-containing flame retardants of the invention include the mineral acids such as phosphoric acid, acids having direct carbon-to-phosphorus bonds such as the phosphonic and phosphinic acids, and partially esterifies phosphorus acids which contain at least one remaining unesterified acid group such as the first and second degree esters of phosphoric acid and the like. Typical phosphorus acids that can be employed in the present invention include, but are not limited to: dibenzyl phosphoric acid, dibutyl phosphoric acid, di(2-ethylhexyl)phosphoric acid, diphenyl phosphoric acid, methyl phenyl phosphoric acid, phenyl benzyl phosphoric acid, hexylphosphonic acid, phenylphosphonic acid tolylphosphonic acid, benzy1phosphonic acid, 2-phenylethylphosphonic acid, methylhexylphosphinic acid, diphenylphosphinic acid, phenylnaphthylphosphinic acid, dibenzylphosphinic acid, methylphenylphosphinic acid, phenylphosphonous acid, tolylphosphonous acid, benzylphosphonous acid, butyl phosphoric acid, 2-ethyl hexyl phosphoric acid, phenyl phosphoric acid, cresyl phosphoric acid, benzyl phosphoric acid, phenyl phosphorous acid, cresyl phosphorous acid, benzyl phosphorous acid, diphenyl phosphorous acid, phenyl benzyl phosphorous acid, dibenzyl phosphorous acid, methyl phenyl phosphorous acid, phenyl phenylphosphonic acid, tolyl methylphosphonic acid, ethyl benzylphosphonic acid, methyl ethylphosphonous acid, methyl phenylphosphonous acid, and phenyl phenylphosphonous acid. The flame retardant typically comprises one or more monoesters, diesters, or triesters of phosphoric acid. In another example, the flame retardant comprises resorcinol bis(diphenyl phosphate), abbreviated herein as “RDP”.

Oxidative stabilizers also may be used as a component in the miscible high Tg polyester/polymer blend composition of the present invention to prevent oxidative degradation during processing of the molten or semi-molten material during extrusion or other melt-process unit operation. Such stabilizers include esters such as distearyl thiodipropionate or dilauryl thiodipropionate; phenolic stabilizers such as IRGANOX® 1010 available from Ciba-Geigy AG, ETHANOX® 330 available from Ethyl Corporation, and butylated hydroxytoluene; and phosphorus containing stabilizers such as Irgafos® available from Ciba-Geigy AG and WESTON® stabilizers available from GE Specialty Chemicals. These stabilizers may be used alone or in combinations. Also, the compositions may contain dyes, pigments, fillers, matting agents, antiblocking agents, antistatic agents, blowing agents, chopped fibers, glass, impact modifiers, carbon black, talc, TiO2 and the like as desired. Colorants are sometimes added to impart a desired neutral hue and/or brightness to the blend composition and the film product.

In one embodiment of the invention wherein the miscible high Tg polyester/polymer blend composition in film form (substrate), the substrate is further coated with a protection layer such as UV coating or infrared light reflecting coating. In one embodiment of the invention with the plastic forming the transparent plastic substrate being a polyester or blended resin, the ultraviolet absorbent is selected from 2-(3′-t-butyl-5′-methyl-2′-hydroxyphenyl)-5-chlorobenzotriazole, 2-(3′,5′-di-t-butyl-2′-hydroxyphenyl)-5-chlorobenzotriazole, 2-(2′-hydroxy-5′-t-octylphenyl)benzotriazole or 2-(4,6-diphenyl-1,3,5-triazin-2-yl)-5-hexyloxyphenol. In one embodiment, the coating comprises IR reflecting particles which comprise a titanium dioxide layer applied on a flake like carrier.

When a film is melt extruded from miscible high Tg polyester/polymer blend compositions, gels or unmelts which comprise insoluble foreign matter particles are undesirable, they cause diffused reflection or glitter points. Thus when such film is employed in a liquid crystal display, light from the crystal cell is scattered to cause degraded visibility of the display. It is difficult to detect insoluble foreign matter particles, or gels/unmelts, under ordinary light. However, when observation is made in such a manner that two polarizing plates are arranged in the right angle (cross Nicole) state and a film prepared from the miscible high Tg polyester/polymer blend is placed between them then it is illuminated from one side, it is possible to detect gleaming foreign matter particles in a dark visual field. Thus it is possible to readily determine the sizes as well as the numbers of foreign matter particles. The number of foreign matter particles having a size of 10 to 50 μm (0.01 to 0.05 mm) is preferably no more than 200 per 250 mm² (0.8 particles/mm²) and the number of foreign matter particles having a size of at least 50 μm is preferably 5 or less and, more preferably, 2 or less, and most preferably 0. More preferably, the number of foreign matter particles having a size of 10 to 50 μm is no more than 100 per 250 mm². More preferably, the number of foreign matter particles having a size of 5 to 50 μm is no more than 100 per 250 mm². Foreign matter particles having a size of less than 5 μm are visually not problematic; however number of the foreign matter particles is preferable as less as possible if the size is less than 5 μm. On the other hand, foreign matter particles having a size of at least 50 μm are barely formed during the production of miscible high Tg polyester/polymer blend employing common methods. Foreign matter particles such as metal, sealing materials, and the like having a size of at least 50 μm, are removed during production process of polyester or polycarbonate. Due to that, foreign matter particles will be present when preparing the miscible high Tg polyester/polymer blend compositions and the melt must be filtered to remove these foreign matter particles prior to casting of the film. Filtering can occur during any stage of the process prior to actual film formation. Usable filters are those which exhibit resistance to high heat and stress. Typical structures employed as such filters may be, for example, simple screen holders or their extended area variants, screen changers or their extended area variants, single or multiple candle filter assemblies, leaf disc type assemblies or any other geometry that filtration media can be formed into for the purpose of melt filtration. Suitable media include woven wire cloth, sintered non-woven wire cloth, sintered powdered metal and any other porous structure constructed with materials sufficient to withstand the high temperatures of melt filtration. While any media can be used the preferred media is one of the depth types capable of removing gels and other deformable contaminants. Hard particle removal capabilities of the media can range from 20 um down to 0.1 um with 1-10 um being the preferred range.

Film Formation

In a general embodiment, the miscible high Tg polyester/polymer blend composition may be formed into film or sheet using any method known to those skilled in the art, including but not limited to extrusion and calendaring. For more melt process methods generally known in the polymer art, see Chapter 4—Processing of Plastics in “Plastics Engineering, 3^{rd} ed”, R. J. Crawford, Butterworth-Heinemann, 1998, Oxford, England.

In the extrusion process, the miscible high Tg polyester/polymer blend composition, typically in pellet form, fed to or placed in a hopper of an extruder, or other apparatus, for melt processing. Alternatively, the pellets, flake, plasticizer, additive, etc. may be added to the hopper of an extruder or other melt mixing apparatus by various feeders, which meter the components in their desired weight ratios. Upon exiting the extruder or other melt processing apparatus, the now molten blend composition is shaped into a film or sheet. The filtration of the molten miscible high Tg polyester/polymer blend composition mentioned above can be performed during the above mentioned compounding stage, or during the film forming stage.

In a general embodiment, the miscible high Tg polyester/polymer blend compositions of the invention are useful in making calendared film and/or sheet on calendaring rolls. The invention also provides a process for film or sheet by calendaring the novel miscible high Tg polyester/polymer blend composition and for the film or sheet produced from such calendaring processes. The calendared film or sheet typically has a thickness in the range of about 2 mils (0.05 mm) to about 1000 mils.

Our invention also includes a process for the manufacture of film or sheet, comprising any of the miscible high Tg polyester/polycarbonate compositions of the invention. In some embodiments, a process is disclosed for making such articles, film, sheet, and/or fibers comprising the steps of injection molding, extrusion blow molding, film/sheet extruding or calendaring the miscible high Tg polyester/polymer blend ester composition of the invention.

The miscible high Tg polyester/polymer blend compositions of the invention may be fabricated into mono-layer or multi-layer films by any technique known in the art. For example, mono-layer, or multi-layer films may be produced by the well known cast film, blown film and extrusion coating techniques, the latter including extrusion onto a substrate. Such a substrate may also include a tie-layer. Mono-layer, or multi-layer films produced by melt casting or blowing can be thermally bonded or sealed to a substrate using an adhesive. For example, multilayer structures of this invention are readily prepared by conventional coextrusion processes, a conventional in-line or off-line lamination process or a conventional extrusion coating process, all well known in the art. In general, in a coextrusion process, the polymers are brought to the molten state and coextruded from a conventional extruder through a flat sheet die, the melt streams being combined in a coextrusion feed block or multimanifold die prior to exiting the die. After leaving the die, the multi-layer film structure is quenched and removed for subsequent handling. When the molten film (mono-layer or multi-layer) exits the die, it can be quenched directly on a chill roll, or gradually cooled through a series of chill rolls. The molten film can also be polished between two rolls prior to complete chilling. The molten film can be cast onto a rotating continuous belt, such as used in the common solvent cast process, where the temperature profile along said continuous belt is precisely controlled to ultimately control the cooling profile of the extruded film when going to the molten to solid state. The molten film can be cast in-between a double belt press where again the temperature profile along said double belt press is precisely controlled to ultimately control the cooling profile of the extruded film when going to the molten to solid state. The controlled cooling of the extruded film from the molten state to the solid state is important in controlling the birefringent and/or optical properties of the resulting finished film product. It is desirable for any surface which is used to collect and cool a melt extruded film to be polished to, or near to a mirror finish in order to minimize defects from the final film surface. Significant defects will interfere with the optical performance of the film when used in display applications. Formation of films from the resulting blend compositions of the invention can be achieved by melt extrusion, as described, for example, in U.S. Pat. No. 4,880,592, or by compression molding as described, for example, in U.S. Pat. No. 4,427,614, or by any other suitable method. The ordinary artisan, in possession of the present disclosure, can prepare such mono-layer or multi-layer films and articles containing such films without undue experimentation. The resulting films of this invention can be collected at a take-up station or winding station, or can be directly fed to a down stream process such as film stretching and/or heat-setting prior to final winding.

This invention also includes a process for extrusion of film or sheet or for making an extrusion profile, or for extruding film or sheet, comprising the miscible high Tg polyester/polymer blend compositions of the invention described hereinabove, and the films or sheets or extrusion profile produced thereof. The miscible high Tg polyester/polymer blend compositions of the invention of this invention are also useful as molded plastic parts, or as films and/or sheet. Examples of such parts include eyeglass frames, toothbrush handles, toys, automotive trim, tool handles, camera parts, razor parts, ink pen barrels, disposable syringes, bottles, nonwovens, food wraps, packaging films, and the like.

The miscible high Tg polyester/polymer blend compositions of the invention may be coated by extrusion coating or laminated to a substrate. Extrusion coating and laminating means are well known in the art. The laminating process may further include the step of preparing a film of the miscible high Tg polyester/polymer blend compositions according to the present invention. The film may be, for instance, a cast or blown film. Again, the skilled artisan in possession of the present disclosure would be well-aware of how to prepare a film from the blend according to the present invention. The substrate to which the miscible high Tg polyester/polymer blend compositions according to the present invention may be coated or laminated may be any substrate to which the miscible high Tg polyester/polymer blend compositions of the invention are ordinarily coated. Examples include, but are not limited to, paper or paperboard (printed or unprinted, coated—e.g., claycoated or uncoated), metal foils, plastic layers, glass, etc. These surfaces may be primed or unprimed. The skilled artisan, in possession of the present disclosure, can determine the optimum conditions for coating or lamination (experimental conditions, priming, etc.) without undue experimentation.

Post Film Processing

The monolayer or multilayer films described herein can be stretched by any known method. The film obtained may be stretched, for example, in a certain direction by from 1.01 to 6 times the original measurements. The stretching method for the film may be by any of the methods known in the art, such as, the roll-to-roll stretching method, the long-gap stretching, the tenter-stretching method, ring-roll or intermeshing, TM Long, hand stretching, and the tubular stretching method. With the use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also the stretching may be done first in one direction and then in the other direction to result in effective biaxial stretching.

Stretching of a film is defined herein as the elongation of a material beyond the yield point of the material to render permanent the deformation of the material. In so doing, the films must be stretched at an appropriate temperature, where this temperature range is roughly bound by the glass transition temperature (lower boundary) and the Vicat softening point +40° C. (upper boundary) of the miscible high Tg polyester/polymer blend compositions. Another method of quantifying the upper stretch boundary if the film heat distortion temperature (HDT)+40° C. The optimal stretch temperature depends on the stretch method used, the stretching rate, and the desired birefringent and other optical properties of the completed stretched film (Vicat is determined by ASTM D1525 and HDT is determined by either ASTM D648 or ASTM D1637).

Roll-to-roll stretching is generally performed by passing a film across a series of rolls where adjacent, downstream rolls are rotating at higher rates than upstream rolls. The simplest example is a film passing over two rolls, the second rotating faster than the first resulting in the film being stretched in the region in between the two rolls. Tenter frame stretching simply involves gripping a film and then moving the grips apart from one another (in lateral and/or longitudinal directions), stretching the film in between. Such processes can involve preheating of the film prior to stretching and heat setting after stretch.

Ring-roll stretching or intermesh stretching is performed by passing the film between two parallel rolls having a surface of intermeshing gear-like teeth where the degree of stretch that is applied to the film is controlled by the degree of gear engagement, i.e., how close the rolls are brought together. Machine direction stretching is accomplished using rolls where the gear-like teeth spans the cross direction of the upper and lower roll analogous to a wide cog or pitch spur gears. Cross direction stretching is accomplished by covering the surface of the rolls with intermeshing disks. Passing a film through the machine direction stretching device produces uniform stretched bands spanning the cross direction of the film. Passing a film through the cross direction stretching device produces uniform stretched bands spanning the machine direction of the film. Passing film through both of these devices produces a film bearing a crosshatched or checkered pattern.

The TM Long film stretcher (named for the producer) uniaxially or biaxially stretches samples of pressed, blown, or extruded film. The operation of the film stretcher is based upon the movement of two drawbars at right angles to each other upon hydraulically driven rods. There is a fixed draw bar opposed to each moving draw bar. These pairs of opposed moving and fixed draw bars, to which the four edges of the film specimen are attached, form the two axes at right angles to each other along which the specimen is stretched in any stretch ratio up to four or seven times original size, depending on the machine being used. Samples are placed in grips on the machine and heated prior to stretching if desired. The outputs from the device are stress versus elongation data (if desired) at the temperature of the experiment and the stretched film.

These films can be heat-set under restrained or unrestrained conditions and allowed to shrink slightly (in planar and/or thickness direction) to reduce residual stresses present in stretched films, which is believed to be important during the manufacture of optical films where precise control of the isotropic or anisotropic nature of the film is required. Mechanically, any residual stresses present in stretched film have been allowed to relax, thus making the film stronger and more uniform. Additionally, the surface of the film becomes smoother and more uniform.

These films may be isotropic or anisotropic depending on the conditions used during film casting and post film treatment. Isotropic films are useful as protective films for polarizer plates and anisotropic films are useful as compensation films for improving the viewing angle of a display. Isotropic and Anisotropic are defined by the refractive index values (n) in the three directions (x, y, z) where x and y are in the plane of the film and z in the thickness direction of the film plane. The films of this invention can range from 1 to 1000 mils in thickness. Preferably, films are from 1 to 100 mils in thickness. Even more preferably, films are from 1 to 10 mils in thickness. And most preferably, films are from 1 to 5 mils in thickness. Retardation values in the plane of the film is defined by:
Ro=(nx−ny)*film thickness
Retardation values in the thickness direction of the film is defined by:
Rt=[(nx+ny)/2−nz]*film thickness

A film useful as a protection film may be considered Isotropic if Ro and/or Rt are below 10 to 200 nm, and a film useful as a compensation film may be Anisotropic if Ro and/or Rt are above 10 to 200 nm. These retardation values are easily controlled to target either compensation films or protection films by adjusting the film thickness, the stretch ratio, the stretching temperature, and of course the film composition (polyester type and content, polycarbonate type and content and additives used).

The polyester/polymer blend composition for use in the LCD film and sheet substrates of the present invention may further contain any additive conventionally used, such as fillers, other compatible plastics, anti-static agents, antioxidants, flame-proofing agents, lubricants, UV absorbers/stabilizers. The additives may be used in conventional effective amounts. In one embodiment, they are present in an amount from 0.1 to a total of about 20% relative to the total weight of the composition. The use of such additives may be desirable in enhancing the processing of the composition as well as improving the products or articles formed therefrom. Examples of such include: oxidative and thermal stabilizers, lubricants, mold release agents, flame-retarding agents, oxidation inhibitors, dyes, pigments and other coloring agents, ultraviolet light stabilizers, nucleators, plasticizers, as well as other conventional additives known to the art. These conventional additives may be incorporated into compositions at any suitable stage of the production process, and typically are introduced in the mixing step and included in an extrudate.

By way of example, representative ultraviolet light stabilizers include various substituted resorcinols, salicylates, benzotriazole, benzophenones, and the like. Suitable exemplary lubricants and mold release agents include stearic acid, stearyl alcohol, stearamides. Exemplary flame-retardants include organic halogenated compounds, including decabromodiphenyl ether and the like as well as inorganic compounds. Suitable coloring agents including dyes and pigments include cadmium sulfide, cadmium selenide, titanium dioxide, phthalocyanines, ultramarine blue, nigrosine, carbon black and the like. Representative oxidative and thermal stabilizers include the Period Table of Element's Group I metal halides, such as sodium halides, potassium halides, lithium halides; as well as cuprous halides; and further, chlorides, bromides, iodides. Also, hindered phenols, hydroquinones, aromatic amines as well as substituted members of those above mentioned groups and combinations thereof. Exemplary plasticizers include lactams such as caprolactam and lauryl lactam, sulfonamides such as o,p-toluenesulfonamide and N-ethyl, N-butyl benylnesulfonamide, and combinations of any of the above, as well as other plasticizers known to the art.

In one embodiment of the invention with the plastic forming the transparent plastic substrate being an aromatic polycarbonate resin, the ultraviolet absorbent is selected from 2-(3′-t-butyl-5′-methyl-2′-hydroxyphenyl)-5-chlorobenzotriazole, 2-(3′,5′-di-t-butyl-2′-hydroxyphenyl)-5-chlorobenzotriazole, 2-(2′-hydroxy-5′-t-octylphenyl)benzotriazole or 2-(4,6-diphenyl-1,3,5-triazin-2-yl)-5-hexyloxyphenol.

In one embodiment of the invention wherein the polyester/polymer blend is a homogeneous sheet or multi-wall sheet, the substrate is further coated with a protection layer such as UV coating or infrared light reflecting coating. In one embodiment, the coating comprises IR reflecting particles which comprise a titanium dioxide layer applied on a flake like carrier. In another embodiment, the UV coating layer comprises a non-fluorescing material selected from the group consisting of benzotriazoles, triazines and diphenylcyanoacrylates, or a fluorescing material such as a benzoxazinone. A fluorescing additive acts as a brightness enhancing agent (or fluorescing whitening agents) and is dissolved (not dispersed) into the blend. Additional examples of fluorescing materials are: stilbyl-naphthotriazole, diphenylgloxaline, coumarin, aminocoumarin, triazinylaminostilbene, bistriazinylaminostilbene, stilbyl-naphthotriazole, trimethyldihydropyridine, trimethyldihydropyridine, xanthene, naphthalimide, aminocoumarin, stilbyl-s-triazine, triazoylstilbene, pyrazoline, morpholine, coeroxene, triazole, benzidine sulphone, triazine, acenaphthene, stilbyl-s-triazine, coumarinyl-pyrazole, azastilbene, stilbene derivative, pyrazoline derivative, distyryl-biphenyl derivative, distyrylbiphenyl, styrylbenzoxazole derivative, benzoxazole-ethylene derivative, stilbene benzoxazole, heterocyclic such as C. I. Constitution Number 515245, 515240, azacyanine, 4,4′-diaminostilbene-2,2′-disulphonic acid derivatives and coumarin derivative. Optical brighteners or fluorescent whitening agents (FWA) are colorless to weakly colored organic compounds that in solution or applied to a substrate absorb ultraviolet light and re-emit most of the absorbed energy as blue fluorescent light between 400-500 nm. FWAs improve lightness because their bluing effect is not based on subtracting yellow-green light, but rather on adding blue and violet light FWAs are virtually colorless compounds which, absorb primarily invisible ultraviolet light in the 360-380 nanometer (nm) range and re-emit in the visible violet-to-blue light. This ability of FWAs to absorb invisible short wavelength radiation and re-emit in the visible blue light which imparts a brilliant whiteness, increasing the amount of light reflected in the 400 to 600 nm range by a substrate, is the key to FWAs effectiveness.

In yet another embodiment, the cap layer comprises or further comprises a brightness enhancing agent. In one embodiment wherein a UV coating layer is employed, the thickness of the coating is governed by the concentration of UV absorbing compound. For a UV protective layer that will absorb at least 90% of the harmful UV radiation prior to it reaching the underlying light diffusing sheet with the UV protective layer applied by coextrusion, lamination, or coating technology. In one embodiment of a homogeneous sheet or multi-wall sheet, the UV coating layer has a thickness of about 2 to 10 microns.

Manufacturing of the light diffusing article. The mixing of the components for the preparation of the composition used in the light diffusing substrate of the present invention may be carried out conventionally by methods and using equipment which are well known in the art.

In one embodiment, the components are prepared by mixing light-diffusing polycarbonate resins with poly(methyl silsesquioxanes), and then melt-kneading the mixture in a suitable extruder to form pellets. The pellets are then used to form the light diffusing substrates of the present invention through conventional methods such as extrusion, injection molding, or solvent casting into light diffusing substrates for commerce.

In one embodiment of the invention, the solvent casting method is used for forming a light diffusing film of low retardation. In another embodiment of the invention, wherein the light diffusing substrate is formed using an extrusion process, it is surprisingly found that the extruder die and calibrators have to be cleaned less frequently (in some instances, about ⅕ as often) due to less plating out and fouling problems seen in the manufacturing process of the prior art, wherein BaSO₄ and other materials are used to make light diffusing articles. In yet another embodiment of the invention, the extruder is in operation for a minimum of 10 hours before the extruder die has to be cleaned.

In embodiments wherein the substrate is further coating with a protective coating layer, the coating can be applied via roller coating, spray coating or screen-printing.

In certain embodiments of the invention wherein the light diffusing substrate is a homogeneous sheet or multi-wall sheet, the sheet has a thickness of about 5 to 50 mm with a thickness variation of ±10% over an area of 1 m². In another embodiment of a homogeneous sheet or multi-wall sheet, the thickness is about 10 to 30 mm. In embodiments wherein the light diffusing substrate is in the form of a film, the film thickness is about 2 to 15 mils, with a thickness variation of ±10% over an area of 1 m².

In certain embodiments the light diffusing substrate of the invention is further characterized as having minimum variations in light transmission due to the excellent dispersion property of the polyalkyl silsesquioxane. In one embodiment, the variation in light transmission is within 5% over a web area of 1 m² of homogeneous sheet or multi-wall sheet. In another embodiment, wherein the light diffusing substrate is in the form of a film having a thickness of 2-15 mils, the light transmission variation is ±2%.

The miscible, high Tg polyester/polymer blend of the present invention is used in a number of homogeneous sheet multi-wall sheet applications and optical applications in general, particularly in LCD film or sheet applications.

In certain embodiments the miscible, high Tg polyester/polymer blends of the present invention are typically characterized by a novel combination of properties which preferably include polyester/polymer blends (with out light scattering agents present) having a clearness or clarity or haze value measured on ⅛ inch (3.2 mm) molded samples of about 0.2 to 3.0 percent as determined by a HunterLab UltraScan Sphere 8000 using Hunter's Universal Software, where % Haze=100*Diffuse Transmission/Total Transmission. Diffuse transmission is obtained by placing a light trap on the other side of the integrating sphere from where the sample port is, thus eliminating the straight-thru light path. Only light scattered by greater than 2.5 degrees is measured. Total transmission includes measurement of light passing straight-through the sample and also off-axis light scattered to the sensor by the sample. The sample is placed at the exit port of the sphere so that off-axis light from the full sphere interior is available for scattering. Regular transmission is the name given to measurement of only the straight-through rays—the sample is placed immediately in front of the sensor, which is approximately 20 cm away from the sphere exit port—this keeps off-axis light from impinging on the sample. In certain embodiments the polymer blends also exhibit a Glass Transition Temperature (Tg), of at least 100° C., preferably at least 110° C., more preferable at least 120° C. The film or sheet prepared from the blends of this invention comprising a particulate light scattering agent and an brightness enhancing agent are characterized by having higher brightness or luminance when compared to the film or sheet prepared from blends of this invention comprising only the particulate light scattering agent.

For the purposes of this disclosure, the term “wt” means “weight”.

The following examples further illustrate how the LCD films or sheets of the invention can be made and evaluated, and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

Measurement Methods

The inherent viscosity of the polyesters was determined in 60/40 (wt/wt) phenol/tetrachloroethane at a concentration of 0.5 g/100 ml at 25° C.

Unless stated otherwise, the glass transition temperature (T_{g}) was determined using a TA DSC 2920 instrument from Thermal Analyst Instruments at a scan rate of 20° C./min according to ASTM D3418.

The glycol content and the cis/trans ratio of the compositions were determined by proton nuclear magnetic resonance (NMR) spectroscopy. All NMR spectra were recorded on a JEOL Eclipse Plus 600 MHz nuclear magnetic resonance spectrometer using either chloroform-trifluoroacetic acid (70-30 volume/volume) for polymers or, for oligomeric samples, 60/40 (wt/wt) phenol/tetrachloroethane with deuterated chloroform added for lock. Peak assignments for 2,2,4,4-tetramethyl-1,3-cyclobutanediol resonances were made by comparison to model mono- and dibenzoate esters of 2,2,4,4-tetramethyl-1,3-cyclobutanediol. These model compounds closely approximate the resonance positions found in the polymers and oligomers.

The crystallization half-time, t½, was determined by measuring the light transmission of a sample via a laser and photo detector as a function of time on a temperature controlled hot stage. This measurement was done by exposing the polymers to a temperature, Tₘₐₓ, and then cooling it to the desired temperature. The sample was then held at the desired temperature by a hot stage while transmission measurements were made as a function of time. Initially, the sample was visually clear with high light transmission and became opaque as the sample crystallized. The crystallization half-time was recorded as the time at which the light transmission was halfway between the initial transmission and the final transmission. Tₘₐₓ is defined as the temperature required to melt the crystalline domains of the sample (if crystalline domains are present). The Tₘₐₓ reported in the examples below represents the temperature at which each sample was heated to condition the sample prior to crystallization half time measurement. The Tₘₐₓ temperature is dependant on composition and is typically different for each polyester. For example, PCT may need to be heated to some temperature greater than 290° C. to melt the crystalline domains.

Density was determined using a gradient density column at 23° C.

The melt viscosity reported herein was measured by using a Rheometrics Dynamic Analyzer (RDA II). The melt viscosity was measured as a function of shear rate, at frequencies ranging from 1 to 400 rad/sec, at the temperatures reported. The zero shear melt viscosity (ηₒ) is the melt viscosity at zero shear rate estimated by extrapolating the data by known models in the art. This step is automatically performed by the Rheometrics Dynamic Analyzer (RDA II) software.

The polymers were dried at a temperature ranging from 80 to 100° C. in a vacuum oven for 24 hours and injection molded on a Boy 22S molding machine to give ⅛×½×5-inch and ¼×½×5-inch flexure bars. These bars were cut to a length of 2.5 inch and notched down the ½ inch width with a 10-mil notch in accordance with ASTM D256. The average Izod impact strength at 23° C. was determined from measurements on 5 specimens.

In addition, 5 specimens were tested at various temperatures using 5° C. increments in order to determine the brittle-to-ductile transition temperature. The brittle-to-ductile transition temperature is defined as the temperature at which 50% of the specimens fail in a brittle manner as denoted by ASTM D256.

Color values reported herein were determined using a Hunter Lab Ultrascan Spectra Colorimeter manufactured by Hunter Associates Lab Inc., Reston, Va. The color determinations were averages of values measured on either pellets of the polyesters or plaques or other items injection molded or extruded from them. They were determined by the L*a*b* color system of the CIE (International Commission on Illumination) (translated), wherein L* represents the lightness coordinate, a* represents the red/green coordinate, and b* represents the yellow/blue coordinate.

In addition, 10-mil films were compression molded using a Carver press at 240° C.

1. Unless otherwise specified, the cis/trans ratio of the 1,4 cyclohexanedimethanol used in the following examples was approximately 30/70, and could range from 35/65 to 25/75. Unless otherwise specified, the cis/trans ratio of the 2,2,4,4-tetramethyl-1,3-cyclobutanediol used in the following examples was approximately 50/50.

The following abbreviations apply throughout the working examples and figures:

| | |
|---|---|
| TPA | Terephthalic acid |
| DMT | Dimethyl terephthalate |
| TMCD | 2,2,4,4-tetramethyl-1,3-cyclobutanediol |
| CHDM | 1,4-cyclohexanedimethanol |
| IV | Inherent viscosity |
| ηₒ | Zero shear melt viscosity |
| T_{g} | Glass transition temperature |
| T_{bd} | Brittle-to-ductile transition temperature |
| Tₘₐₓ | Conditioning temperature for crystallization |
| | half time measurements |

### Example 1

This example illustrates that 2,2,4,4-tetramethyl-1,3-cyclobutanediol is more effective at reducing the crystallization rate of PCT than ethylene glycol or isophthalic acid. In addition, this example illustrates the benefits of 2,2,4,4-tetramethyl-1,3-cyclobutanediol on the glass transition temperature and density.

A variety of copolyesters were prepared as described below. These copolyesters were all made with 200 ppm dibutyl tin oxide as the catalyst in order to minimize the effect of catalyst type and concentration on nucleation during crystallization studies. The cis/trans ratio of the 1,4-cyclohexanedimethanol was 31/69 while the cis/trans ratio of the 2,2,4,4-tetramethyl-1,3-cyclobutanediol is reported in Table 1.

For purposes of this example, the samples had sufficiently similar inherent viscosities thereby effectively eliminating this as a variable in the crystallization rate measurements.

Crystallization half-time measurements from the melt were made at temperatures from 140 to 200° C. at 10° C. increments and are reported in Table 1. The fastest crystallization half-time for each sample was taken as the minimum value of crystallization half-time as a function of temperature, typically occurring around 170 to 180° C. The fastest crystallization half-times for the samples are plotted in FIG. 1 as a function of mole % comonomer modification to PCT.

The data shows that 2,2,4,4-tetramethyl-1,3-cyclobutanediol is more effective than ethylene glycol and isophthalic acid at decreasing the crystallization rate (i.e., increasing the crystallization half-time). In addition, 2,2,4,4-tetramethyl-1,3-cyclobutanediol increases T_{g} and lowers density.

TABLE 1
Crystallization Half-times (min)

| | | | | | | at | at | at | at | at | at | at |
|---|---|---|---|---|---|---|---|---|---|---|---|---|
| | Comonomer | IV | Density | T_{g} | Tₘₐₓ | 140° C. | 150° C. | 160° C. | 170° C. | 180° C. | 190° C. | 200° C. |
| Example | (mol %)¹ | (dl/g) | (g/ml) | (° C.) | (° C.) | (min) | (min) | (min) | (min) | (min) | (min) | (min) |
| 1A | 20.2% A² | 0.630 | 1.198 | 87.5 | 290 | 2.7 | 2.1 | 1.3 | 1.2 | 0.9 | 1.1 | 1.5 |
| 1B | 19.8% B | 0.713 | 1.219 | 87.7 | 290 | 2.3 | 2.5 | 1.7 | 1.4 | 1.3 | 1.4 | 1.7 |
| 1C | 20.0% C | 0.731 | 1.188 | 100.5 | 290 | >180 | >60 | 35.0 | 23.3 | 21.7 | 23.3 | 25.2 |
| 1D | 40.2% A² | 0.674 | 1.198 | 81.2 | 260 | 18.7 | 20.0 | 21.3 | 25.0 | 34.0 | 59.9 | 96.1 |
| 1E | 34.5% B | 0.644 | 1.234 | 82.1 | 260 | 8.5 | 8.2 | 7.3 | 7.3 | 8.3 | 10.0 | 11.4 |
| 1F | 40.1% C | 0.653 | 1.172 | 122.0 | 260 | >10 days | >5 days | >5 days | 19204 | >5 days | >5 days | >5 days |
| 1G | 14.3% D | 0.646³ | 1.188 | 103.0 | 290 | 55.0 | 28.8 | 11.6 | 6.8 | 4.8 | 5.0 | 5.5 |
| 1H | 15.0% E | 0.728⁴ | 1.189 | 99.0 | 290 | 25.4 | 17.1 | 8.1 | 5.9 | 4.3 | 2.7 | 5.1 |

¹The balance of the diol component of the polyesters in Table 1 is 1,4-cyclohexanedimethanol; and the balance of the dicarboxylic acid component of the polyesters in Table 1 is dimethyl terephthalate; if the dicarboxylic acid is not described, it is 100 mole % dimethyl terephthalate.
²100 mole % 1,4-cyclohexanedimethanol.
³A film was pressed from the ground polyester of Example 1G at 240° C. The resulting film had an inherent viscosity value of 0.575 dL/g.
⁴A film was pressed from the ground polyester of Example 1H at 240° C. The resulting film had an inherent viscosity value of 0.0.652 dL/g.

where:
A is Isophthalic Acid
B is Ethylene Glycol
C is 2,2,4,4-Tetramethyl-1,3-cyclobutanediol (approx. 50/50 cis/trans)
D is 2,2,4,4-Tetramethyl-1,3-cyclobutanediol (98/2 cis/trans)
E is 2,2,4,4-Tetramethyl-1,3-cyclobutanediol (5/95 cis/trans)

As shown in Table 1 and FIG. 1, 2,2,4,4-tetramethyl-1,3-cyclobutanediol is more effective than other comonomers, such ethylene glycol and isophthalic acid, at increasing the crystallization half-time, i.e., the time required for a polymer to reach half of its maximum crystallinity. By decreasing the crystallization rate of PCT (increasing the crystallization half-time), amorphous articles based on 2,2,4,4-tetramethyl-1,3-cyclobutanediol-modified PCT as described herein may be fabricated by methods known in the art. As shown in Table 1, these materials can exhibit higher glass transition temperatures and lower densities than other modified PCT copolyesters.

Preparation of the polyesters shown on Table 1 is described below.

### Example 1A

This example illustrates the preparation of a copolyester with a target composition of 80 mol % dimethyl terephthalate residues, 20 mol % dimethyl isophthalate residues, and 100 mol % 1,4-cyclohexanedimethanol residues (28/72 cis/trans).

A mixture of 56.63 g of dimethyl terephthalate, 55.2 g of 1,4-cyclohexanedimethanol, 14.16 g of dimethyl isophthalate, and 0.0419 g of dibutyl tin oxide was placed in a 500-milliliter flask equipped with an inlet for nitrogen, a metal stirrer, and a short distillation column. The flask was placed in a Wood's metal bath already heated to 210° C. The stirring speed was set to 200 RPM throughout the experiment. The contents of the flask were heated at 210° C. for 5 minutes and then the temperature was gradually increased to 290° C. over 30 minutes. The reaction mixture was held at 290° C. for 60 minutes and then vacuum was gradually applied over the next 5 minutes until the pressure inside the flask reached 100 mm of Hg. The pressure inside the flask was further reduced to 0.3 mm of Hg over the next 5 minutes. A pressure of 0.3 mm of Hg was maintained for a total time of 90 minutes to remove excess unreacted diols. A high melt viscosity, visually clear and colorless polymer was obtained with a glass transition temperature of 87.5° C. and an inherent viscosity of 0.63 dl/g. NMR analysis showed that the polymer was composed of 100 mol % 1,4-cyclohexanedimethanol residues and 20.2 mol % dimethyl isophthalate residues.

### Example 1B

This example illustrates the preparation of a copolyester with a target composition of 100 mol % dimethyl terephthalate residues, 20 mol % ethylene glycol residues, and 80 mol % 1,4-cyclohexanedimethanol residues (32/68 cis/trans).

A mixture of 77.68 g of dimethyl terephthalate, 50.77 g of 1,4-cyclohexanedimethanol, 27.81 g of ethylene glycol, and 0.0433 g of dibutyl tin oxide was placed in a 500-milliliter flask equipped with an inlet for nitrogen, a metal stirrer, and a short distillation column. The flask was placed in a Wood's metal bath already heated to 200° C. The stirring speed was set to 200 RPM throughout the experiment. The contents of the flask were heated at 200° C. for 60 minutes and then the temperature was gradually increased to 210° C. over 5 minutes. The reaction mixture was held at 210° C. for 120 minutes and then heated up to 280° C. in 30 minutes. Once at 280° C., vacuum was gradually applied over the next 5 minutes until the pressure inside the flask reached 100 mm of Hg. The pressure inside the flask was further reduced to 0.3 mm of Hg over the next 10 minutes. A pressure of 0.3 mm of Hg was maintained for a total time of 90 minutes to remove excess unreacted diols. A high melt viscosity, visually clear and colorless polymer was obtained with a glass transition temperature of 87.7° C. and an inherent viscosity of 0.71 dl/g. NMR analysis showed that the polymer was composed of 19.8 mol % ethylene glycol residues.

### Example 1C

This example illustrates the preparation of a copolyester with a target composition of 100 mol % dimethyl terephthalate residues, 20 mol % 2,2,4,4-tetramethyl-1,3-cyclobutanediol residues, and 80 mol % 1,4-cyclohexanedimethanol residues (31/69 cis/trans).

A mixture of 77.68 g of dimethyl terephthalate, 48.46 g of 1,4-cyclohexanedimethanol, 17.86 g of 2,2,4,4-tetramethyl-1,3-cyclobutanediol, and 0.046 g of dibutyl tin oxide was placed in a 500-milliliter flask equipped with an inlet for nitrogen, a metal stirrer, and a short distillation column. This polyester was prepared in a manner similar to that described in Example 1A. A high melt viscosity, visually clear and colorless polymer was obtained with a glass transition temperature of 100.5° C. and an inherent viscosity of 0.73 dl/g. NMR analysis showed that the polymer was composed of 80.5 mol % 1,4-cyclohexanedimethanol residues and 19.5 mol % 2,2,4,4-tetramethyl-1,3-cyclobutanediol residues.

### Example 1D

This example illustrates the preparation of a copolyester with a target composition of 100 mol % dimethyl terephthalate residues, 40 mol % dimethyl isophthalate residues, and 100 mol % 1,4-cyclohexanedimethanol residues (28/72 cis/trans).

A mixture of 42.83 g of dimethyl terephthalate, 55.26 g of 1,4-cyclohexanedimethanol, 28.45 g of dimethyl isophthalate, and 0.0419 g of dibutyl tin oxide was placed in a 500-milliliter flask equipped with an inlet for nitrogen, a metal stirrer, and a short distillation column. The flask was placed in a Wood's metal bath already heated to 210° C. The stirring speed was set to 200 RPM throughout the experiment. The contents of the flask were heated at 210° C. for 5 minutes and then the temperature was gradually increased to 290° C. over 30 minutes. The reaction mixture was held at 290° C. for 60 minutes and then vacuum was gradually applied over the next 5 minutes until the pressure inside the flask reached 100 mm of Hg. The pressure inside the flask was further reduced to 0.3 mm of Hg over the next 5 minutes. A pressure of 0.3 mm of Hg was maintained for a total time of 90 minutes to remove excess unreacted diols. A high melt viscosity, visually clear and colorless polymer was obtained with a glass transition temperature of 81.2° C. and an inherent viscosity of 0.67 dl/g. NMR analysis showed that the polymer was composed of 100 mol % 1,4-cyclohexanedimethanol residues and 40.2 mol % dimethyl isophthalate residues.

### Example 1E

This example illustrates the preparation of a copolyester with a target composition of 100 mol % dimethyl terephthalate residues, 40 mol % ethylene glycol residues, and 60 mol % 1,4-cyclohexanedimethanol residues (31/69 cis/trans).

A mixture of 81.3 g of dimethyl terephthalate, 42.85 g of 1,4-cyclohexanedimethanol, 34.44 g of ethylene glycol, and 0.0419 g of dibutyl tin oxide was placed in a 500-milliliter flask equipped with an inlet for nitrogen, a metal stirrer, and a short distillation column. The flask was placed in a Wood's metal bath already heated to 200° C. The stirring speed was set to 200 RPM throughout the experiment. The contents of the flask were heated at 200° C. for 60 minutes and then the temperature was gradually increased to 210° C. over 5 minutes. The reaction mixture was held at 210° C. for 120 minutes and then heated up to 280° C. in 30 minutes. Once at 280° C., vacuum was gradually applied over the next 5 minutes until the pressure inside the flask reached 100 mm of Hg. The pressure inside the flask was further reduced to 0.3 mm of Hg over the next 10 minutes. A pressure of 0.3 mm of Hg was maintained for a total time of 90 minutes to remove excess unreacted diols. A high melt viscosity, visually clear and colorless polymer was obtained with a glass transition temperature of 82.1° C. and an inherent viscosity of 0.64 dl/g. NMR analysis showed that the polymer was composed of 34.5 mol % ethylene glycol residues.

### Example 1F

This example illustrates the preparation of a copolyester with a target composition of 100 mol % dimethyl terephthalate residues, 40 mol % 2,2,4,4-tetramethyl-1,3-cyclobutanediol residues, and 60 mol % 1,4-cyclohexanedimethanol residues (31/69 cis/trans).

A mixture of 77.4 g of dimethyl terephthalate, 36.9 g of 1,4-cyclohexanedimethanol, 32.5 g of 2,2,4,4-tetramethyl-1,3-cyclobutanediol, and 0.046 g of dibutyl tin oxide was placed in a 500-milliliter flask equipped with an inlet for nitrogen, a metal stirrer, and a short distillation column. The flask was placed in a Wood's metal bath already heated to 210° C. The stirring speed was set to 200 RPM throughout the experiment. The contents of the flask were heated at 210° C. for 3 minutes and then the temperature was gradually increased to 260° C. over 30 minutes. The reaction mixture was held at 260° C. for 120 minutes and then heated up to 290° C. in 30 minutes. Once at 290° C., vacuum was gradually applied over the next 5 minutes until the pressure inside the flask reached 100 mm of Hg. The pressure inside the flask was further reduced to 0.3 mm of Hg over the next 5 minutes. A pressure of 0.3 mm of Hg was maintained for a total time of 90 minutes to remove excess unreacted diols. A high melt viscosity, visually clear and colorless polymer was obtained with a glass transition temperature of 122° C. and an inherent viscosity of 0.65 dl/g. NMR analysis showed that the polymer was composed of 59.9 mol % 1,4-cyclohexanedimethanol residues and 40.1 mol % 2,2,4,4-tetramethyl-1,3-cyclobutanediol residues.

### Example 1G

This example illustrates the preparation of a copolyester with a target composition of 100 mol % dimethyl terephthalate residues, 20 mol % 2,2,4,4-tetramethyl-1,3-cyclobutanediol residues (98/2 cis/trans), and 80 mol % 1,4-cyclohexanedimethanol residues (31/69 cis/trans).

A mixture of 77.68 g of dimethyl terephthalate, 48.46 g of 1,4-cyclohexanedimethanol, 20.77 g of 2,2,4,4-tetramethyl-1,3-cyclobutanediol, and 0.046 g of dibutyl tin oxide was placed in a 500-milliliter flask equipped with an inlet for nitrogen, a metal stirrer, and a short distillation column. The flask was placed in a Wood's metal bath already heated to 210° C. The stirring speed was set to 200 RPM throughout the experiment. The contents of the flask were heated at 210° C. for 3 minutes and then the temperature was gradually increased to 260° C. over 30 minutes. The reaction mixture was held at 260° C. for 120 minutes and then heated up to 290° C. in 30 minutes. Once at 290° C., vacuum was gradually applied over the next 5 minutes until the pressure inside the flask reached 100 mm of Hg and the stirring speed was also reduced to 100 RPM. The pressure inside the flask was further reduced to 0.3 mm of Hg over the next 5 minutes and the stirring speed was reduced to 50 RPM. A pressure of 0.3 mm of Hg was maintained for a total time of 60 minutes to remove excess unreacted diols. A high melt viscosity, visually clear and colorless polymer was obtained with a glass transition temperature of 103° C. and an inherent viscosity of 0.65 dl/g. NMR analysis showed that the polymer was composed of 85.7 mol % 1,4-cyclohexanedimethanol residues and 14.3 mol % 2,2,4,4-tetramethyl-1,3-cyclobutanediol residues.

### Example 1H

This example illustrates the preparation of a copolyester with a target composition of 100 mol % dimethyl terephthalate residues, 20 mol % 2,2,4,4-tetramethyl-1,3-cyclobutanediol residues (5/95 cis/trans), and 80 mol % 1,4-cyclohexanedimethanol residues (31/69 cis/trans).

A mixture of 77.68 g of dimethyl terephthalate, 48.46 g of 1,4-cyclohexanedimethanol, 20.77 g of 2,2,4,4-tetramethyl-1,3-cyclobutanediol, and 0.046 g of dibutyl tin oxide was placed in a 500-milliliter flask equipped with an inlet for nitrogen, a metal stirrer, and a short distillation column. The flask was placed in a Wood's metal bath already heated to 210° C. The stirring speed was set to 200 RPM at the beginning of the experiment. The contents of the flask were heated at 210° C. for 3 minutes and then the temperature was gradually increased to 260° C. over 30 minutes. The reaction mixture was held at 260° C. for 120 minutes and then heated up to 290° C. in 30 minutes. Once at 290° C., vacuum was gradually applied over the next 5 minutes with a set point of 100 mm of Hg and the stirring speed was also reduced to 100 RPM. The pressure inside the flask was further reduced to a set point of 0.3 mm of Hg over the next 5 minutes and the stirring speed was reduced to 50 RPM. This pressure was maintained for a total time of 60 minutes to remove excess unreacted diols. It was noted that the vacuum system failed to reach the set point mentioned above, but produced enough vacuum to produce a high melt viscosity, visually clear and colorless polymer with a glass transition temperature of 99° C. and an inherent viscosity of 0.73 dl/g. NMR analysis showed that the polymer was composed of 85 mol % 1,4-cyclohexanedimethanol residues and 15 mol % 2,2,4,4-tetramethyl-1,3-cyclobutanediol residues.

### Example 2

This example illustrates that 2,2,4,4-tetramethyl-1,3-cyclobutanediol improves the toughness of PCT-based copolyesters (polyesters containing terephthalic acid and 1,4-cyclohexanedimethanol).

Copolyesters based on 2,2,4,4-tetramethyl-1,3-cyclobutanediol were prepared as described below. The cis/trans ratio of the 1,4-cyclohexanedimethanol was approximately 31/69 for all samples. Copolyesters based on ethylene glycol and 1,4-cyclohexanedimethanol were commercial polyesters. The copolyester of Example 2A (Eastar PCTG 5445) was obtained from Eastman Chemical Co. The copolyester of Example 2B was obtained from Eastman Chemical Co. under the trade name Spectar. Example 2C and Example 2D were prepared on a pilot plant scale (each a 15-lb batch) following an adaptation of the procedure described in Example 1A and having the inherent viscosities and glass transition temperatures described in Table 2 below. Example 2C was prepared with a target tin amount of 300 ppm (Dibutyltin Oxide). The final product contained 295 ppm tin. The color values for the polyester of Example 2C were L*=77.11; a*=−1.50; and b*=5.79. Example 2D was prepared with a target tin amount of 300 ppm (Dibutyltin Oxide). The final product contained 307 ppm tin. The color values for the polyester of Example 2D were L*=66.72; a*=−1.22; and b*=16.28.

Materials were injection molded into bars and subsequently notched for Izod testing. The notched Izod impact strengths were obtained as a function of temperature and are also reported in Table 2.

For a given sample, the Izod impact strength undergoes a major transition in a short temperature span. For instance, the Izod impact strength of a copolyester based on 38 mol % ethylene glycol undergoes this transition between 15 and 20° C. This transition temperature is associated with a change in failure mode; brittle/low energy failures at lower temperatures and ductile/high energy failures at higher temperatures. The transition temperature is denoted as the brittle-to-ductile transition temperature, T_{bd}, and is a measure of toughness. T_{bd} is reported in Table 2 and plotted against mol % comonomer in FIG. 2.

The data shows that adding 2,2,4,4-tetramethyl-1,3-cyclobutanediol to PCT lowers T_{bd} and improves the toughness, as compared to ethylene glycol, which increases T_{bd} of PCT.

TABLE 2
Notched Izod Impact Energy (ft-lb/in)

| | Comonomer | IV | T_{g} | T_{bd} | at | at | at | at | at | at | at | at | at | at | at |
|---|---|---|---|---|---|---|---|---|---|---|---|---|---|---|---|
| Example | (mol %)¹ | (dl/g) | (° C.) | (° C.) | −20° C. | −15° C. | −10° C. | −5° C. | 0° C. | 5° C. | 10° C. | 15° C. | 20° C. | 25° C. | 30° C. |
| 2A | 38.0% B | 0.68 | 86 | 18 | NA | NA | NA | 1.5 | NA | NA | 1.5 | 1.5 | 32 | 32 | NA |
| 2B | 69.0% B | 0.69 | 82 | 26 | NA | NA | NA | NA | NA | NA | 2.1 | NA | 2.4 | 13.7 | 28.7 |
| 2C | 22.0% C | 0.66 | 106 | −5 | 1.5 | NA | 12 | 23 | 23 | NA | 23 | NA | NA | NA | NA |
| 2D | 42.8% C | 0.60 | 133 | −12 | 2.5 | 2.5 | 11 | NA | 14 | NA | NA | NA | NA | NA | NA |

¹The balance of the glycol component of the polyesters in the Table is 1,4-cyclohexanedimethanol. All polymers were prepared from 100 mole % dimethyl terephthalate.
NA = Not available.

where:
B is Ethylene glycol
C is 2,2,4,4-Tetramethyl-1,3-cyclobutanediol (50/50 cis/trans)

### Example 3

This example illustrates that 2,2,4,4-tetramethyl-1,3-cyclobutanediol can improve the toughness of PCT-based copolyesters (polyesters containing terephthalic acid and 1,4-cyclohexanedimethanol). Polyesters prepared in this example comprise from 15 to 25 mol % of 2,2,4,4-tetramethyl-1,3-cyclobutanediol residues.

Copolyesters based on dimethyl terephthalate, 2,2,4,4-tetramethyl-1,3-cyclobutanediol, and 1,4-cyclohexanedimethanol were prepared as described below, having the composition and properties shown on Table 3. The balance up to 100 mol % of the diol component of the polyesters in Table 3 was 1,4-cyclohexanedimethanol (31/69 cis/trans).

Materials were injection molded into both 3.2 mm and 6.4 mm thick bars and subsequently notched for Izod impact testing. The notched Izod impact strengths were obtained at 23° C. and are reported in Table 3. Density, Tg, and crystallization halftime were measured on the molded bars. Melt viscosity was measured on pellets at 290° C.

TABLE 3
Compilation of various properties for certain polyesters useful in the invention

| | | | | | Notched | Notched | | | | |
|---|---|---|---|---|---|---|---|---|---|---|
| | | | | | Izod of | Izod of | | | | |
| | | | | | 3.2 mm | 6.4 mm | | | | Melt |
| | | | | | thick | thick | | | Crystallization | Viscosity |
| | | | Pellet | Molded | bars at | bars at | Specific | | Halftime from | at 1 rad/sec |
| | TMCD | % cis | IV | Bar IV | 23° C. | 23° C. | Gravity | Tg | melt at 170° C. | at 290° C. |
| Example | mole % | TMCD | (dl/g) | (dl/g) | (J/m) | (J/m) | (g/mL) | (° C.) | (min) | (Poise) |
| A | 15 | 48.8 | 0.736 | 0.707 | 1069 | 878 | 1.184 | 104 | 15 | 5649 |
| B | 18 | NA | 0.728 | 0.715 | 980 | 1039 | 1.183 | 108 | 22 | 6621 |
| C | 20 | NA | 0.706 | 0.696 | 1006 | 1130 | 1.182 | 106 | 52 | 6321 |
| D | 22 | NA | 0.732 | 0.703 | 959 | 988 | 1.178 | 108 | 63 | 7161 |
| E | 21 | NA | 0.715 | 0.692 | 932 | 482 | 1.179 | 110 | 56 | 6162 |
| F | 24 | NA | 0.708 | 0.677 | 976 | 812 | 1.180 | 109 | 58 | 6282 |
| G | 23 | NA | 0.650 | 0.610 | 647 | 270 | 1.182 | 107 | 46 | 3172 |
| H | 23 | 47.9 | 0.590 | 0.549 | 769 | 274 | 1.181 | 106 | 47 | 1736 |
| I | 23 | 48.1 | 0.531 | 0.516 | 696 | 352 | 1.182 | 105 | 19 | 1292 |
| J | 23 | 47.8 | 0.364 | NA | NA | NA | NA | 98 | NA | 167 |

NA = Not available

### Example 3A

21.24 lb (49.71 gram-mol) dimethyl terephthalate, 14.34 lb (45.21 gram-mol) 1,4-cyclohexanedimethanol, and 4.58 lb (14.44 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and at a pressure of 20 psig. The pressure was then decreased to 0 psig at a rate of 3 psig/minute. The temperature of the reaction mixture was then increased to 270° C. and the pressure was decreased to 90 mm of Hg. After a 1 hour hold time at 270° C. and 90 mm of Hg, the agitator speed was decreased to 15 RPM, the reaction mixture temperature was increased to 290° C., and the pressure was decreased to <1 mm of Hg. The reaction mixture was held at 290° C. and at a pressure of <1 mm of Hg until the power draw to the agitator no longer increased (70 minutes). The pressure of the pressure vessel was then increased to 1 atmosphere using nitrogen gas. The molten polymer was then extruded from the pressure vessel. The cooled, extruded polymer was ground to pass a 6-mm screen. The polymer had an inherent viscosity of 0.736 dL/g and a Tg of 104° C. NMR analysis showed that the polymer was composed of 85.4 mol % 1,4-cyclohexane-dimethanol residues and 14.6 mol % 2,2,4,4-tetramethyl-1,3-cyclobutanediol residues. The polymer had color values of: L*=78.20, a*=−1.62, and b*=6.23.

### Example 3B to Example 3D

The polyesters described in Example 3B to Example 3D were prepared following a procedure similar to the one described for Example 3A. The composition and properties of these polyesters are shown in Table 3.

### Example 3E

21.24 lb (49.71 gram-mol) dimethyl terephthalate, 12.61 lb (39.77 gram-mol) 1,4-cyclohexanedimethanol, and 6.30 lb (19.88 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and 20 psig pressure. The pressure was then decreased to 0 psig at a rate of 3 psig/minute. The temperature of the reaction mixture was then increased to 270° C. and the pressure was decreased to 90 mm of Hg. After a 1 hour hold time at 270° C. and 90 mm of Hg, the agitator speed was decreased to 15 RPM, the reaction mixture temperature was increased to 290° C., and the pressure was decreased to <1 mm of Hg. The reaction mixture was held at 290° C. and at a pressure of <1 mm of Hg for 60 minutes. The pressure of the pressure vessel was then increased to 1 atmosphere using nitrogen gas. The molten polymer was then extruded from the pressure vessel. The cooled, extruded polymer was ground to pass a 6-mm screen. The polymer had an inherent viscosity of 0.715 dL/g and a Tg of 110° C. X-ray analysis showed that the polyester had 223 ppm tin. NMR analysis showed that the polymer was composed of 78.6 mol % 1,4-cyclohexane-dimethanol residues and 21.4 mol % 2,2,4,4-tetramethyl-1,3-cyclobutanediol residues. The polymer had color values of: L*=76.45, a*=−1.65, and b*=6.47.

### Example 3F

The polyester described in Example 3F was prepared following a procedure similar to the one described for Example 3A. The composition and properties of this polyester are shown in Table 3.

### Example 3H

21.24 lb (49.71 gram-mol) dimethyl terephthalate, 12.61 lb (39.77 gram-mol) 1,4-cyclohexanedimethanol, and 6.30 lb (19.88 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and 20 psig pressure. The pressure was then decreased to 0 psig at a rate of 3 psig/minute. The temperature of the reaction mixture was then increased to 270° C. and the pressure was decreased to 90 mm of Hg. After a 1 hour hold time at 270° C. and 90 mm of Hg, the agitator speed was decreased to 15 RPM, the reaction mixture temperature was increased to 290° C., and the pressure was decreased to <1 mm of Hg. The reaction mixture was held at 290° C. and at a pressure of <1 mm of Hg for 12 minutes. The pressure of the pressure vessel was then increased to 1 atmosphere using nitrogen gas. The molten polymer was then extruded from the pressure vessel. The cooled, extruded polymer was ground to pass a 6-mm screen. The polymer had an inherent viscosity of 0.590 dL/g and a Tg of 106° C. NMR analysis showed that the polymer was composed of 77.1 mol % 1,4-cyclohexane-dimethanol residues and 22.9 mol % 2,2,4,4-tetramethyl-1,3-cyclobutanediol residues. The polymer had color values of: L*=83.27, a*=−1.34, and b*=5.08.

### Example 3I

21.24 lb (49.71 gram-mol) dimethyl terephthalate, 12.61 lb (39.77 gram-mol) 1,4-cyclohexanedimethanol, and 6.30 lb (19.88 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and 20 psig pressure. The pressure was then decreased to 0 psig at a rate of 3 psig/minute. The temperature of the reaction mixture was then increased to 270° C. and the pressure was decreased to 90 mm of Hg. After a 1 hour hold time at 270° C. and 90 mm of Hg, the agitator speed was decreased to 15 RPM, the reaction mixture temperature was increased to 290° C., and the pressure was decreased to 4 mm of Hg. The reaction mixture was held at 290° C. and at a pressure of 4 mm of Hg for 30 minutes. The pressure of the pressure vessel was then increased to 1 atmosphere using nitrogen gas. The molten polymer was then extruded from the pressure vessel. The cooled, extruded polymer was ground to pass a 6-mm screen. The polymer had an inherent viscosity of 0.531 dL/g and a Tg of 105° C. NMR analysis showed that the polymer was composed of 76.9 mol % 1,4-cyclohexane-dimethanol residues and 23.1 mol % 2,2,4,4-tetramethyl-1,3-cyclobutanediol residues. The polymer had color values of: L*=80.42, a*=−1.28, and b*=5.13.

### Example 3J

21.24 lb (49.71 gram-mol) dimethyl terephthalate, 12.61 lb (39.77 gram-mol) 1,4-cyclohexanedimethanol, and 6.30 lb (19.88 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and 20 psig pressure. The pressure was then decreased to 0 psig at a rate of 3 psig/minute. The temperature of the reaction mixture was then increased to 270° C. and the pressure was decreased to 90 mm of Hg. After a 1 hour hold time at 270° C. and 90 mm of Hg, the agitator speed was decreased to 15 RPM, the reaction mixture temperature was increased to 290° C., and the pressure was decreased to 4 mm of Hg. When the reaction mixture temperature was 290° C. and the pressure was 4 mm of Hg, the pressure of the pressure vessel was immediately increased to 1 atmosphere using nitrogen gas. The molten polymer was then extruded from the pressure vessel. The cooled, extruded polymer was ground to pass a 6-mm screen. The polymer had an inherent viscosity of 0.364 dL/g and a Tg of 98° C. NMR analysis showed that the polymer was composed of 77.5 mol % 1,4-cyclohexane-dimethanol residues and 22.5 mol % 2,2,4,4-tetramethyl-1,3-cyclobutanediol residues. The polymer had color values of: L*=77.20, a*=−1.47, and b*=4.62.

### Example 4

This example illustrates that 2,2,4,4-tetramethyl-1,3-cyclobutanediol can improve the toughness of PCT-based copolyesters (polyesters containing terephthalic acid and 1,4-cyclohexanedimethanol). Polyesters prepared in this example fall comprise more than 25 to less than 40 mol % of 2,2,4,4-tetramethyl-1,3-cyclobutanediol residues.

Copolyesters based on dimethyl terephthalate, 2,2,4,4-tetramethyl-1,3-cyclobutanediol, and 1,4-cyclohexanedimethanol (31/69 cis/trans) were prepared as described below, having the composition and properties shown on Table 4. The balance up to 100 mol % of the diol component of the polyesters in Table 4 was 1,4-cyclohexanedimethanol (31/69 cis/trans).

Materials were injection molded into both 3.2 mm and 6.4 mm thick bars and subsequently notched for Izod impact testing. The notched Izod impact strengths were obtained at 23° C. and are reported in Table 4. Density, Tg, and crystallization halftime were measured on the molded bars. Melt viscosity was measured on pellets at 290° C.

TABLE 4
Compilation of various properties for certain polyesters useful in the invention

| | | | | | Notched | Notched | | | | |
|---|---|---|---|---|---|---|---|---|---|---|
| | | | | | Izod of | Izod of | | | | |
| | | | | | 3.2 mm | 6.4 mm | | | | Melt |
| | | | | | thick | thick | | | Crystallization | Viscosity |
| | | | Pellet | Molded | bars at | bars at | Specific | | Halftime from | at 1 rad/sec |
| | TMCD | % cis | IV | Bar IV | 23° C. | 23° C. | Gravity | Tg | melt at 170° C. | at 290° C. |
| Example | mole % | TMCD | (dl/g) | (dl/g) | (J/m) | (J/m) | (g/mL) | (° C.) | (min) | (Poise) |
| A | 27 | 47.8 | 0.714 | 0.678 | 877 | 878 | 1.178 | 113 | 280 | 8312 |
| B | 31 | NA | 0.667 | 0.641 | 807 | 789 | 1.174 | 116 | 600 | 6592 |

NA = Not available

### Example 4A

21.24 lb (49.71 gram-mol) dimethyl terephthalate, 11.82 lb (37.28 gram-mol) 1,4-cyclohexanedimethanol, and 6.90 lb (21.77 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and 20 psig pressure. The pressure was then decreased to 0 psig at a rate of 3 psig/minute. The temperature of the reaction mixture was then increased to 270° C. and the pressure was decreased to 90 mm of Hg. After a 1 hour hold time at 270° C. and 90 mm of Hg, the agitator speed was decreased to 15 RPM, the reaction mixture temperature was increased to 290° C., and the pressure was decreased to <1 mm of Hg. The reaction mixture was held at 290° C. and at a pressure of <1 mm of Hg until the power draw to the agitator no longer increased (50 minutes). The pressure of the pressure vessel was then increased to 1 atmosphere using nitrogen gas. The molten polymer was then extruded from the pressure vessel. The cooled, extruded polymer was ground to pass a 6-mm screen. The polymer had an inherent viscosity of 0.714 dL/g and a Tg of 113° C. NMR analysis showed that the polymer was composed of 73.3 mol % 1,4-cyclohexane-dimethanol residues and 26.7 mol % 2,2,4,4-tetramethyl-1,3-cyclobutanediol residues.

### Example 4B

The polyester of Example 4B was prepared following a procedure similar to the one described for Example 4A. The composition and properties of this polyester are shown in Table 4.

### Example 5

This example illustrates that 2,2,4,4-tetramethyl-1,3-cyclobutanediol can improve the toughness of PCT-based copolyesters (polyesters containing terephthalic acid and 1,4-cyclohexanedimethanol). Polyesters prepared in this example comprise 2,2,4,4-tetramethyl-1,3-cyclobutanediol residues in an amount of 40 mol % or greater.

Copolyesters based on dimethyl terephthalate, 2,2,4,4-tetramethyl-1,3-cyclobutanediol, and 1,4-cyclohexanedimethanol were prepared as described below, having the composition and properties shown on Table 5. The balance up to 100 mol % of the diol component of the polyesters in Table 5 was 1,4-cyclohexanedimethanol (31/69 cis/trans).

Materials were injection molded into both 3.2 mm and 6.4 mm thick bars and subsequently notched for Izod impact testing. The notched Izod impact strengths were obtained at 23° C. and are reported in Table 5. Density, Tg, and crystallization halftime were measured on the molded bars. Melt viscosity was measured on pellets at 290° C.

TABLE 5
Compilation of various properties for certain polyesters useful in the invention

| | | | | | Notched | Notched | | | | |
|---|---|---|---|---|---|---|---|---|---|---|
| | | | | | Izod of | Izod of | | | | |
| | | | | | 3.2 mm | 6.4 mm | | | | Melt |
| | | | | | thick | thick | | | Crystallization | Viscosity |
| | | | Pellet | Molded | bars at | bars at | Specific | | Halftime from | at 1 rad/sec |
| | TMCD | % cis | IV | Bar IV | 23° C. | 23° C. | Gravity | Tg | melt at 170° C. | at 290° C. |
| Example | mole % | TMCD | (dl/g) | (dl/g) | (J/m) | (J/m) | (g/mL) | (° C.) | (min) | (Poise) |
| A | 44 | 46.2 | 0.657 | 0.626 | 727 | 734 | 1.172 | 119 | NA | 9751 |
| B | 45 | NA | 0.626 | 0.580 | 748 | 237 | 1.167 | 123 | NA | 8051 |
| C | 45 | NA | 0.582 | 0.550 | 671 | 262 | 1.167 | 125 | 19782 | 5835 |
| D | 45 | NA | 0.541 | 0.493 | 424 | 175 | 1.167 | 123 | NA | 3275 |
| E | 59 | 46.6 | 0.604 | 0.576 | 456 | 311 | 1.156 | 139 | NA | 16537 |
| F | 45 | 47.2 | 0.475 | 0.450 | 128 | 30 | 1.169 | 121 | NA | 1614 |

NA = Not available

### Example 5A

21.24 lb (49.71 gram-mol) dimethyl terephthalate, 8.84 lb (27.88 gram-mol) 1,4-cyclohexanedimethanol, and 10.08 lb (31.77 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and 20 psig pressure. The pressure was then decreased to 0 psig at a rate of 3 psig/minute. Then the agitator speed was decreased to 15 RPM, the temperature of the reaction mixture was then increased to 290° C. and the pressure was decreased to 2 mm of Hg. The reaction mixture was held at 290° C. and at a pressure of 2 mm of Hg until the power draw to the agitator no longer increased (80 minutes). The pressure of the pressure vessel was then increased to 1 atmosphere using nitrogen gas. The molten polymer was then extruded from the pressure vessel. The cooled, extruded polymer was ground to pass a 6-mm screen. The polymer had an inherent viscosity of 0.657 dL/g and a Tg of 119° C. NMR analysis showed that the polymer was composed of 56.3 mol % 1,4-cyclohexane-dimethanol residues and 43.7 mol % 2,2,4,4-tetramethyl-1,3-cyclobutanediol residues. The polymer had color values of: L*=75.04, a*=−1.82, and b*=6.72.

### Example 5B to Example 5D

The polyesters described in Example 5B to Example 5D were prepared following a procedure similar to the one described for Example 5A. The composition and properties of these polyesters are shown in Table 5.

### Example 5E

21.24 lb (49.71 gram-mol) dimethyl terephthalate, 6.43 lb (20.28 gram-mol 1,4-cyclohexanedimethanol, and 12.49 lb (39.37 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and 20 psig pressure. The pressure was then decreased to 0 psig at a rate of 3 psig/minute. Then the agitator speed was decreased to 15 RPM, the temperature of the reaction mixture was then increased to 290° C. and the pressure was decreased to 2 mm of Hg. The reaction mixture was held at 290° C. and at a pressure of <1 mm of Hg until the power draw to the agitator no longer increased (50 minutes). The pressure of the pressure vessel was then increased to 1 atmosphere using nitrogen gas. The molten polymer was then extruded from the pressure vessel. The cooled, extruded polymer was ground to pass a 6-mm screen. The polymer had an inherent viscosity of 0.604 dL/g and a Tg of 139° C. NMR analysis showed that the polymer was composed of 40.8 mol % 1,4-cyclohexanedimethanol residues and 59.2 mol % 2,2,4,4-tetramethyl-1,3-cyclobutanediol residues. The polymer had color values of: L*=80.48, a*=−1.30, and b*=6.82.

### Example 5F

21.24 lb (49.71 gram-mol) dimethyl terephthalate, 8.84 lb (27.88 gram-mol) 1,4-cyclohexanedimethanol, and 10.08 lb (31.77 gram-mol) 2,2,4,4-tetramethyl-1,3-cyclobutanediol were reacted together in the presence of 200 ppm of the catalyst butyltin tris(2-ethylhexanoate). The reaction was carried out under a nitrogen gas purge in an 18-gallon stainless steel pressure vessel fitted with a condensing column, a vacuum system, and a HELICONE-type agitator. With the agitator running at 25 RPM, the reaction mixture temperature was increased to 250° C. and the pressure was increased to 20 psig. The reaction mixture was held for 2 hours at 250° C. and 20 psig pressure. The pressure was then decreased to 0 psig at a rate of 3 psig/minute. The temperature of the reaction mixture was then increased to 270° C. and the pressure was decreased to 90 mm of Hg. After a 1 hour hold time at 270° C. and 90 mm of Hg, the agitator speed was decreased to 15 RPM and the pressure was decreased to 4 mm of Hg. When the reaction mixture temperature was 270° C. and the pressure was 4 mm of Hg, the pressure of the pressure vessel was immediately increased to 1 atmosphere using nitrogen gas. The molten polymer was then extruded from the pressure vessel. The cooled, extruded polymer was ground to pass a 6-mm screen. The polymer had an inherent viscosity of 0.475 dL/g and a Tg of 121° C. NMR analysis showed that the polymer was composed of 55.5 mol % 1,4-cyclohexane-dimethanol residues and 44.5 mol % 2,2,4,4-tetramethyl-1,3-cyclobutanediol residues. The polymer had color values of: L*=85.63, a*=−0.88, and b*=4.34.

### Example 6

### Comparative Example

This example shows data for comparative materials in Table 6. The PC was Makrolon 2608 from Bayer, with a nominal composition of 100 mole % bisphenol A residues and 100 mole % diphenyl carbonate residues. Makrolon 2608 has a nominal melt flow rate of 20 grams/10 minutes measured at 300 C using a 1.2 kg weight. The PET was Eastar 9921 from Eastman Chemical Company, with a nominal composition of 100 mole % terephthalic acid, 3.5 mole % cyclohexanedimethanol (CHDM) and 96.5 mole % ethylene glycol. The PETG was Eastar 6763 from Eastman Chemical Company, with a nominal composition of 100 mole % terephthalic acid, 31 mole % cyclohexanedimethanol (CHDM) and 69 mole % ethylene glycol. The PCTG was Eastar DN001 from Eastman Chemical Company, with a nominal composition of 100 mole % terephthalic acid, 62 mole % cyclohexanedimethanol (CHDM) and 38 mole % ethylene glycol. The PCTA was Eastar AN001 from Eastman Chemical Company, with a nominal composition of 65 mole % terephthalic acid, 35 mole % isophthalic acid and 100 mole % cyclohexanedimethanol (CHDM). The Polysulfone was Udel 1700 from Solvay, with a nominal composition of 100 mole % bisphenol A residues and 100 mole % 4,4-dichlorosulfonyl sulfone residues. Udel 1700 has a nominal melt flow rate of 6.5 grams/10 minutes measured at 343 C using a 2.16 kg weight. The SAN was Lustran 31 from Lanxess, with a nominal composition of 76 weight % styrene and 24 weight % acrylonitrile. Lustran 31 has a nominal melt flow rate of 7.5 grams/10 minutes measured at 230 C using a 3.8 kg weight. The examples of the invention show improved toughness in 6.4 mm thickness bars compared to all of the other resins.

TABLE 6
Compilation of various properties for certain commercial polymers

| | | | | Notched | Notched | | | |
|---|---|---|---|---|---|---|---|---|
| | | | | Izod of | Izod of | | | |
| | | | | 3.2 mm | 6.4 mm | | | Crystallization |
| | | Pellet | Molded | thick bars | thick bars | Specific | | Halftime from |
| | Polymer | IV | Bar IV | at 23° C. | at 23° C. | Gravity | Tg | melt |
| Example | name | (dl/g) | (dl/g) | (J/m) | (J/m) | (g/mL) | (° C.) | (min) |
| A | PC | 12 MFR | NA | 929 | 108 | 1.20 | 146 | NA |
| B | PCTG | 0.73 | 0.696 | NB | 70 | 1.23 | 87 | 30 at 170° C. |
| C | PCTA | 0.72 | 0.702 | 98 | 59 | 1.20 | 87 | 15 at 150° C. |
| D | PETG | 0.75 | 0.692 | 83 | 59 | 1.27 | 80 | 2500 at 130° C. |
| E | PET | 0.76 | 0.726 | 45 | 48 | 1.33 | 78 | 1.5 at 170° C. |
| F | SAN | 7.5 MFR | NA | 21 | NA | 1.07 | ˜110 | NA |
| G | PSU | 6.5 MFR | NA | 69 | NA | 1.24 | ˜190 | NA |

NA = Not available

### Example 7

This example illustrates the effect of the amount of 2,2,4,4-tetramethyl-1,3-cyclobutanediol used for the preparation of the polyesters of the invention on the glass transition temperature of the polyesters. Polyesters prepared in this example comprise from 15 to 25 mol % of 2,2,4,4-tetramethyl-1,3-cyclobutanediol residues.

### Example 7A to Example 7G

Dimethyl terephthalate, 1,4-cyclohexanedimethanol, and 2,2,4,4-tetramethyl-1,3-cyclobutanediol were weighed into a 500-ml single neck round bottom flask. NMR analysis on the 2,2,4,4-tetramethyl-1,3-cyclobutanediol starting material showed a cis/trans ratio of 53/47. The polyesters of this example were prepared with a 1.2/1 glycol/acid ratio with the entire excess coming from the 2,2,4,4-tetramethyl-1,3-cyclobutanediol. Enough dibutyltin oxide catalyst was added to give 300 ppm tin in the final polymer. The flask was under a 0.2 SCFC nitrogen purge with vacuum reduction capability. The flask was immersed in a Belmont metal bath at 200° C. and stirred at 200 RPM after the reactants had melted. After about 2.5 hours, the temperature was raised to 210° C. and these conditions were held for an additional 2 hours. The temperature was raised to 285° C. (in approximately 25 minutes) and the pressure was reduced to 0.3 mm of Hg over a period of 5 minutes. The stirring was reduced as the viscosity increased, with 15 RPM being the minimum stirring used. The total polymerization time was varied to attain the target inherent viscosities. After the polymerization was complete, the Belmont metal bath was lowered and the polymer was allowed to cool to below its glass transition temperature. After about 30 minutes, the flask was reimmersed in the Belmont metal bath (the temperature had been increased to 295° C. during this 30 minute wait) and the polymer mass was heated until it pulled away from the glass flask. The polymer mass was stirred at mid level in the flask until the polymer had cooled. The polymer was removed from the flask and ground to pass a 3 mm screen. Variations to this procedure were made to produce the copolyesters described below with a targeted composition of 20 mol %.

Inherent viscosities were measured as described in the “Measurement Methods” section above. The compositions of the polyesters were determined by ¹H NMR as explained before in the Measurement Methods section. The glass transition temperatures were determined by DSC, using the second heat after quench at a rate of 20° C./min.

### Example 7H to Example 7Q

These polyesters were prepared by carrying out the ester exchange and polycondensation reactions in separate stages. The ester exchange experiments were conducted in a continuous temperature rise (CTR) reactor. The CTR was a 3000 ml glass reactor equipped with a single shaft impeller blade agitator, covered with an electric heating mantle and fitted with a heated packed reflux condenser column. The reactor was charged with 777 g (4 moles) of dimethyl terephthalate, 230 g (1.6 moles) of 2,2,4,4-tetramethyl-1,3,-cyclobutanediol, 460.8 g (3.2 moles) of cyclohexanedimethanol and 1.12 g of butyltin tris-2-ethylhexanoate (such that there will be 200 ppm tin metal in the final polymer). The heating mantle was set manually to 100% output. The set points and data collection were facilitated by a Camile process control system. Once the reactants were melted, stirring was initiated and slowly increased to 250 rpm. The temperature of the reactor gradually increased with run time. The weight of methanol collected was recorded via balance. The reaction was stopped when methanol evolution stopped or at a pre-selected lower temperature of 260° C. The oligomer was discharged with a nitrogen purge and cooled to room temperature. The oligomer was frozen with liquid nitrogen and broken into pieces small enough to be weighed into a 500 ml round bottom flask.

In the polycondensation reactions, a 500 ml round bottom flask was charged with approximately 150 g of the oligomer prepared above. The flask was equipped with a stainless steel stirrer and polymer head. The glassware was set up on a half mole polymer rig and the Camile sequence was initiated. The stirrer was positioned one full turn from the flask bottom once the oligomer melted. The temperature/pressure/stir rate sequence controlled by the Camile software for each example is reported in the following tables.

Camile Sequence for Example 7H and Example 7I

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 290 | 90 | 50 |
| 6 | 5 | 290 | 6 | 25 |
| 7 | 110 | 290 | 6 | 25 |

Camile Sequence for Example 7N to Example 7Q

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 290 | 90 | 50 |
| 6 | 5 | 290 | 3 | 25 |
| 7 | 110 | 290 | 3 | 25 |

Camile Sequence for Example 7K and Example 7L

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 290 | 90 | 50 |
| 6 | 5 | 290 | 2 | 25 |
| 7 | 110 | 290 | 2 | 25 |

Camile Sequence for Example 7J and Example 7M

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 290 | 90 | 50 |
| 6 | 5 | 290 | 1 | 25 |
| 7 | 110 | 290 | 1 | 25 |

The resulting polymers were recovered from the flask, chopped using a hydraulic chopper, and ground to a 6 mm screen size. Samples of each ground polymer were submitted for inherent viscosity in 60/40 (wt/wt) phenol/tetrachloroethane at a concentration of 0.5 g/100 ml at 25° C., catalyst level (Sn) by x-ray fluorescence, and color (L*, a*, b*) by transmission spectroscopy. Polymer composition was obtained by ¹H NMR. Samples were submitted for thermal stability and melt viscosity testing using a Rheometrics Mechanical Spectrometer (RMS-800).

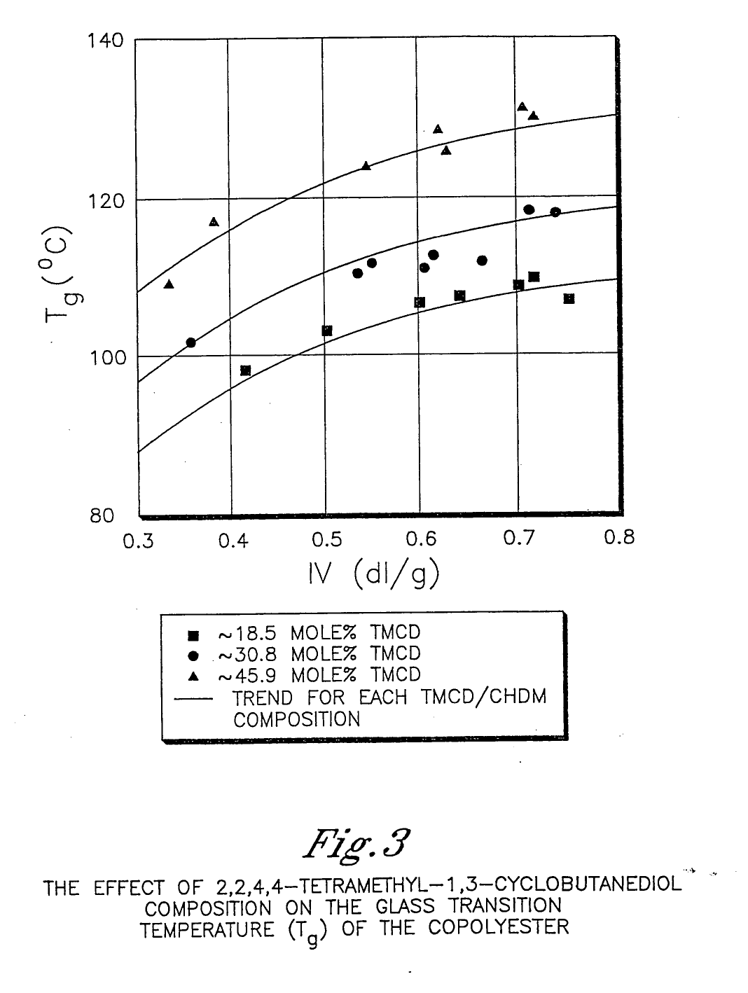

The table below shows the experimental data for the polyesters of this example. The data shows that an increase in the level of 2,2,4,4-tetramethyl-1,3-cyclobutanediol raises the glass transition temperature in an almost linear fashion, for a constant inherent viscosity. FIG. 3 also shows the dependence of Tg on composition and inherent viscosity.

TABLE 7
Glass transition temperature as a function of inherent viscosity and composition

| | | % cis | | | \acute{η}ₒ at 260° C. | \acute{η}ₒ at 275° C. | \acute{η}ₒ at 290° C. |
|---|---|---|---|---|---|---|---|
| Example | mol % TMCD | TMCD | IV (dL/g) | T_{g} (° C.) | (Poise) | (Poise) | (Poise) |
| A | 20 | 51.4 | 0.72 | 109 | 11356 | 19503 | 5527 |
| B | 19.1 | 51.4 | 0.60 | 106 | 6891 | 3937 | 2051 |
| C | 19 | 53.2 | 0.64 | 107 | 8072 | 4745 | 2686 |
| D | 18.8 | 54.4 | 0.70 | 108 | 14937 | 8774 | 4610 |
| E | 17.8 | 52.4 | 0.50 | 103 | 3563 | 1225 | 883 |
| F | 17.5 | 51.9 | 0.75 | 107 | 21160 | 10877 | 5256 |
| G | 17.5 | 52 | 0.42 | 98 | NA | NA | NA |
| H | 22.8 | 53.5 | 0.69 | 109 | NA | NA | NA |
| I | 22.7 | 52.2 | 0.68 | 108 | NA | NA | NA |
| J | 23.4 | 52.4 | 0.73 | 111 | NA | NA | NA |
| K | 23.3 | 52.9 | 0.71 | 111 | NA | NA | NA |
| L | 23.3 | 52.4 | 0.74 | 112 | NA | NA | NA |
| M | 23.2 | 52.5 | 0.74 | 112 | NA | NA | NA |
| N | 23.1 | 52.5 | 0.71 | 111 | NA | NA | NA |
| O | 22.8 | 52.4 | 0.73 | 112 | NA | NA | NA |
| P | 22.7 | 53 | 0.69 | 112 | NA | NA | NA |
| Q | 22.7 | 52 | 0.70 | 111 | NA | NA | NA |

NA = Not available

### Example 8

This example illustrates the effect of the amount of 2,2,4,4-tetramethyl-1,3-cyclobutanediol used for the preparation of the polyesters of the invention on the glass transition temperature of the polyesters. Polyesters prepared in this example fall comprise more than 25 to less than 40 mol % of 2,2,4,4-tetramethyl-1,3-cyclobutanediol residues.

Dimethyl terephthalate, 1,4-cyclohexanedimethanol, and 2,2,4,4-tetramethyl-1,3-cyclobutanediol were weighed into a 500-ml single neck round bottom flask. NMR analysis on the 2,2,4,4-tetramethyl-1,3-cyclobutanediol starting material showed a cis/trans ratio of 53/47. The polyesters of this example were prepared with a 1.2/1 glycol/acid ratio with the entire excess coming from the 2,2,4,4-tetramethyl-1,3-cyclobutanediol. Enough dibutyltin oxide catalyst was added to give 300 ppm tin in the final polymer. The flask was under a 0.2 SCFC nitrogen purge with vacuum reduction capability. The flask was immersed in a Belmont metal bath at 200° C. and stirred at 200 RPM after the reactants had melted. After about 2.5 hours, the temperature was raised to 210° C. and these conditions were held for an additional 2 hours. The temperature was raised to 285° C. (in approximately 25 minutes) and the pressure was reduced to 0.3 mm of Hg over a period of 5 minutes. The stirring was reduced as the viscosity increased, with 15 RPM being the minimum stirring used. The total polymerization time was varied to attain the target inherent viscosities. After the polymerization was complete, the Belmont metal bath was lowered and the polymer was allowed to cool to below its glass transition temperature. After about 30 minutes, the flask was reimmersed in the Belmont metal bath (the temperature had been increased to 295° C. during this 30 minute wait) and the polymer mass was heated until it pulled away from the glass flask. The polymer mass was stirred at mid level in the flask until the polymer had cooled. The polymer was removed from the flask and ground to pass a 3 mm screen. Variations to this procedure were made to produce the copolyesters described below with a targeted composition of 32 mol %.

Inherent viscosities were measured as described in the “Measurement Methods” section above. The compositions of the polyesters were determined by ¹H NMR as explained before in the Measurement Methods section. The glass transition temperatures were determined by DSC, using the second heat after quench at a rate of 20° C./min.

The table below shows the experimental data for the polyesters of this example. FIG. 3 also shows the dependence of Tg on composition and inherent viscosity. The data shows that an increase in the level of 2,2,4,4-tetramethyl-1,3-cyclobutanediol raises the glass transition temperature in an almost linear fashion, for a constant inherent viscosity.

TABLE 8
Glass transition temperature as a function of inherent viscosity and composition

| | | % cis | | | \acute{η}ₒ at 260° C. | \acute{η}ₒ at 275° C. | \acute{η}ₒ at 290° C. |
|---|---|---|---|---|---|---|---|
| Example | mol % TMCD | TMCD | IV (dL/g) | T_{g} (° C.) | (Poise) | (Poise) | (Poise) |
| A | 32.2 | 51.9 | 0.71 | 118 | 29685 | 16074 | 8522 |
| B | 31.6 | 51.5 | 0.55 | 112 | 5195 | 2899 | 2088 |
| C | 31.5 | 50.8 | 0.62 | 112 | 8192 | 4133 | 2258 |
| D | 30.7 | 50.7 | 0.54 | 111 | 4345 | 2434 | 1154 |
| E | 30.3 | 51.2 | 0.61 | 111 | 7929 | 4383 | 2261 |
| F | 30.0 | 51.4 | 0.74 | 117 | 31476 | 17864 | 8630 |
| G | 29.0 | 51.5 | 0.67 | 112 | 16322 | 8787 | 4355 |
| H | 31.1 | 51.4 | 0.35 | 102 | NA | NA | NA |

NA = Not available

### Example 9

This example illustrates the effect of the amount of 2,2,4,4-tetramethyl-1,3-cyclobutanediol used for the preparation of the polyesters of the invention on the glass transition temperature of the polyesters. Polyesters prepared in this example comprise 2,2,4,4-tetramethyl-1,3-cyclobutanediol residues in an amount of 40 mol % or greater.

### Examples A to AC

These polyesters were prepared by carrying out the ester exchange and polycondensation reactions in separate stages. The ester exchange experiments were conducted in a continuous temperature rise (CTR) reactor. The CTR was a 3000 ml glass reactor equipped with a single shaft impeller blade agitator, covered with an electric heating mantle and fitted with a heated packed reflux condenser column. The reactor was charged with 777 g of dimethyl terephthalate, 375 g of 2,2,4,4-tetramethyl-1,3,-cyclobutanediol, 317 g of cyclohexanedimethanol and 1.12 g of butyltin tris-2-ethylhexanoate (such that there will be 200 ppm tin metal in the final polymer). The heating mantle was set manually to 100% output. The set points and data collection were facilitated by a Camile process control system. Once the reactants were melted, stirring was initiated and slowly increased to 250 rpm. The temperature of the reactor gradually increased with run time. The weight of methanol collected was recorded via balance. The reaction was stopped when methanol evolution stopped or at a pre-selected lower temperature of 260° C. The oligomer was discharged with a nitrogen purge and cooled to room temperature. The oligomer was frozen with liquid nitrogen and broken into pieces small enough to be weighed into a 500 ml round bottom flask.

In the polycondensation reactions, a 500 ml round bottom flask was charged with 150 g of the oligomer prepared above. The flask was equipped with a stainless steel stirrer and polymer head. The glassware was set up on a half mole polymer rig and the Camile sequence was initiated. The stirrer was positioned one full turn from the flask bottom once the oligomer melted. The temperature/pressure/stir rate sequence controlled by the Camile software for these examples is reported in the following table, unless otherwise specified below.

### Camile Sequence for Polycondensation Reactions

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 290 | 90 | 50 |
| 6 | 5 | 290 | 6 | 25 |
| 7 | 110 | 290 | 6 | 25 |

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 290 | 90 | 50 |
| 6 | 5 | 290 | 6 | 25 |
| 7 | 110 | 290 | 6 | 25 |

For Examples B, D, F, the same sequence in the preceding table was used, except the time was 80 min in Stage 7. For Examples G and J, the same sequence in the preceding table was used, except the time was 50 min in Stage 7. For Example L, the same sequence in the preceding table was used, except the time was 140 min in Stage 7.

Camile Sequence for Example E

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 300 | 90 | 50 |
| 6 | 5 | 300 | 7 | 25 |
| 7 | 110 | 300 | 7 | 25 |

For Example I, the same sequence in the preceding table was used, except the vacuum was 8 torr in Stages 6 and 7. For Example 0, the same sequence in the preceding table was used, except the vacuum was 6 torr in Stage 6 and 7. For Example P, the same sequence in the preceding table was used, except the vacuum was 4 torr in Stages 6 and 7. For Example Q, the same sequence in the preceding table was used, except the vacuum was 5 torr in Stages 6 and 7.

Camile Sequence for Example H

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 280 | 90 | 50 |
| 6 | 5 | 280 | 5 | 25 |
| 7 | 110 | 280 | 5 | 25 |

For Example U and M, the same sequence in the preceding table was used, except the vacuum was 6 torr in Stages 6 and 7. For Example V and X, the same sequence in the preceding table was used, except the vacuum was 6 torr and stir rate was 15 rpm in Stages 6 and 7. For Example Z, the same sequence in the preceding table was used, except the stir rate was 15 rpm in Stages 6 and 7.

Camile Sequence for Example K

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 300 | 90 | 50 |
| 6 | 5 | 300 | 6 | 15 |
| 7 | 110 | 300 | 6 | 15 |

For Example M, the same sequence in the preceding table was used, except the vacuum was 8 torr in Stages 6 and 7. For Example N, the same sequence in the preceding table was used, except the vacuum was 7 torr in Stages 6 and 7.

Camile Sequence for Examples S and T

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 5 | 290 | 6 | 25 |
| 5 | 110 | 290 | 6 | 25 |

The resulting polymers were recovered from the flask, chopped using a hydraulic chopper, and ground to a 6 mm screen size. Samples of each ground polymer were submitted for inherent viscosity in 60/40 (wt/wt) phenol/tetrachloroethane at a concentration of 0.5 g/100 ml at 25° C., catalyst level (Sn) by x-ray fluorescence, and color (L*, a*, b*) by transmission spectroscopy. Polymer composition was obtained by ¹H NMR. Samples were submitted for thermal stability and melt viscosity testing using a Rheometrics Mechanical Spectrometer (RMS-800).

### Examples AD to AK and AT

The polyesters of these examples were prepared as described above for Examples A to AC, except that the target tin amount in the final polymer was 150 ppm for examples AD to AK and AT. The following tables described the temperature/pressure/stir rate sequences controlled by the Camile software for these examples.

Camile Sequence for Examples AD, AF, and AH

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 400 | 50 |
| 5 | 110 | 290 | 400 | 50 |
| 6 | 5 | 290 | 8 | 50 |
| 7 | 110 | 295 | 8 | 50 |

For Example AD, the stirrer was turned to 25 rpm with 95 min left in Stage 7.

Camile Sequence for Example AE

| | Time | Temp | Vacuum | Stir |
|---|---|---|---|---|
| Stage | (min) | (° C.) | (torr) | (rpm) |
| 1 | 10 | 245 | 760 | 0 |
| 2 | 5 | 245 | 760 | 50 |
| 3 | 30 | 283 | 760 | 50 |
| 4 | 3 | 283 | 175 | 50 |
| 5 | 5 | 283 | 5 | 50 |
| 6 | 5 | 283 | 1.2 | 50 |
| 7 | 71 | 285 | 1.2 | 50 |

2. For Example AK, the same sequence in the preceding table was used, except the time was 75 min in Stage 7.

Camile Sequence for Example AG

| | Time | Temp | Vacuum | Stir |
|---|---|---|---|---|
| Stage | (min) | (° C.) | (torr) | (rpm) |
| 1 | 10 | 245 | 760 | 0 |
| 2 | 5 | 245 | 760 | 50 |
| 3 | 30 | 285 | 760 | 50 |
| 4 | 3 | 285 | 175 | 50 |
| 5 | 5 | 285 | 5 | 50 |
| 6 | 5 | 285 | 4 | 50 |
| 7 | 220 | 290 | 4 | 50 |

Camile Sequence for Example AI

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 285 | 90 | 50 |
| 6 | 5 | 285 | 6 | 50 |
| 7 | 70 | 290 | 6 | 50 |

Camile Sequence for Example AJ

| | Time | Temp | Vacuum | Stir |
|---|---|---|---|---|
| Stage | (min) | (° C.) | (torr) | (rpm) |
| 1 | 5 | 245 | 760 | 0 |
| 2 | 5 | 245 | 760 | 50 |
| 3 | 30 | 265 | 760 | 50 |
| 4 | 3 | 265 | 90 | 50 |
| 5 | 110 | 290 | 90 | 50 |
| 6 | 5 | 290 | 6 | 25 |
| 7 | 110 | 295 | 6 | 25 |

### Examples AL to AS

Dimethyl terephthalate, 1,4-cyclohexanedimethanol, and 2,2,4,4-tetramethyl-1,3-cyclobutanediol were weighed into a 500-ml single neck round bottom flask. The polyesters of this example were prepared with a 1.2/1 glycol/acid ratio with the entire excess coming from the 2,2,4,4-tetramethyl-1,3-cyclobutanediol. Enough dibutyltin oxide catalyst was added to give 300 ppm tin in the final polymer. The flask was under a 0.2 SCFC nitrogen purge with vacuum reduction capability. The flask was immersed in a Belmont metal bath at 200° C. and stirred at 200 RPM after the reactants had melted. After about 2.5 hours, the temperature was raised to 210° C. and these conditions were held for an additional 2 hours. The temperature was raised to 285° C. (in approximately 25 minutes) and the pressure was reduced to 0.3 mm of Hg over a period of 5 minutes. The stirring was reduced as the viscosity increased, with 15 RPM being the minimum stirring used. The total polymerization time was varied to attain the target inherent viscosities. After the polymerization was complete, the Belmont metal inherent was lowered and the polymer was allowed to cool to below its glass transition temperature. After about 30 minutes, the flask was reimmersed in the Belmont metal bath (the temperature had been increased to 295° C. during this 30 minute wait) and the polymer mass was heated until it pulled away from the glass flask. The polymer mass was stirred at mid level in the flask until the polymer had cooled. The polymer was removed from the flask and ground to pass a 3 mm screen. Variations to this procedure were made to produce the copolyesters described below with a targeted composition of 45 mol %.

Inherent viscosities were measured as described in the “Measurement Methods” section above. The compositions of the polyesters were determined by ¹H NMR as explained before in the Measurement Methods section. The glass transition temperatures were determined by DSC, using the second heat after quench at a rate of 20° C./min.

The table below shows the experimental data for the polyesters of this example. The data shows that an increase in the level of 2,2,4,4-tetramethyl-1,3-cyclobutanediol raises the glass transition temperature in an almost linear fashion, for a constant inherent viscosity. FIG. 3 also shows the dependence of Tg on composition and inherent viscosity.

TABLE 9
Glass transition temperature as a function of inherent viscosity and composition

| | | | | | | \acute{η}ₒ at | |
|---|---|---|---|---|---|---|---|
| | mol % | % cis | | | \acute{η}ₒ at 260° C. | 275° C. | _{\acute{η}o} at 290° C. |
| Example | TMCD | TMCD | IV (dL/g) | T_{g} (° C.) | (Poise) | (Poise) | (Poise) |
| A | 43.9 | 72.1 | 0.46 | 131 | NA | NA | NA |
| B | 44.2 | 36.4 | 0.49 | 118 | NA | NA | NA |
| C | 44 | 71.7 | 0.49 | 128 | NA | NA | NA |
| D | 44.3 | 36.3 | 0.51 | 119 | NA | NA | NA |
| E | 46.1 | 46.8 | 0.51 | 125 | NA | NA | NA |
| F | 43.6 | 72.1 | 0.52 | 128 | NA | NA | NA |
| G | 43.6 | 72.3 | 0.54 | 127 | NA | NA | NA |
| H | 46.4 | 46.4 | 0.54 | 127 | NA | NA | NA |
| I | 45.7 | 47.1 | 0.55 | 125 | NA | NA | NA |
| J | 44.4 | 35.6 | 0.55 | 118 | NA | NA | NA |
| K | 45.2 | 46.8 | 0.56 | 124 | NA | NA | NA |
| L | 43.8 | 72.2 | 0.56 | 129 | NA | NA | NA |
| M | 45.8 | 46.4 | 0.56 | 124 | NA | NA | NA |
| N | 45.1 | 47.0 | 0.57 | 125 | NA | NA | NA |
| O | 45.2 | 46.8 | 0.57 | 124 | NA | NA | NA |
| P | 45 | 46.7 | 0.57 | 125 | NA | NA | NA |
| Q | 45.1 | 47.1 | 0.58 | 127 | NA | NA | NA |
| R | 44.7 | 35.4 | 0.59 | 123 | NA | NA | NA |
| S | 46.1 | 46.4 | 0.60 | 127 | NA | NA | NA |
| T | 45.7 | 46.8 | 0.60 | 129 | NA | NA | NA |
| U | 46 | 46.3 | 0.62 | 128 | NA | NA | NA |
| V | 45.9 | 46.3 | 0.62 | 128 | NA | NA | NA |
| X | 45.8 | 46.1 | 0.63 | 128 | NA | NA | NA |
| Y | 45.6 | 50.7 | 0.63 | 128 | NA | NA | NA |
| Z | 46.2 | 46.8 | 0.65 | 129 | NA | NA | NA |
| AA | 45.9 | 46.2 | 0.66 | 128 | NA | NA | NA |
| AB | 45.2 | 46.4 | 0.66 | 128 | NA | NA | NA |
| AC | 45.1 | 46.5 | 0.68 | 129 | NA | NA | NA |
| AD | 46.3 | 52.4 | 0.52 | NA | NA | NA | NA |
| AE | 45.7 | 50.9 | 0.54 | NA | NA | NA | NA |
| AF | 46.3 | 52.6 | 0.56 | NA | NA | NA | NA |
| AG | 46 | 50.6 | 0.56 | NA | NA | NA | NA |
| AH | 46.5 | 51.8 | 0.57 | NA | NA | NA | NA |
| AI | 45.6 | 51.2 | 0.58 | NA | NA | NA | NA |
| AJ | 46 | 51.9 | 0.58 | NA | NA | NA | NA |
| AK | 45.5 | 51.2 | 0.59 | NA | NA | NA | NA |
| AL | 45.8 | 50.1 | 0.624 | 125 | NA | NA | 7696 |
| AM | 45.7 | 49.4 | 0.619 | 128 | NA | NA | 7209 |
| AN | 46.2 | 49.3 | 0.548 | 124 | NA | NA | 2348 |
| AP | 45.9 | 49.5 | 0.72 | 128 | 76600 | 40260 | 19110 |
| AQ | 46.0 | 50 | 0.71 | 131 | 68310 | 32480 | 17817 |
| AR | 46.1 | 49.6 | 0.383 | 117 | NA | NA | 387 |
| AS | 45.6 | 50.5 | 0.325 | 108 | NA | NA | NA |
| AT | 47.2 | NA | 0.48 | NA | NA | NA | NA |

NA = Not available

### Example 10

This example illustrates the effect of the predominance of the type of 2,2,4,4-tetramethyl-1,3-cyclobutanediol isomer (cis or trans) on the glass transition temperature of the polyester.

Dimethyl terephthalate, 1,4-cyclohexanedimethanol, and 2,2,4,4-tetramethyl-1,3-cyclobutanediol were weighed into a 500-ml single neck round bottom flask. The polyesters of this example were prepared with a 1.2/1 glycol/acid ratio with the entire excess coming from the 2,2,4,4-tetramethyl-1,3-cyclobutanediol. Enough dibutyltin oxide catalyst was added to give 300 ppm tin in the final polymer. The flask was under a 0.2 SCFC nitrogen purge with vacuum reduction capability. The flask was immersed in a Belmont metal bath at 200° C. and stirred at 200 RPM after the reactants had melted. After about 2.5 hours, the temperature was raised to 210° C. and these conditions were held for an additional 2 hours. The temperature was raised to 285° C. (in approximately 25 minutes) and the pressure was reduced to 0.3 mm of Hg over a period of 5 minutes. The stirring was reduced as the viscosity increased, with 15 RPM being the minimum stirring used. The total polymerization time was varied to attain the target inherent viscosities. After the polymerization was complete, the Belmont metal bath was lowered and the polymer was allowed to cool to below its glass transition temperature. After about 30 minutes, the flask was reimmersed in the Belmont metal bath (the temperature had been increased to 295° C. during this 30 minute wait) and the polymer mass was heated until it pulled away from the glass flask. The polymer mass was stirred at mid level in the flask until the polymer had cooled. The polymer was removed from the flask and ground to pass a 3 mm screen. Variations to this procedure were made to produce the copolyesters described below with a targeted composition of 45 mol %.

Inherent viscosities were measured as described in the “Measurement Methods” section above. The compositions of the polyesters were determined by ¹H NMR as explained before in the Measurement Methods section. The glass transition temperatures were determined by DSC, using the second heat after quench at a rate of 20° C./min.

The table below shows the experimental data for the polyesters of this Example. The data shows that cis 2,2,4,4-tetramethyl-1,3-cyclobutanediol is approximately twice as effective as trans 2,2,4,4-tetramethyl-1,3-cyclobutanediol at increasing the glass transition temperature for a constant inherent viscosity.

TABLE 10
Effect of 2,2,4,4-tetramethyl-1,3-cyclobutanediol
cis/trans composition on T_{g}

| Ex- | | | | ηₒ at | ηₒ at | ηₒ at | |
|---|---|---|---|---|---|---|---|
| am- | mol % | IV | T_{g} | 260° C. | 275° C. | 290° C. | % cis |
| ple | TMCD | (dL/g) | (° C.) | (Poise) | (Poise) | (Poise) | TMCD |
| A | 45.8 | 0.71 | 119 | N.A. | N.A. | N.A. | 4.1 |
| B | 43.2 | 0.72 | 122 | N.A. | N.A. | N.A. | 22.0 |
| C | 46.8 | 0.57 | 119 | 26306 | 16941 | 6601 | 22.8 |
| D | 43.0 | 0.67 | 125 | 55060 | 36747 | 14410 | 23.8 |
| E | 43.8 | 0.72 | 127 | 101000 | 62750 | 25330 | 24.5 |
| F | 45.9 | 0.533 | 119 | 11474 | 6864 | 2806 | 26.4 |
| G | 45.0 | 0.35 | 107 | N.A. | N.A. | N.A. | 27.2 |
| H | 41.2 | 0.38 | 106 | 1214 | 757 | N.A. | 29.0 |
| I | 44.7 | 0.59 | 123 | N.A. | N.A. | N.A. | 35.4 |
| J | 44.4 | 0.55 | 118 | N.A. | N.A. | N.A. | 35.6 |
| K | 44.3 | 0.51 | 119 | N.A. | N.A. | N.A. | 36.3 |
| L | 44.0 | 0.49 | 128 | N.A. | N.A. | N.A. | 71.7 |
| M | 43.6 | 0.52 | 128 | N.A. | N.A. | N.A. | 72.1 |
| N | 43.6 | 0.54 | 127 | N.A. | N.A. | N.A. | 72.3 |
| O | 41.5 | 0.58 | 133 | 15419 | 10253 | 4252 | 88.7 |
| P | 43.8 | 0.57 | 135 | 16219 | 10226 | 4235 | 89.6 |
| Q | 41.0 | 0.33 | 120 | 521 | 351 | 2261 | 90.4 |
| R | 43.0 | 0.56 | 134 | N.A. | N.A. | N.A. | 90.6 |
| S | 43.0 | 0.49 | 132 | 7055 | 4620 | 2120 | 90.6 |
| T | 43.1 | 0.55 | 134 | 12970 | 8443 | 3531 | 91.2 |
| U | 45.9 | 0.52 | 137 | N.A. | N.A. | N.A. | 98.1 |

NA = not available

### Example 11

This example illustrates the preparation of a copolyester containing 100 mol % dimethyl terephthalate residues, 55 mol % 1,4-cyclohexanedimethanol residues, and 45 mol % 2,2,4,4-tetramethyl-1,3-cyclobutanediol residues.

A mixture of 97.10 g (0.5 mol) dimethyl terephthalate, 52.46 g (0.36 mol) 1,4-cyclohexanedimethanol, 34.07 g (0.24 mol) 2,2,4,4-tetramethyl-1,3-cyclobutanediol, and 0.0863 g (300 ppm) dibutyl tin oxide was placed in a 500-milliliter flask equipped with an inlet for nitrogen, a metal stirrer, and a short distillation column. The flask was placed in a Wood's metal bath already heated to 200° C. The contents of the flask were heated at 200° C. for 1 hour and then the temperature was increased to 210° C. The reaction mixture was held at 210° C. for 2 hours and then heated up to 290° C. in 30 minutes. Once at 290° C., a vacuum of 0.01 psig was gradually applied over the next 3 to 5 minutes. Full vacuum (0.01 psig) was maintained for a total time of about 45 minutes to remove excess unreacted diols. A high melt viscosity, visually clear and colorless polymer was obtained with a glass transition temperature of 125° C. and an inherent viscosity of 0.64 dl/g.

### Example 12

### Comparative Example

This example illustrates that a polyester based on 100% 2,2,4,4-tetramethyl-1,3-cyclobutanediol has a slow crystallization half-time.

A polyester based solely on terephthalic acid and 2,2,4,4-tetramethyl-1,3-cyclobutanediol was prepared in a method similar to the method described in Example 1A with the properties shown on Table 11. This polyester was made with 300 ppm dibutyl tin oxide. The trans/cis ratio of the 2,2,4,4-tetramethyl-1,3-cyclobutanediol was 65/35.

Films were pressed from the ground polymer at 320° C. Crystallization half-time measurements from the melt were made at temperatures from 220 to 250° C. at 10° C. increments and are reported in Table 11. The fastest crystallization half-time for the sample was taken as the minimum value of crystallization half-time as a function of temperature. The fastest crystallization half-time of this polyester is around 1300 minutes. This value contrasts with the fact that the polyester (PCT) based solely on terephthalic acid and 1,4-cyclohexanedimethanol (no comonomer modification) has an extremely short crystallization half-time (<1 min) as shown in FIG. 1.

TABLE 11
Crystallization Half-times (min)

| | | | | at | at | at | at |
|---|---|---|---|---|---|---|---|
| Comonomer | | | | 220° C. | 230° C. | 240° C. | 250° C. |
| (mol %) | IV (dl/g) | T_{g} (° C.) | Tₘₐₓ (° C.) | (min) | (min) | (min) | (min) |
| 100 mol % F | 0.63 | 170.0 | 330 | 3291 | 3066 | 1303 | 1888 |

where: F is 2,2,4,4-Tetramethyl-1,3-cyclobutanediol (65/35 Trans/Cis)

where: F is 2,2,4,4-Tetramethyl-1,3-cyclobutanediol (65/35 Trans/Cis)

### Example 13

Sheets comprising a polyester that had been prepared with a target composition of 100 mole % terephthalic acid residues, 80 mole % 1,4-cyclohexanedimethanol residues, and 20 mole % 2,2,4,4-tetramethyl-1,3-cyclobutanediol residues were produced using a 3.5 inch single screw extruder. A sheet was extruded continuously, gauged to a thickness of 177 mil and then various sheets were sheared to size. Inherent viscosity and glass transition temperature were measured on one sheet. The sheet inherent viscosity was measured to be 0.69 dL/g. The glass transition temperature of the sheet was measured to be 106° C. Sheets were then conditioned at 50% relative humidity and 60° C. for 2 weeks. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example G). The thermoformed part was visually inspected for any blisters and the degree of blistering rated as none (N), low (L), or high (H). The results below demonstrate that these thermoplastic sheets with a glass transition temperature of 106° C. can be thermoformed under the conditions shown below, as evidenced by these sheets having at least 95% draw and no blistering, without predrying the sheets prior to thermoforming.

| | Thermoforming | | | | |
|---|---|---|---|---|---|
| | Conditions | | | | |
| | Heat | Sheet | Part Quality | | |
| | Time | Temperature | Part Volume | | Blisters |
| Example | (s) | (° C.) | (mL) | Draw (%) | (N, L, H) |
| A | 86 | 145 | 501 | 64 | N |
| B | 100 | 150 | 500 | 63 | N |
| C | 118 | 156 | 672 | 85 | N |
| D | 135 | 163 | 736 | 94 | N |
| E | 143 | 166 | 760 | 97 | N |
| F | 150 | 168 | 740 | 94 | L |
| G | 159 | 172 | 787 | 100 | L |

### Example 14

Sheets comprising a polyester that had been prepared with a target composition of 100 mole % terephthalic acid residues, 80 mole % 1,4-cyclohexanedimethanol residues, and 20 mole % 2,2,4,4-tetramethyl-1,3-cyclobutanediol residues were produced using a 3.5 inch single screw. A sheet was extruded continuously, gauged to a thickness of 177 mil and then various sheets were sheared to size. Inherent viscosity and glass transition temperature were measured on one sheet. The sheet inherent viscosity was measured to be 0.69 dl/g. The glass transition temperature of the sheet was measured to be 106° C. Sheets were then conditioned at 100% relative humidity and 25° C. for 2 weeks. Sheets were subsequently thermoformed into a female mold having a draw ratio of 2.5:1 using a Brown thermoforming machine. The thermoforming oven heaters were set to 60/40/40% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example G). The thermoformed part was visually inspected for any blisters and the degree of blistering rated as none (N), low (L), or high (H). The results below demonstrate that these thermoplastic sheets with a glass transition temperature of 106° C. can be thermoformed under the conditions shown below, as evidenced by the production of sheets having at least 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 141 | 154 | 394 | 53 | N |
| B | 163 | 157 | 606 | 82 | N |
| C | 185 | 160 | 702 | 95 | N |
| D | 195 | 161 | 698 | 95 | N |
| E | 215 | 163 | 699 | 95 | L |
| F | 230 | 168 | 705 | 96 | L |
| G | 274 | 174 | 737 | 100 | H |
| H | 275 | 181 | 726 | 99 | H |

### Example 15

### Comparative Example

Sheets consisting of Kelvx 201 were produced using a 3.5 inch single screw extruder. Kelvx is a blend consisting of 69.85% PCTG (Eastar from Eastman Chemical Co. having 100 mole % terephthalic acid residues, 62 mole % 1,4-cyclohexanedimethanol residues, and 38 mole % ethylene glycol residues); 30% PC (bisphenol A polycarbonate); and 0.15% Weston 619 (stabilizer sold by Crompton Corporation). A sheet was extruded continuously, gauged to a thickness of 177 mil and then various sheets were sheared to size. The glass transition temperature was measured on one sheet and was 100° C. Sheets were then conditioned at 50% relative humidity and 60° C. for 2 weeks. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example E). The thermoformed part was visually inspected for any blisters and the degree of blistering rated as none (N), low (L), or high (H). The results below demonstrate that these thermoplastic sheets with a glass transition temperature of 100° C. can be thermoformed under the conditions shown below, as evidenced by the production of sheets having at least 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 90 | 146 | 582 | 75 | N |
| B | 101 | 150 | 644 | 83 | N |
| C | 111 | 154 | 763 | 98 | N |
| D | 126 | 159 | 733 | 95 | N |
| E | 126 | 159 | 775 | 100 | N |
| F | 141 | 165 | 757 | 98 | N |
| G | 148 | 168 | 760 | 98 | L |

### Example 16

### Comparative Example

Sheets consisting of Kelvx 201 were produced using a 3.5 inch single screw extruder. A sheet was extruded continuously, gauged to a thickness of 177 mil and then various sheets were sheared to size. The glass transition temperature was measured on one sheet and was 100° C. Sheets were then conditioned at 100% relative humidity and 25° C. for 2 weeks. Sheets were subsequently thermoformed into a female mold having a draw ratio of 2.5:1 using a Brown thermoforming machine. The thermoforming oven heaters were set to 60/40/40% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example H). The thermoformed part was visually inspected for any blisters and the degree of blistering rated as none (N), low (L), or high (H). The results below demonstrate that these thermoplastic sheets with a glass transition temperature of 100° C. can be thermoformed under the conditions shown below, as evidenced by the production of sheets having greater than 95% draw and no blistering, without predrying the sheets prior to thermoforming.

| | Thermoforming | Part Quality | | | |
|---|---|---|---|---|---|
| | Conditions | Sheet | Part | | |
| | Heat | Temperature | Volume | Draw | Blisters |
| Example | Time (s) | (° C.) | (mL) | (%) | (N, L, H) |
| A | 110 | 143 | 185 | 25 | N |
| B | 145 | 149 | 529 | 70 | N |
| C | 170 | 154 | 721 | 95 | N |
| D | 175 | 156 | 725 | 96 | N |
| E | 185 | 157 | 728 | 96 | N |
| F | 206 | 160 | 743 | 98 | L |
| G | 253 | NR | 742 | 98 | H |
| H | 261 | 166 | 756 | 100 | H |

NR = Not recorded

### Example 17

### Comparative Example

Sheets consisting of PCTG 25976 (100 mole % terephthalic acid residues, 62 mole % 1,4-cyclohexanedimethanol residues, and 38 mole % ethylene glycol residues) were produced using a 3.5 inch single screw extruder. A sheet was extruded continuously, gauged to a thickness of 118 mil and then various sheets were sheared to size. The glass transition temperature was measured on one sheet and was 87° C. Sheets were then conditioned at 50% relative humidity and 60° C. for 4 weeks. The moisture level was measured to be 0.17 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example A). The thermoformed part was visually inspected for any blisters and the degree of blistering rated as none (N), low (L), or high (H). The results below demonstrate that these thermoplastic sheets with a glass transition temperature of 87° C. can be thermoformed under the conditions shown below, as evidenced by the production of sheets having greater than 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 102 | 183 | 816 | 100 | N |
| B | 92 | 171 | 811 | 99 | N |
| C | 77 | 160 | 805 | 99 | N |
| D | 68 | 149 | 804 | 99 | N |
| E | 55 | 143 | 790 | 97 | N |
| F | 57 | 138 | 697 | 85 | N |

### Example 18

### Comparative Example

A miscible blend consisting of 20 wt % Teijin L-1250 polycarbonate (a bisphenol A polycarbonate), 79.85 wt % PCTG 25976, and 0.15 wt % Weston 619 was produced using a 1.25 inch single screw extruder. Sheets consisting of the blend were then produced using a 3.5 inch single screw extruder. A sheet was extruded continuously, gauged to a thickness of 118 mil and then various sheets were sheared to size. The glass transition temperature was measured on one sheet and was 94° C. Sheets were then conditioned at 50% relative humidity and 60° C. for 4 weeks. The moisture level was measured to be 0.25 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example A). The thermoformed part was visually inspected for any blisters and the degree of blistering rated as none (N), low (L), or high (H). The results below demonstrate that these thermoplastic sheets with a glass transition temperature of 94° C. can be thermoformed under the conditions shown below, as evidenced by the production of sheets having greater than 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 92 | 184 | 844 | 100 | H |
| B | 86 | 171 | 838 | 99 | N |
| C | 73 | 160 | 834 | 99 | N |
| D | 58 | 143 | 787 | 93 | N |
| E | 55 | 143 | 665 | 79 | N |

### Example 19

### Comparative Example

A miscible blend consisting of 30 wt % Teijin L-1250 polycarbonate, 69.85 wt % PCTG 25976, and 0.15 wt % Weston 619 was produced using a 1.25 inch single screw extruder. Sheets consisting of the blend were then produced using a 3.5 inch single screw extruder. A sheet was extruded continuously, gauged to a thickness of 118 mil and then various sheets were sheared to size. The glass transition temperature was measured on one sheet and was 99° C. Sheets were then conditioned at 50% relative humidity and 60° C. for 4 weeks. The moisture level was measured to be 0.25 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example A). The thermoformed part was visually inspected for any blisters and the degree of blistering rated as none (N), low (L), or high (H). The results below demonstrate that these thermoplastic sheets with a glass transition temperature of 99° C. can be thermoformed under the conditions shown below, as evidenced by the production of sheets having greater than 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 128 | 194 | 854 | 100 | H |
| B | 98 | 182 | 831 | 97 | L |
| C | 79 | 160 | 821 | 96 | N |
| D | 71 | 149 | 819 | 96 | N |
| E | 55 | 145 | 785 | 92 | N |
| F | 46 | 143 | 0 | 0 | NA |
| G | 36 | 132 | 0 | 0 | NA |

NA = not applicable.
A value of zero indicates that the sheet was not formed because it did not pull into the mold (likely because it was too cold).

### Example 20

### Comparative Example

A miscible blend consisting of 40 wt % Teijin L-1250 polycarbonate, 59.85 wt % PCTG 25976, and 0.15 wt % Weston 619 was produced using a 1.25 inch single screw extruder. Sheets consisting of the blend were then produced using a 3.5 inch single screw extruder. A sheet was extruded continuously, gauged to a thickness of 118 mil and then various sheets were sheared to size. The glass transition temperature was measured on one sheet and was 105° C. Sheets were then conditioned at 50% relative humidity and 60° C. for 4 weeks. The moisture level was measured to be 0.265 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Examples 8A to 8E). The thermoformed part was visually inspected for any blisters and the degree of blistering rated as none (N), low (L), or high (H). The results below demonstrate that these thermoplastic sheets with a glass transition temperature of 105° C. can be thermoformed under the conditions shown below, as evidenced by the production of sheets having greater than 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 111 | 191 | 828 | 100 | H |
| B | 104 | 182 | 828 | 100 | H |
| C | 99 | 179 | 827 | 100 | N |
| D | 97 | 177 | 827 | 100 | N |
| E | 78 | 160 | 826 | 100 | N |
| F | 68 | 149 | 759 | 92 | N |
| G | 65 | 143 | 606 | 73 | N |

### Example 21

### Comparative Example

A miscible blend consisting of 50 wt % Teijin L-1250 polycarbonate, 49.85 wt % PCTG 25976, and 0.15 wt % Weston 619 was produced using a 1.25 inch single screw extruder. A sheet was extruded continuously, gauged to a thickness of 118 mil and then various sheets were sheared to size. The glass transition temperature was measured on one sheet and was 111° C. Sheets were then conditioned at 50% relative humidity and 60° C. for 4 weeks. The moisture level was measured to be 0.225 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Examples A to D). The thermoformed part was visually inspected for any blisters and the degree of blistering rated as none (N), low (L), or high (H). The results below demonstrate that these thermoplastic sheets with a glass transition temperature of 111° C. can be thermoformed under the conditions shown below, as evidenced by the production of sheets having greater than 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 118 | 192 | 815 | 100 | H |
| B | 99 | 182 | 815 | 100 | H |
| C | 97 | 177 | 814 | 100 | L |
| D | 87 | 171 | 813 | 100 | N |
| E | 80 | 160 | 802 | 98 | N |
| F | 64 | 154 | 739 | 91 | N |
| G | 60 | 149 | 0 | 0 | NA |

NA = not applicable.
A value of zero indicates that the sheet was not formed because it did not pull into the mold (likely because it was too cold).

### Example 22

### Comparative Example

A miscible blend consisting of 60 wt % Teijin L-1250 polycarbonate, 39.85 wt % PCTG 25976, and 0.15 wt % Weston 619 was produced using a 1.25 inch single screw extruder. Sheets consisting of the blend were then produced using a 3.5 inch single screw extruder. A sheet was extruded continuously, gauged to a thickness of 118 mil and then various sheets were sheared to size. The glass transition temperature was measured on one sheet and was 117° C. Sheets were then conditioned at 50% relative humidity and 60° C. for 4 weeks. The moisture level was measured to be 0.215 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example A). The thermoformed part was visually inspected for any blisters and the degree of blistering rated as none (N), low (L), or high (H). The results below demonstrate that these thermoplastic sheets with a glass transition temperature of 117° C. cannot be thermoformed under the conditions shown below, as evidenced by the inability to produce sheets having greater than 95% draw and no blistering, without predrying the sheets prior to thermoforming.

| | | Part Quality | | | |
|---|---|---|---|---|---|
| | Thermoforming | Sheet | Part | | |
| | Conditions | Temperature | Volume | Draw | Blisters |
| Example | Heat Time (s) | (° C.) | (mL) | (%) | (N, L, H) |
| A | 114 | 196 | 813 | 100 | H |
| B | 100 | 182 | 804 | 99 | H |
| C | 99 | 177 | 801 | 98 | L |
| D | 92 | 171 | 784 | 96 | L |
| E | 82 | 168 | 727 | 89 | L |
| F | 87 | 166 | 597 | 73 | N |

### Example 23

### Comparative Example

A miscible blend consisting of 65 wt % Teijin L-1250 polycarbonate, 34.85 wt % PCTG 25976, and 0.15 wt % Weston 619 was produced using a 1.25 inch single screw extruder. Sheets consisting of the blend were then produced using a 3.5 inch single screw extruder. A sheet was extruded continuously, gauged to a thickness of 118 mil and then various sheets were sheared to size. The glass transition temperature was measured on one sheet and was 120° C. Sheets were then conditioned at 50% relative humidity and 60° C. for 4 weeks. The moisture level was measured to be 0.23 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Example A). The thermoformed part was visually inspected for any blisters and the degree of blistering rated as none (N), low (L), or high (H). The results below demonstrate that these thermoplastic sheets with a glass transition temperature of 120° C. cannot be thermoformed under the conditions shown below, as evidenced by the inability to produce sheets having greater than 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 120 | 197 | 825 | 100 | H |
| B | 101 | 177 | 820 | 99 | H |
| C | 95 | 174 | 781 | 95 | L |
| D | 85 | 171 | 727 | 88 | L |
| E | 83 | 166 | 558 | 68 | L |

### Example 24

### Comparative Example

A miscible blend consisting of 70 wt % Teijin L-1250 polycarbonate, 29.85 wt % PCTG 25976, and 0.15 wt % Weston 619 was produced using a 1.25 inch single screw extruder. Sheets consisting of the blend were then produced using a 3.5 inch single screw extruder. A sheet was extruded continuously, gauged to a thickness of 118 mil and then various sheets were sheared to size. The glass transition temperature was measured on one sheet and was 123° C. Sheets were then conditioned at 50% relative humidity and 60° C. for 4 weeks. The moisture level was measured to be 0.205 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw, and visually inspecting the thermoformed part. The draw was calculated as the part volume divided by the maximum part volume achieved in this set of experiments (Examples A and B). The thermoformed part was visually inspected for any blisters and the degree of blistering rated as none (N), low (L), or high (H). The results below demonstrate that these thermoplastic sheets with a glass transition temperature of 123° C. cannot be thermoformed under the conditions shown below, as evidenced by the inability to produce sheets having greater than 95% draw and no blistering, without predrying the sheets prior to thermoforming.

| | Thermoforming | | | | |
|---|---|---|---|---|---|
| | Conditions | | Part Quality | | |
| | | Sheet | Part | | |
| | | Temperature | Volume | Draw | Blisters |
| Example | Heat Time (s) | (° C.) | (mL) | (%) | (N, L, H) |
| A | 126 | 198 | 826 | 100 | H |
| B | 111 | 188 | 822 | 100 | H |
| C | 97 | 177 | 787 | 95 | L |
| D | 74 | 166 | 161 | 19 | L |
| E | 58 | 154 | 0 | 0 | NA |
| F | 48 | 149 | 0 | 0 | NA |

NA = not applicable.
A value of zero indicates that the sheet was not formed because it did not pull into the mold (likely because it was too cold).

### Example 25

### Comparative Example

Sheets consisting of Teijin L-1250 polycarbonate were produced using a 3.5 inch single screw extruder. A sheet was extruded continuously, gauged to a thickness of 118 mil and then various sheets were sheared to size. The glass transition temperature was measured on one sheet and was 149° C. Sheets were then conditioned at 50% relative humidity and 60° C. for 4 weeks. The moisture level was measured to be 0.16 wt %. Sheets were subsequently thermoformed into a female mold having a draw ratio of 2.5:1 using a Brown thermoforming machine. The thermoforming oven heaters were set to 70/60/60% output using top heat only. Sheets were left in the oven for various amounts of time in order to determine the effect of sheet temperature on the part quality as shown in the table below. Part quality was determined by measuring the volume of the thermoformed part, calculating the draw and visually inspecting the thermoformed part. The draw was calculated as the part volume divided by the maximum part volume achieved in this set of experiments (Example A). The thermoformed part was visually inspected for any blisters and the degree of blistering rated as none (N), low (L), or high (H). The results below demonstrate that these thermoplastic sheets with a glass transition temperature of 149° C. cannot be thermoformed under the conditions shown below, as evidenced by the inability to produce sheets having greater than 95% draw and no blistering, without predrying the sheets prior to thermoforming.

| | | Part Quality | | | |
|---|---|---|---|---|---|
| | Thermoforming | Sheet | Part | | Blisters |
| | Conditions | Temperature | Volume | | (N, L, |
| Example | Heat Time (s) | (° C.) | (mL) | Draw (%) | H) |
| A | 152 | 216 | 820 | 100 | H |
| B | 123 | 193 | 805 | 98 | H |
| C | 113 | 191 | 179 | 22 | H |
| D | 106 | 188 | 0 | 0 | H |
| E | 95 | 182 | 0 | 0 | NA |
| F | 90 | 171 | 0 | 0 | NA |

NA = not applicable.
A value of zero indicates that the sheet was not formed because it did not pull into the mold (likely because it was too cold).

The invention is further described and illustrated with the following examples, all of which are prophetic. The glass transition temperatures (Tg's) of the pellets are determined using a TA Instruments 2920 differential scanning calorimeter (DSC) at a scan rate of 20° C./min. The polymer blends also exhibit a Glass Transition Temperature (Tg), of at least 85° C., preferably at least 100° C., more preferably at least 110° C., and even more preferably at least 120° C. The miscible high Tg polyester/polymer blend composition of the present invention are characterized by a novel combination of properties including a clarity or haze value of about 0.1 to 3.0 as determined by a HunterLab UltraScan Sphere 8000 Colorimeter manufactured by Hunter Associates Laboratory, Inc., Reston, Va. using Hunter's Universal Software (version 3.8). % Haze=100* DiffuseTransmission/TotalTransmission. Calibration and operation of the instrument is done according to the HunterLab User Manual. To reproduce the results on any colorimeter, run the instrument according to its instructions. Diffuse transmission is obtained by placing a light trap on the other side of the integrating sphere from where the sample port is, thus eliminating the straight-thru light path. Only light scattered by greater than 2.5 degrees is measured. Total transmission includes measurement of light passing straight-through the sample and also off-axis light scattered to the sensor by the sample. The sample is placed at the exit port of the sphere so that off-axis light from the full sphere interior is available for scattering. (Regular transmission is the name given to measurement of only the straight-through rays—the sample is placed immediately in front of the sensor, which is approximately 20 cm away from the sphere exit port—this keeps off-axis light from impinging on the sample.) Heat Deflection Temperature is determined by ASTM D648, Notched Izod Impact Strength is performed according to ASTM D256. Flexural properties are determined according to ASTM D790. The tensile properties of the blend determined according to ASTM D638 at 23° C. The inherent viscosity of the polyesters is determined in 60/40 (wt/wt) phenol/tetrachloroethane at a concentration of 0.5 g/100 mL at 25° C. The miscibility of the polyester/polymer blends and the miscibility of components added to the polyester(s) are determined by differential scanning calorimetry and by observation of the clarity of sheet, films and molded objects.

Prophetic Examples 26 to 50—Miscible high Tg polyester/polymer blend compositions are melt processable into film suitable for LCD films. The nomenclature for the polyester or copolyesters used is shown in Table 12. The compositions of preferred polyesters and copolyesters having high clarity and glass transition temperatures above 100° C. when blended with polycarbonate or other suitable polymer(s) are shown in Table 13, although not limiting the scope of this invention. Table 12 below shows abbreviations or nomenclature used to describe some selected monomers, primarily those chosen from preferred species:

TABLE 12

| Name | Diacid or Diol | Abbreviation |
|---|---|---|
| Terephthalic acid | Diacid | T |
| Isophthalic acid | Diacid | I |
| 1,4 cyclohexanedicarboxylic acid | Diacid | CHDA |
| 2,6 or 2,7-naphthalenedicarboxylic | Diacid | N |
| ethylene glycol | Diol | EG |
| 2,2,4,4-tetramethyl-1,3- | Diol | TMCB |
| cyclobutanediol | | |
| neopentyl glycol | Diol | NPG |
| 1,4-cyclohexanedimethanol | Diol | CHDM |

In Table 13 below, appropriate illustrative combinations of monomers are presented that yield polyesters or copolyesters that form miscible blends with polycarbonate. These are considered preferred polyesters. The information shown in Table 13 is by no means limiting to the scope of the invention.

TABLE 13

| | | Diacid 1 | | Diacid 2 | | Diol 1 | | Diol 2 |
|---|---|---|---|---|---|---|---|---|
| Composition | Diacid 1 | (mol %) | Diacid 2 | (mol %) | Diol 1 | (mol %) | Diol 2 | (mol %) |
| 26 | T | 100 | | 0 | CHDM | 100 | | 0 |
| 27 | T | 75 | I | 25 | CHDM | 100 | | 0 |
| 28 | T | 50 | CHDA | 50 | CHDM | 100 | | 0 |
| 29 | N | 50 | T | 50 | CHDM | 90 | EG | 10 |
| 30 | T | 100 | | 0 | CHDM | 81 | EG | 19 |
| 31 | T | 100 | | 0 | CHDM | 62 | EG | 38 |
| 32 | T | 100 | | 0 | CHDM | 55 | EG | 45 |
| 33 | T | 50 | I | 50 | NPG | 55 | CHDM | 45 |
| 34 | CHDA | 100 | | 0 | CHDM | 100 | | 0 |
| 35 | CHDA | 100 | | 0 | CHDM | 50 | EG | 50 |
| 36 | T | 100 | | 0 | TMCB | 100 | | 0 |
| 37 | T | 100 | | 0 | TMCB | 70 | EG | 30 |
| 38 | T | 100 | | 0 | CHDM | 55 | TMCB | 45 |
| 39 | T | 100 | | 0 | CHDM | 80 | TMCB | 20 |
| 40 | G | 100 | | 0 | TMCB | 70 | CHDM | 30 |
| 41 | T | 100 | | 0 | CHDM | 60 | NPG | 40 |
| 42 | T | 100 | | 0 | CHDM | 83 | NPG | 17 |
| 43 | T | 100 | | 0 | TMCB | 99 | CHDM | 1 |
| 44 | T | 100 | | 0 | CHDM | 99 | TMCB | 1 |
| 45 | CHDA | 100 | | 0 | TMCB | 99 | EG | 1 |
| 46 | CHDA | 100 | | 0 | EG | 99 | TMCB | 1 |
| 47 | CHDA | 100 | | 0 | TMCB | 100 | | 0 |
| 48 | CHDA | 100 | | 0 | TMCB | 50 | CHDM | 50 |
| 49 | T | 50 | CHDA | 50 | TMCB | 60 | CHDM | 40 |
| 50 | CHDA | 75 | T | 25 | TMCB | 70 | NPG | 30 |

In the following examples, a single step process will be demonstrated. However, if desired, a two step process such as compounding on a Werner-Pfleiderer, 30-mm, co-rotating twin screw extruder followed by film casting using a 1.5″ Killian single screw extruder equipped with a gear pump, a single element candle filter, an adjustable film die, a polishing roll stack and a film winder. By a single step method, either the twin screw extruder or single screw extruder could be used with the candle filter and adjustable film die with a roll stack and a film winder. The polyesters of Table 13 are blended with bisphenol A polycarbonate and a phosphorous additive. The bisphenol A polycarbonate is Teijin L1250. The phosphorous concentrate is prepared by first hydrolyzing Weston 619 buy melting it and soaking it in water, allowing the excess water to evaporate. A powdered version Eastar 5445 is then added to the now hydrolyzed molten Weston 619 and mixed until it a homogeneous solution is formed. This material is then extruded in a twin-screw extruder at a melt temperature of 270° C. and pelletized. The final phosphorous content in the pellets is 5 wt %. Selected polyesters of Table 13 are blended with a phosphorous additive and one of the following: polyarylate (U100™), polyetherimide (Ultem 1000™), polyestercarbonate (Lexan 4704™), Phenoxy (PKHH™), Polyethylenenaphthalate (MN600), and poly(vinyl phenol).

### Examples 26 to 50

Optical quality films from polyester/polycarbonate blend compositions melt process into film directly from compound components. 47 wt % of each of the polyesters of Table 13 are compounded with 50 wt % bisphenol A polycarbonate and 3 wt % of a phosphorous additive, filtered then processed directly into film using a Werner-Pfleiderer 30-mm corotating twin screw extruder, all films are transparent and with single Tg's over 100° C. These films are then oriented by uniaxial and biaxial stretching into thin, optical quality films suitable for LCD applications.

### Examples 51 to 75

The same blends of Examples 26 to 50 are prepared with an additional additive (5 parts per 100 parts of Example 26-50 blends). The blend components and the referenced additive types and levels are compounded, filtered then processed directly into film using a Werner-Pfleiderer 30-mm corotating twin screw extruder, all films are transparent and with single Tg's over 100° C. These films are then oriented by uniaxial and biaxial stretching into thin, optical quality films suitable for LCD applications. Additives used are a flame retardant (FR) of triethylphosphate, an ultraviolet absorber (UV) of 2-(3′-t-butyl-5′-methyl-2′-hydroxyphenyl)-5-chlorobenzotriazole, a process aid (PA) of stearic acid, and an oxidative stabilizer (OS) of IRGANOX® 1010.

### Examples 76-81

Blends containing polyesters of Table 13 and polymers other than bisphenol A polycarbonate. 47 wt % of selected polyesters of Table 13 are blended with 3 wt % of a phosphorous additive and 50 wt % of one of the following: polyarylate (U100™), polyetherimide (Ultem 1000™), polyestercarbonate (Lexan 4704™), phenoxy (PKHH™), polyethylene-naphthalate (MN600), and poly(vinyl phenol). The polyester component is selected carefully to ensure miscibility with each of the above listed polymers. These selected polyesters of Table 13 are compounded with a phosphorous additive and each of the above listed polymers and, filtered then processed directly into film using a Werner-Pfleiderer 30-mm corotating twin screw extruder, all films are transparent and with single Tg's over 100° C. These films are then oriented by uniaxial and biaxial stretching into thin, optical quality films suitable for LCD applications.

The entire melt process operation is performed using a Werner-Pfleiderer, 30-mm, co-rotating twin screw extruder. The extruder is equipped with multiple, auxiliary feeders to allow controlled metering of the ingredients. A screw design is used that featured sufficient mixing or kneading elements to give homogeneous melts with minimal gels but not excessive mixing that would result in unacceptable color generation or molecular weight degradation. The extruder is fitted with a melt pump, single element candle filter housing, film die, film take of roll and polishing stack and film take-up equipment. two-hole dye that fed strands into a water bath before feeding into a pelletizer. Although not necessary, a temperature profile is used. This profile ranged from 50° C. at the feed section to 280° C. at the last zone. The die temperature is set either at or 20° C. above the temperature of the last zone. Casting film thickness is 15 mils for all examples.

An important element when melt processing films for LCD applications is filtration to ensure that the number of foreign matter in each of these films having a size of 10 to 50 μm (0.01 to 0.05 mm) are less than 200 per 250 mm² (0.8 particles/mm²) and there are no foreign matter particles having a size of at greater than 50 μm. Filtering can occur during any stage of the process prior to actual film formation; however, for these examples the compositions are filtered just before the film die in this single-step operation. Usable filters are those which exhibit resistance to high heat and stress. Typical structures employed as such filters may be, for example, simple screen holders or their extended area variants, screen changers or their extended area variants, single or multiple candle filter assemblies, leaf disc type assemblies or any other geometry that filtration media can be formed into for the purpose of melt filtration. Suitable media include woven wire cloth, sintered non-woven wire cloth, sintered powdered metal and any other porous structure constructed with materials sufficient to withstand the high temperatures of melt filtration. While any media can be used the preferred media is one of the depth types capable of removing gels and other deformable contaminants. Hard particle removal capabilities of the media can range from 20 um down to 0.1 um with 1-10 um being the preferred range. For the examples shown here a single-element candle filter housing is used. The filter elements can be either pleated candles for absolute micron ratings down to about 5 microns or wrapped candles for micron ratings below 5 micron. Pleated candle filters are used for these examples.

These melt processed films are then uniaxially and biaxially oriented using a TM Long film stretcher (named for the producer) to produce uniaxially or biaxially stretched samples of film. The operation of the film stretcher is based upon the movement of two drawbars at right angles to each other upon hydraulically driven rods. There is a fixed draw bar opposed to each moving draw bar. These pairs of opposed moving and fixed draw bars, to which the four edges of the film specimen are attached, form the two axes at right angles to each other along which the specimen is stretched in any stretch ratio up to four or seven times original size, depending on the machine being used. Samples are placed in grips on the machine and heated prior to stretching if desired. The outputs from the device are stress versus elongation data (if desired) at the temperature of the experiment and the stretched film.

These films can be heat-set under restrained or unrestrained conditions and allowed to shrink slightly (in planar and/or thickness direction) to reduce residual stresses present in stretched films, which is important during the manufacture of optical films where precise control of the isotropic or anisotropic nature of the film is required. Mechanically, any residual stresses present in stretched film have been allowed to relax, thus making the film stronger and more uniform. Additionally, the surface of the film becomes smoother and more uniform.

The films for these examples are stretched at various temperatures and draw ratios as required to produce uniformly stretched films with the desired optical properties. Films with acceptable surface finish and thickness uniformity for optical applications are obtained. Films stretched at higher draw ratios or lower temperatures have a higher anisotropic nature to them and are suitable as compensation films. Stretched films of film of polyester from Table 13 blended with low levels of polycarbonate (lower Tg) had lower birefringence than stretched films of the same polyester with higher polycarbonate levels (higher Tg), keeping the stretch temperature and stretch ratios constant. These films, stretched uniaxially and/or biaxially yield films suitable for both polarizer protection films or compensation films depending upon the polyester type and level, the polymer (polycarbonate) type and level, stretch ratio, and stretch temperature; i.e., a single blend type can yield film of either a polarizer protection film (low birefringence, low retardation values) or a compensation film (high birefringence, high retardation) simply by controlling the blend composition, draw ratios, and stretch temperatures used for a given starting film thickness.

We claim:

1. A composition for LCD compensation or protective films, the composition comprising:
a polyester and polymer blend comprising
1) 1 to 99.9 percent by weight of the polymer and
2) 0.1 to 99 pecent by weight of the polyester that is miscible in the polymer, with the percent by weight being based on the total weight of the polyester and the polymer; and
wherein the polyester polymer blend has a Tg greater than 85° C., and
wherein a section of the blend having a thickness of 10 to 50 μm has less than 200 foreign matter particles per 250 mm².

2. The composition according to claim 1, wherein the blend has no foreign matter particles having a size greater than 50 μm.

3. The composition according to claim 1, wherein the polymer is selected from the group consisting of polycarbonates, polyarylates, polysulfones, cyclic olefin copolymers, polyarylates, polyetherimides, amorphous polyamides, cellulose esters and mixtures thereof.

4. The composition according to claim 1, wherein the polymer comprises a polycarbonate comprising about 90 to 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent.

5. The composition according to claim 1, wherein the polyester comprises
A. diacid residues comprising terephthalic acid residues wherein the total mole percent of diacid residues is equal to 100 mol percent;
B. diol residues comprising about 25 to 100 mole percent of the residues of 1,4-cyclohexanedimethanol and about 75 to 0 mole percent of the residues of at least one aliphatic diol wherein the total mole percent of diol residues is equal to 100 mole percent; and, optionally,
C. about 0.05 to about 1.0 mole percent, based on the total diacid or diol residues, of the residues of at least one branching monomer having 3 or more functional groups.

6. The composition according to claim 1, wherein the polyester comprises
(a) diacid residues comprising terephthalic acid, isophthalic acid, 1,2-cyclohexanedicarboxylic acid, 2,6-naphthalenedicarboxlyic acid, 2,7-naphthalenedicarboxylic acid or mixtures thereof;
(b) diol residues comprising about 25 to 100 mole percent 1,4-cyclohexanedimethanol residues and about 75 to 0 mole percent aliphatic glycol residues wherein the total mole percent of diol residues is equal to 100 mole percent.

7. The composition according to claim 1, wherein the polyester comprises
(a) a dicarboxylic acid component comprising:
i) 70 to 100 mole % of terephthalic acid residues;
ii) 0 to 30 mole % of aromatic dicarboxylic acid residues having up to 20 carbon atoms; and
iii) 0 to 10 mole % of aliphatic dicarboxylic acid residues having up to 16 carbon atoms; and
(b) a glycol component comprising:
i) 10 to 99 mole % of 2,2,4,4-tetramethyl-1,3-cyclobutanediol residues; and
ii) 1 to 90 mole % of 1,4-cyclohexanedimethanol residues,
wherein the total mole % of the dicarboxylic acid component is 100 mole %, the total mole % of the glycol component is 100 mole %; and
wherein the inherent viscosity of the polyester is from 0.1 to 1.2 dL/g as determined in 60/40 (wt/wt) phenol/tetrachloroethane at a concentration of 0.5 g/100 ml at 25° C.

8. The composition according to claim 7 wherein the diacid residues comprise 65 to 100 mole % of terephthalic acid residues and 0 to 35 mole % of aromatic dicarboxylic acid residues having up to 20 carbon atoms; and the diol residues comprise 0 to 43 mole % of ethylene glycol residues; and 57 to 100 mole % of 1,4-cyclohexanedimethanol residues.

9. The composition according to claim 1, wherein the polyester comprises
A. diacid residues selected from the group comprising terephthalic acid residues, napthalic acid residues, and cyclohexanedicarboxylic acid residues, and mixtures thereof, wherein the total mole percent of diacid residues is equal to 100 mol percent;
B. diol residues of about 0 to 100 mole percent selected from the group comprising comprising 1,4-cyclohexanedimethanol residues, 2,2,4,4-tetramethyl-1,3-cyclobutanediol residues, ethylene glycol residues, and neopentyl glycol residues and about 100 to 0 mole percent selected from the group comprising comprising 1,4-cyclohexanedimethanol residues, 2,2,4,4-tetramethyl-1,3-cyclobutanediol residues, ethylene glycol residues, and neopentyl glycol residues wherein the total mole percent of diol residues is equal to 100 mole percent and optionally;
C. about 0.05 to 1.0 mole percent of the residue of a trifunctional monomer wherein the total mole percent of component C is based on (1) the moles of Component A when Component C is a triacid residues and (2) the moles of component B when Component C is a triol.

10. An article for LCD compensation or protective films, the article comprising:
a polyester and polymer blend comprising
1) 1 to 99.9 percent by weight of the polymer and
2) 0.1 to 99 pecent by weight of the polyester that is miscible in the polymer, with the percent by weight being based on the total weight of the polyester and the polymer; and
wherein the polyester polymer blend has a Tg greater than 85° C., and
wherein a section of the article having a thickness of 10 to 50 μm has less than 200 foreign matter particles per 250 mm².

11. The article according to claim 10, wherein the blend has no foreign matter particles having a size greater than 50 μm.

12. The article according to claim 10, wherein the polymer is selected from the group consisting of polycarbonates, polyarylates, polysulfones, cyclic olefin copolymers, polyarylates, polyetherimides, amorphous polyamides, cellulose esters and mixtures thereof.

13. The article according to claim 10, wherein the polymer comprises a polycarbonate comprising about 90 to 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent.

14. The article according to claim 10, wherein the polyester comprises
A. diacid residues comprising terephthalic acid residues wherein the total mole percent of diacid residues is equal to 100 mol percent;
B. diol residues comprising about 25 to 100 mole percent of the residues of 1,4-cyclohexanedimethanol and about 75 to 0 mole percent of the residues of at least one aliphatic diol wherein the total mole percent of diol residues is equal to 100 mole percent; and, optionally,
C. about 0.05 to about 1.0 mole percent, based on the total diacid or diol residues, of the residues of at least one branching monomer having 3 or more functional groups.

15. The article according to claim 10, wherein the polyester comprises
(a) diacid residues comprising terephthalic acid, isophthalic acid, 1,2-cyclohexanedicarboxylic acid, 2,6-naphthalenedicarboxlyic acid, 2,7-naphthalenedicarboxylic acid or mixtures thereof;
(b) diol residues comprising about 25 to 100 mole percent 1,4-cyclohexanedimethanol residues and about 75 to 0 mole percent aliphatic glycol residues wherein the total mole percent of diol residues is equal to 100 mole percent.

16. The article according to claim 10, wherein the polyester comprises
(a) a dicarboxylic acid component comprising:
i) 70 to 100 mole % of terephthalic acid residues;
ii) 0 to 30 mole % of aromatic dicarboxylic acid residues having up to 20 carbon atoms; and
iii) 0 to 10 mole % of aliphatic dicarboxylic acid residues having up to 16 carbon atoms; and
(b) a glycol component comprising:
i) 10 to 99 mole % of 2,2,4,4-tetramethyl-1,3-cyclobutanediol residues; and
ii) 1 to 90 mole % of 1,4-cyclohexanedimethanol residues,
wherein the total mole % of the dicarboxylic acid component is 100 mole %, the total mole % of the glycol component is 100 mole %; and
wherein the inherent viscosity of the polyester is from 0.1 to 1.2 dL/g as determined in 60/40 (wt/wt) phenol/tetrachloroethane at a concentration of 0.5 g/100 ml at 25° C.

17. The article according to claim 16 wherein the diacid residues comprise 65 to 100 mole % of terephthalic acid residues and 0 to 35 mole % of aromatic dicarboxylic acid residues having up to 20 carbon atoms; and the diol residues comprise 0 to 43 mole % of ethylene glycol residues; and 57 to 100 mole % of 1,4-cyclohexanedimethanol residues.

18. The article according to claim 10, wherein the polyester comprises
A. diacid residues selected from the group comprising terephthalic acid residues, napthalic acid residues, and cyclohexanedicarboxylic acid residues, and mixtures thereof, wherein the total mole percent of diacid residues is equal to 100 mol percent;
B. diol residues of about 0 to 100 mole percent selected from the group comprising comprising 1,4-cyclohexanedimethanol residues, 2,2,4,4-tetramethyl-1,3-cyclobutanediol residues, ethylene glycol residues, and neopentyl glycol residues and about 100 to 0 mole percent selected from the group comprising comprising 1,4-cyclohexanedimethanol residues, 2,2,4,4-tetramethyl-1,3-cyclobutanediol residues, ethylene glycol residues, and neopentyl glycol residues wherein the total mole percent of diol residues is equal to 100 mole percent and optionally;
C. about 0.05 to 1.0 mole percent of the residue of a trifunctional monomer wherein the total mole percent of component C is based on (1) the moles of Component A when Component C is a triacid residues and (2) the moles of component B when Component C is a triol.

19. The article according to claim 10, wherein the article is a film, sheet or plate.

20. The article according to claim 10, wherein the article is a sheet.

21. The article according to claim 10, further comprising a cap layer.

22. A backlight display comprising a compensation or protective film or sheet, the film or sheet comprising
a polyester and polymer blend comprising
1) 1 to 99.9 percent by weight of the polymer and
2) 0.1 to 99 pecent by weight of the polyester that is miscible in the polymer, with the percent by weight being based on the total weight of the polyester and the polymer; and
wherein the polyester polymer blend has a Tg greater than 85° C., and
wherein a section of the blend having a thickness of 10 to 50 μm has less than 200 foreign matter particles per 250 mm².

23. The display according to claim 22, wherein the blend has no foreign matter particles having a size greater than 50 μm.

24. The display according to claim 22, wherein the polymer is selected from the group consisting of polycarbonates, polyarylates, polysulfones, cyclic olefin copolymers, polyarylates, polyetherimides, amorphous polyamides, cellulose esters and mixtures thereof.

25. The display according to claim 22, wherein the polymer comprises a polycarbonate comprising about 90 to 100 mol percent of the residues of 4,4′-isopropylidenediphenol and 0 to about 10 mol percent of the residues of at least one modifying diol having 2 to 16 carbons, wherein the total mol percent of diol residues is equal to 100 mol percent.

26. The display according to claim 22, wherein the polyester comprises
A. diacid residues comprising terephthalic acid residues wherein the total mole percent of diacid residues is equal to 100 mol percent;
B. diol residues comprising about 25 to 100 mole percent of the residues of 1,4-cyclohexanedimethanol and about 75 to 0 mole percent of the residues of at least one aliphatic diol wherein the total mole percent of diol residues is equal to 100 mole percent; and, optionally,
C. about 0.05 to about 1.0 mole percent, based on the total diacid or diol residues, of the residues of at least one branching monomer having 3 or more functional groups.

27. The display according to claim 22, wherein the polyester comprises
(a) diacid residues comprising terephthalic acid, isophthalic acid, 1,2-cyclohexanedicarboxylic acid, 2,6-naphthalenedicarboxlyic acid, 2,7-naphthalenedicarboxylic acid or mixtures thereof;
(b) diol residues comprising about 25 to 100 mole percent 1,4-cyclohexanedimethanol residues and about 75 to 0 mole percent aliphatic glycol residues wherein the total mole percent of diol residues is equal to 100 mole percent.

28. The display according to claim 22, wherein the polyester comprises
(a) a dicarboxylic acid component comprising:
i) 70 to 100 mole % of terephthalic acid residues;
ii) 0 to 30 mole % of aromatic dicarboxylic acid residues having up to 20 carbon atoms; and
iii) 0 to 10 mole % of aliphatic dicarboxylic acid residues having up to 16 carbon atoms; and
(b) a glycol component comprising:
i) 10 to 99 mole % of 2,2,4,4-tetramethyl-1,3-cyclobutanediol residues; and
ii) 1 to 90 mole % of 1,4-cyclohexanedimethanol residues,
wherein the total mole % of the dicarboxylic acid component is 100 mole %, the total mole % of the glycol component is 100 mole %; and
wherein the inherent viscosity of the polyester is from 0.1 to 1.2 dL/g as determined in 60/40 (wt/wt) phenol/tetrachloroethane at a concentration of 0.5 g/100 ml at 25° C.

29. The display according to claim 28 wherein the diacid residues comprise 65 to 100 mole % of terephthalic acid residues and 0 to 35 mole % of aromatic dicarboxylic acid residues having up to 20 carbon atoms; and the diol residues comprise 0 to 43 mole % of ethylene glycol residues; and 57 to 100 mole % of 1,4-cyclohexanedimethanol residues.

30. The display according to claim 22, wherein the polyester comprises
A. diacid residues selected from the group comprising terephthalic acid residues, napthalic acid residues, and cyclohexanedicarboxylic acid residues, and mixtures thereof, wherein the total mole percent of diacid residues is equal to 100 mol percent;
B. diol residues of about 0 to 100 mole percent selected from the group comprising comprising 1,4-cyclohexanedimethanol residues, 2,2,4,4-tetramethyl-1,3-cyclobutanediol residues, ethylene glycol residues, and neopentyl glycol residues and about 100 to 0 mole percent selected from the group comprising comprising 1,4-cyclohexanedimethanol residues, 2,2,4,4-tetramethyl-1,3-cyclobutanediol residues, ethylene glycol residues, and neopentyl glycol residues wherein the total mole percent of diol residues is equal to 100 mole percent and optionally;
C. about 0.05 to 1.0 mole percent of the residue of a trifunctional monomer wherein the total mole percent of component C is based on (1) the moles of Component A when Component C is a triacid residues and (2) the moles of component B when Component C is a triol.

31. The display according to claim 22, further comprising a cap layer.
